(19) United States
(12) Patent Application Publication
(10) Pub. No.: US 2019/0199276 A1
(43) Pub. Date: Jun. 27, 2019

(54) SYSTEMS AND METHODS FOR ROTATING PHOTOVOLTAIC MODULES

(71) Applicant: Alion Energy, Inc., Richmond, CA (US)

(72) Inventors: Sean Bailey, Emeryville, CA (US); Adam French, San Francisco, CA (US); Peter Young, San Francisco, CA (US); Mark Kingsley, Hollis, NH (US); Rodney Hans Holland, Novato, CA (US); Thomas Goehring, Berkeley, CA (US); Tristan French, El Sobrante, CA (US); Miguel M. L. Praca, Kentfield, CA (US); Graham Maxwell, Rocklin, CA (US); David Tostenson, Auburn, CA (US); Timothy Burkhard, Roseville, CA (US); Nicholas A. Barton, Richmond, CA (US)

(21) Appl. No.: 16/287,945

(22) Filed: Feb. 27, 2019

Related U.S. Application Data
(63) Continuation of application No. 15/154,763, filed on May 13, 2016.
(60) Provisional application No. 62/307,125, filed on Mar. 11, 2016.
(60) Provisional application No. 62/191,980, filed on Jul. 13, 2015.
(60) Provisional application No. 62/191,176, filed on Jul. 10, 2015.
(60) Provisional application No. 62/163,258, filed on May 18, 2015.

(51) Int. Cl. H02S 20/32; H02S 20/10; F24S 40/20; F24S 30/425

(52) U.S. Cl. CPC H02S 20/32; H02S 20/10; F24S 2030/18; F24S 30/425; F24S 40/20

(57) ABSTRACT

Under one aspect, a system is provided for rotating photovoltaic modules arranged in a row. The system can include an elongated structural member extending along and parallel to the row; protrusions coupled to the elongated structural member; an actuator; and drive mechanisms coupled to the photovoltaic modules. Actuation of the actuator can move the elongated structural member, the movement of the elongated structural member can move the protrusions, the movement of the protrusions can move the drive mechanisms, and the movement of the drive mechanisms can rotate the photovoltaic modules.

### CROSS REFERENCE TO RELATED APPLICATIONS

This application is a continuation under 35 U.S.C. § 120 of U.S. patent application Ser. No. 15/154,763, filed May 13, 2016 and entitled “Systems and Methods for Rotating Photovoltaic Modules,” the entire contents of which are incorporated by reference herein, which claims the benefit of the following applications, the entire contents of each of which are incorporated by reference herein:

U.S. Provisional Patent Application No. 62/163,258, filed May 18, 2015 and entitled “Systems and Methods for Rotating Photovoltaic Modules;”

U.S. Provisional Patent Application No. 62/191,176, filed Jul. 10, 2015 and entitled “Systems and Methods for Rotating Photovoltaic Modules;”

U.S. Provisional Patent Application No. 62/191,980, filed Jul. 13, 2015 and entitled “Systems and Methods for Rotating Photovoltaic Modules;” and

U.S. Provisional Patent Application No. 62/307,125, filed Mar. 11, 2016 and entitled “Single-axis tracker.”

### FIELD

This application relates to rotating photovoltaic modules.

### BACKGROUND

It can be useful to rotate arrays of photovoltaic (PV) modules, e.g., as the sun moves relative to the array over the course of a day. However, rotating multiple photovoltaic modules of a given array can be challenging. For example, individually rotating the modules can require providing each module with its own actuator, and appropriately controlling such actuators.

Hence, it is desirable to improve techniques for rotating PV modules.

### SUMMARY

Embodiments of the present invention provide systems and methods for rotating photovoltaic modules.

Under one aspect, a system is provided for rotating photovoltaic modules arranged in a row. The system can include an elongated structural member extending along and parallel to the row; protrusions coupled to the elongated structural member; an actuator; and drive mechanisms coupled to the photovoltaic modules. Actuation of the actuator can move the elongated structural member, the movement of the elongated structural member can move the protrusions, the movement of the protrusions can move the drive mechanisms, and the movement of the drive mechanisms can rotate the photovoltaic modules.

Optionally, the elongated structural member can include a cable or belt. Additionally, or alternatively, the protrusions optionally can include balls, knots, or barrels that traverse the row responsive to actuation of the actuator. Additionally, or alternatively, the drive mechanisms optionally can include gearboxes, worm drives, belt drives, ratchets, or geneva mechanisms. Additionally, or alternatively, the system optionally further can include a common structural element attaching together the photovoltaic modules.

Additionally, or alternatively, the protrusions optionally can convert motion of the elongated structural member into rotary motion of the photovoltaic modules. Additionally, or alternatively, the protrusions optionally engage spaces within the drive mechanisms. Additionally, or alternatively, the drive mechanisms optionally can include curved racks each arranged perpendicularly to the photovoltaic modules. Optionally, the curved racks can include gear teeth. Additionally, or alternatively, the photovoltaic modules optionally rotate about a pivot point at a radial center of the curved racks. Additionally, or alternatively, the drive mechanisms optionally can include distributed gearboxes.

Additionally, or alternatively, the system optionally further can include an elongated concrete ballast extending along and parallel to the row and upon which the photovoltaic modules are disposed. Optionally, the elongated concrete ballast is split into discrete tracks each parallel to the row. Additionally, or alternatively, the elongated concrete ballast optionally is formed by slip forming, precasting, or is cast-in-place. Additionally, or alternatively, the elongated concrete ballast optionally further can include one or more control joints.

Additionally, or alternatively, the photovoltaic modules optionally are arranged in a plurality of independent tables. Each table optionally can include one or more of the drive mechanisms and can extend parallel to the row. Additionally, or alternatively, the system optionally further can include a purlin extending parallel to the row and joining together the photovoltaic modules of a corresponding one of the tables. Optionally, the system further can include a purlin arm coupled to the purlin and to one of the drive mechanisms corresponding to that table. Additionally, or alternatively, each table optionally is disposed on a discrete portion of an elongated concrete ballast, the discrete portions being separated from one another by control joints.

Additionally, or alternatively, the elongated structural member optionally can include a drive tube. Optionally, the drive tube includes flexible couplings that allow articulation of the drive tube.

Additionally, or alternatively, the system optionally can include equal numbers of protrusions and drive mechanisms. Additionally, or alternatively, the protrusions optionally can include spur gears, and the drive mechanisms can include curved rack gear mechanisms that engage with the spur gears. Additionally, or alternatively, the actuator optionally can include a slew drive actuator or a gearbox in a ganged configuration.

Additionally, or alternatively, the system optionally can be configured to rotate photovoltaic modules arranged in a second row, the second row being parallel to the row and laterally offset from the row in a direction orthogonal to the row. For example, the system optionally further can include a second elongated structural member extending along and parallel to the second row; protrusions coupled to the second elongated structural member; and drive mechanisms coupled to the photovoltaic modules arranged in the second row. Optionally, actuation of the actuator can move the second elongated structural member, the movement of the second elongated structural member can move the protrusions coupled to the second elongated structural member, the movement of the protrusions coupled to the second elongated structural member can move the drive mechanisms coupled to the photovoltaic modules arranged in the second row, and the movement of the drive mechanisms coupled to the photovoltaic modules arranged in the second row can rotate the photovoltaic modules of the second row. Optionally, the first and second elongated structural members are discrete from one another. Additionally, or alternatively, the system optionally further can include a torque transmission mechanism configured to transmit torque from the actuator to the second elongated structural member. Optionally, the torque transmission mechanism can include a rotating driveshaft.

Additionally, or alternatively, the system optionally further can include A-shaped uprights supporting the elongated structural member, the protrusions, and the drive mechanisms.

Additionally, or alternatively, the system optionally further can include a bridge and a post, the bridge extending between first and second support surfaces, the post extending vertically from the bridge and supporting the elongated structural member, the protrusions, and the drive mechanisms.

Additionally, or alternatively, the system optionally can be configured to rotate photovoltaic modules arranged in a second row, the second row being parallel to the row and laterally offset from the row in a direction orthogonal to the row. For example, the system further can include a first elongated concrete ballast extending along and parallel to the row and upon which the photovoltaic modules of that row are disposed; a second elongated concrete ballast extending along and parallel to the second row and upon which the photovoltaic modules of that row are disposed; and a linking member extending perpendicular to and connecting together the first concrete ballast and the second concrete ballast.

Additionally, or alternatively, the system optionally further can include an elongated concrete ballast extending along and parallel to the row and upon which the photovoltaic modules are disposed, the elongated concrete ballast can include first and second vehicle support surfaces; and a maintenance robot that can include first and second wheels respectively contacting the first and second vehicle support surfaces and configured to maintain the system. Optionally, the elongated concrete ballast is split into first and second discrete tracks each parallel to the row, the first track can include the first vehicle support surface, and the second track can include the second vehicle support surface. Optionally, the maintenance robot can include a body coupled to the first and second wheels and disposed between the first and second discrete tracks.

Additionally, or alternatively, the system optionally further can include stop members configured to inhibit rotation of the photovoltaic modules beyond a preselected angle. Optionally, the stop members include flexible members that are pulled taut when the photovoltaic modules reach the preselected angle, or include fixed members that the photovoltaic modules contact when reaching the preselected angle.

Under another aspect, a system is provided for rotating photovoltaic modules arranged in a row. The system can include a drive tube extending along and parallel to the row. The drive tube can include a plurality of discrete sections coupled together with flexible couplings. The system also can include an actuator; and drive mechanisms coupled to the photovoltaic modules. Actuation of the actuator can rotate the discrete sections of the drive tube and the flexible couplings, the rotation of the discrete sections of the drive tube and the flexible couplings can rotate the drive mechanisms, and the rotation of the drive mechanisms can rotate the photovoltaic modules.

Optionally, the photovoltaic modules are arranged in a plurality of independent tables. Each table can include one or more of the drive mechanisms and extending parallel to the row. Optionally, at least one of the flexible couplings is disposed between each of the tables. Optionally, at least two of the flexible couplings are disposed between each of the tables. Additionally, or alternatively, the flexible couplings optionally allow articulation of the discrete sections of the drive tube between the tables. Optionally, the system further can include an elongated concrete ballast extending along and parallel to the row and upon which the photovoltaic modules are disposed. Optionally, the elongated concrete ballast can follow an irregular geological topology, and the drive tube can follow the irregular geological topology via the articulation of the discrete sections of the drive tube. Additionally, or alternatively, the flexible couplings optionally allow articulation of the discrete sections of the drive tube. Additionally, or alternatively, the flexible couplings transmit torque from the actuator to the drive mechanisms. Additionally, or alternatively, the flexible couplings optionally transmit longitudinal forces to compensate for thermal expansion or contraction or seismic effects. Additionally, or alternatively, each flexible coupling optionally can include a first flange coupled to a first discrete section of the drive tube; a second flange coupled to a second discrete section of the drive tube; and one or more fasteners coupling the first flange to the second flange. Additionally, or alternatively, each flexible coupling optionally can include a sleeve can include a first end, a second end, and a lumen connecting the first and second ends, the lumen at the first end receiving a portion of a first discrete section of the drive tube, the lumen at the second end receiving a portion of a second discrete section of the drive tube. Additionally, or alternatively, each flexible coupling can include a fastener comprising a pin slidably disposed through an aperture of a first discrete section of the drive tube and through a slotted aperture of a second discrete section of the drive tube. Additionally, or alternatively, each flexible coupling can include a fastener comprising a pin, a bearing, and a collar. The bearing can be disposed within a first aperture of a first discrete section of the drive tube, the pin can extend through the bearing, through a second aperture of a second discrete section of the drive tube, and through the collar, and the collar can be slidably disposed within the bearing.

Under yet another aspect, a system is provided for rotating photovoltaic modules arranged in a row. The system can include a torque tube extending along and parallel to the row. The torque tube can include a plurality of discrete sections coupled together with flexible couplings, the plurality of discrete sections being coupled to the photovoltaic modules. The system also can include an actuator. Actuation of the actuator can rotate the discrete sections of the torque tube and the flexible couplings, and the rotation of the discrete sections of the torque tube and the flexible couplings can rotate the photovoltaic modules.

Optionally, the photovoltaic modules are arranged in a plurality of independent tables, each table being coupled to a discrete section of the torque tube and extending parallel to the row. Optionally, at least one of the flexible couplings is disposed between each of the tables. Optionally, at least two of the flexible couplings are disposed between each of the tables. Optionally, the flexible couplings allow articulation of the discrete sections of the torque tube between the tables. Additionally, or alternatively, the system optionally further can include an elongated concrete ballast extending along and parallel to the row and upon which the photovoltaic modules are disposed, wherein the elongated concrete ballast follows an irregular geological topology, and wherein the torque tube follows the irregular geological topology via the articulation of the discrete sections of the torque tube. Optionally, the flexible couplings allow articulation of the discrete sections of the torque tube. Additionally, or alternatively, the flexible couplings optionally transmit longitudinal forces to compensate for thermal expansion or contraction or seismic effects. Additionally, or alternatively, each flexible coupling optionally can include a first flange coupled to a first discrete section of the torque tube; a second flange coupled to a second discrete section of the torque tube; and one or more fasteners coupling the first flange to the second flange. Additionally, or alternatively, each flexible coupling optionally can include a sleeve can include a first end, a second end, and a lumen connecting the first and second ends, the lumen at the first end receiving a portion of a first discrete section of the torque tube, the lumen at the second end receiving a portion of a second discrete section of the torque tube. Additionally, or alternatively, each flexible coupling can include a fastener comprising a pin slidably disposed through an aperture of a first discrete section of the torque tube and through a slotted aperture of a second discrete section of the torque tube. Additionally, or alternatively, each flexible coupling can include a fastener comprising a pin, a bearing, and a collar. The bearing can be disposed within a first aperture of a first discrete section of the torque tube, the pin can extend through the bearing, through a second aperture of a second discrete section of the torque tube, and through the collar, and the collar can be slidably disposed within the bearing.

Under yet another aspect, a system is provided for rotating photovoltaic modules arranged in a plurality of rows. The system can include a plurality of drive tubes extending along and parallel to the rows; drive mechanisms coupled to the photovoltaic modules; an actuator configured to rotate the photovoltaic modules via the drive tubes and drive mechanisms; and a wind fence disposed parallel to and adjacent to at least one of the rows.

Optionally, the wind fence includes a first portion, a second portion, and a joint disposed between the first and second portions. The first portion can be substantially vertical, and the second portion can be articulable via rotation of the joint between a vertical position and a folded position. Optionally, articulation of the second portion to the folded position reduces shading of at least one of the rows. Additionally, or alternatively, the wind fence optionally can include panels can include mesh, fabric, or solid material.

Under still another aspect, a method for mounting photovoltaic modules is provided. The method can include casting or slip-forming an elongated concrete ballast; wet-setting uprights into the elongated concrete ballast; curing the elongated concrete ballast with the uprights therein; and supporting, with the uprights, a drive tube extending along and parallel to the elongated concrete ballast, and drive mechanisms coupled to the photovoltaic modules. The photovoltaic modules can be rotatable via the drive tubes and drive mechanisms.

Optionally, the uprights are A-shaped. Additionally, or alternatively, the uprights optionally each can include a bridge and a post, the bridge contacting first and second surfaces of the elongated concrete ballast, the post extending vertically from the bridge and supporting the drive tubes and drive mechanisms. Additionally, or alternatively, the uprights optionally each can include first and second feet that each are wet-set into the elongated concrete ballast. Additionally, or alternatively, wet-setting the uprights optionally can include vibrating the uprights.

### BRIEF DESCRIPTION OF DRAWINGS

FIGS. 1A-1I schematically illustrate components of exemplary systems for rotating photovoltaic modules arranged in a row, according to some embodiments.

FIGS. 2A-2B, 3A-3B, 4, 5, 6A-6C, 7A-7B, 8A-8J, 9A-9J, 30A-30B, 31, 32, 35, 36A-36B, 37, and 38A-38C schematically illustrate components of exemplary mechanisms for rotating photovoltaic modules, according to some embodiments. FIGS. 8I-1 and 8I-2 are collectively referred to herein as FIG. 8I.

FIGS. 10A-10I schematically illustrate exemplary mechanisms that can be used to inhibit rotation of a photovoltaic module, according to some embodiments.

FIGS. 11A and 11B schematically illustrate exemplary options for following irregular terrain in a system for rotating photovoltaic modules arranged in a row, according to some embodiments.

FIGS. 12A-12E, 13A-13C, 14A-14X, 33, and 34A-34B schematically illustrate exemplary flexible couplings that can be used in a system for rotating photovoltaic modules arranged in a row, according to some embodiments, and exemplary components of one non-limiting example of a drive tube and coupling, e.g., for use in an arc-drive configuration, are illustrated in FIGS. 12B-12F.

FIGS. 15A-15G schematically illustrate exemplary wind fences that can be used in a system for rotating photovoltaic modules, according to some embodiments.

FIGS. 16A-16E schematically illustrate exemplary vehicles that can be used with a system for rotating photovoltaic modules, according to some embodiments.

FIGS. 17, 18A-18F, 19A-19E, 20A-20C, 21A-21C, 22A-22J, 23, 24A-24E, 25, 26A-26R, 28A-28C, and 29A-29B schematically illustrate optional arrangements of components in a system for rotating photovoltaic modules in a row, according to some embodiments, and FIGS. 26Q-26S illustrate still further exemplary embodiments of exemplary flags that can be used with the arrangement of FIG. 25.

FIGS. 27A-27E schematically illustrate views of exemplary structures formed during steps of a method for wet-setting uprights in a system for rotating photovoltaic modules, in some embodiments.

### DETAILED DESCRIPTION

Embodiments of the present invention provide systems and methods for rotating photovoltaic modules. Illustratively, some aspects of the systems and methods provided herein relate to certain arrangements of components for transmitting rotational forces from an actuator to a row of photovoltaic modules so as to rotate the modules of the row, e.g., at different times than one another, or concurrently with one another. Still other aspects of the systems and methods provided herein relate to elongated drive tubes that couple an actuator to a row of photovoltaic modules, and that include flexible couplings that allow for angular misalignment of different modules in that row relative to one another. Still other aspects of the systems and methods provided herein relate to wind fences that can reduce wind loads on certain arrangements of photovoltaic modules. Yet other aspects of the systems and methods provided herein relate to methods of mounting photovoltaic modules. It should be appreciated that any suitable combination of one or more aspects provided herein optionally can be used with one another, but need not necessarily be used with one another. For example, the presently provided arrangements of components for transmitting rotational forces from an actuator to a row of photovoltaic modules so as to rotate the modules of the row optionally can be, but need not necessarily be, used in combination with one or more of the presently flexible couplings, wind fences, and/or methods of mounting photovoltaic modules. As another example, the presently provided flexible couplings optionally can be, but need not necessarily be, used in combination with one or more of the present components for transmitting rotational forces, wind fences, and/or methods of mounting photovoltaic modules. As still another example, the presently provided wind fences optionally can be, but need not necessarily be, used in combination with one or more of the present components for transmitting rotational forces, flexible couplings, and/or methods of mounting photovoltaic modules. As yet another example, the presently provided methods of mounting photovoltaic modules optionally can be, but need not necessarily be, used in combination with one or more of the present components for transmitting rotational forces, flexible couplings, and/or wind fences.

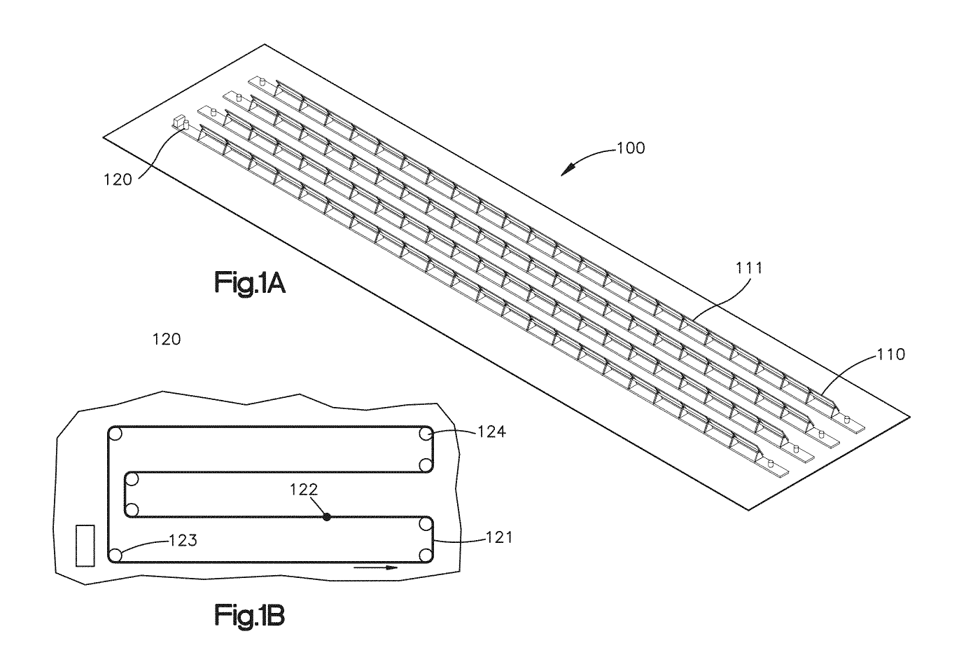

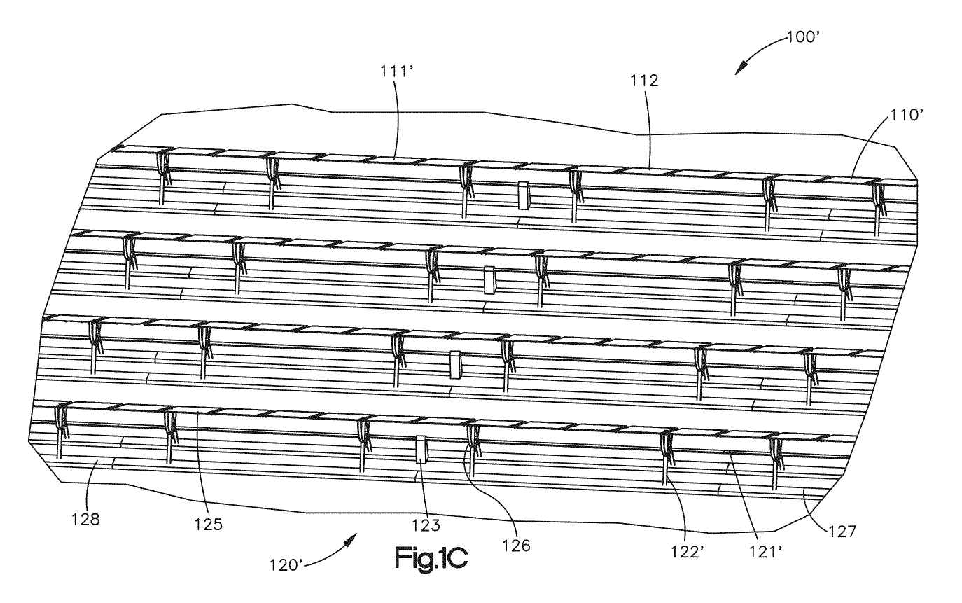

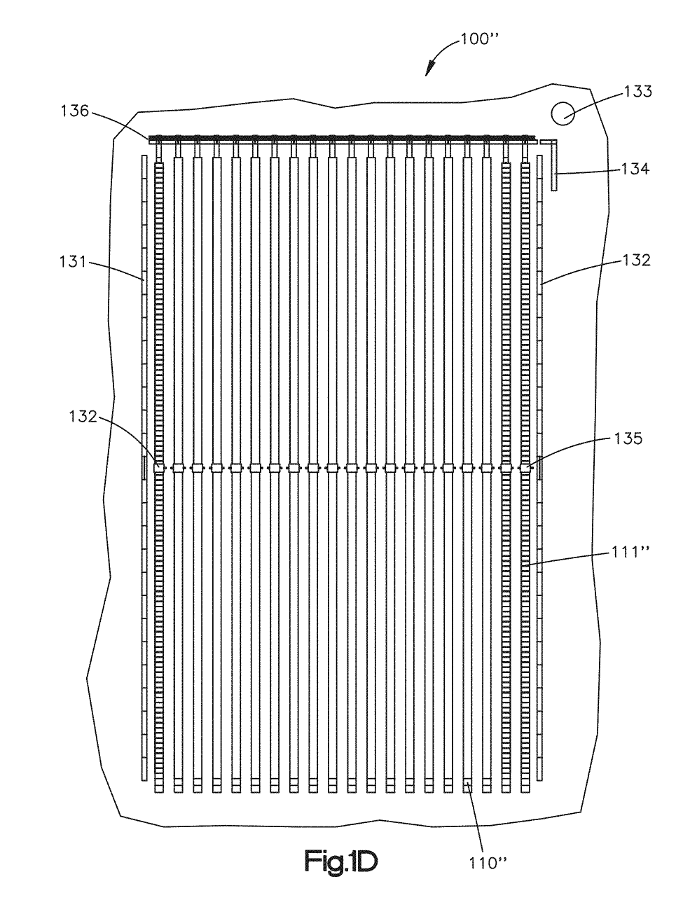

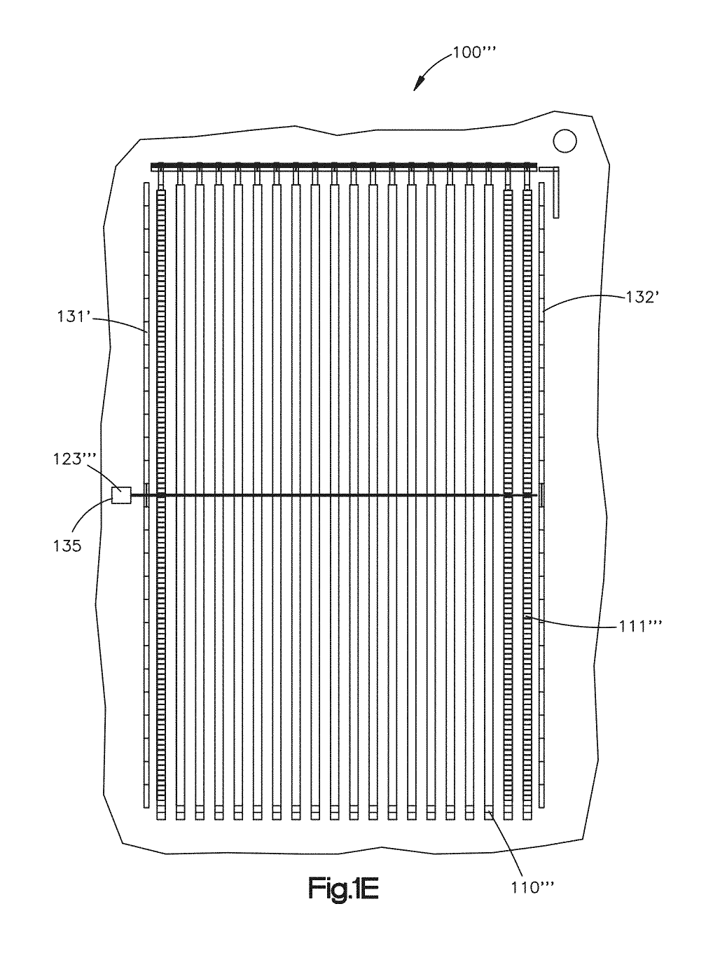

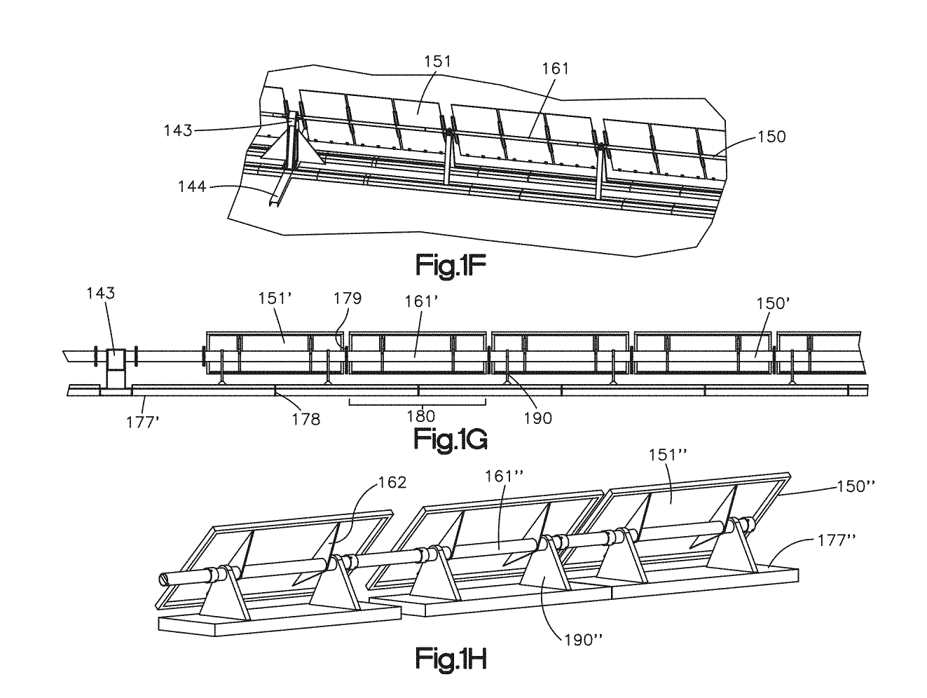

FIGS. 1A-1I schematically illustrate components of exemplary systems for rotating photovoltaic modules arranged in a row, according to some embodiments. For example, FIG. 1A schematically illustrates a perspective view of exemplary system 100 including a plurality of rows 110 of photovoltaic modules 111 and row rotation mechanism 120 which can be coupled to any suitable number of rows 110, e.g., to each of rows 110, to only one of rows 110, or to more than one of rows 110, so as to rotate photovoltaic modules 111 of that row. Optionally, system 100 can further include a common structural element attaching together the photovoltaic modules (not specifically illustrated in FIG. 1A, but can be configured similarly as a purlin such as described with reference to FIG. 1B) Exemplary features of system 110 include one or more of the following: ballasted (non-penetrating); central actuation and control (low cost); low force transmission (low cost, low loads, simple components); distributed gearbox (non-backdrivable); easy to install (manually installed or automated install); ship as a unit, or assembly of pieces on-site (manual/automated); and/or robotically cleanable.

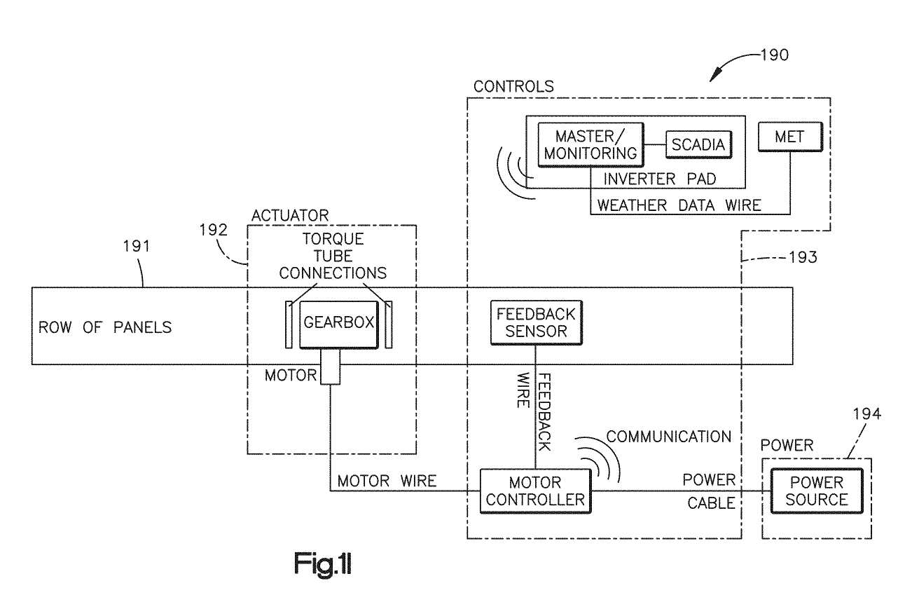

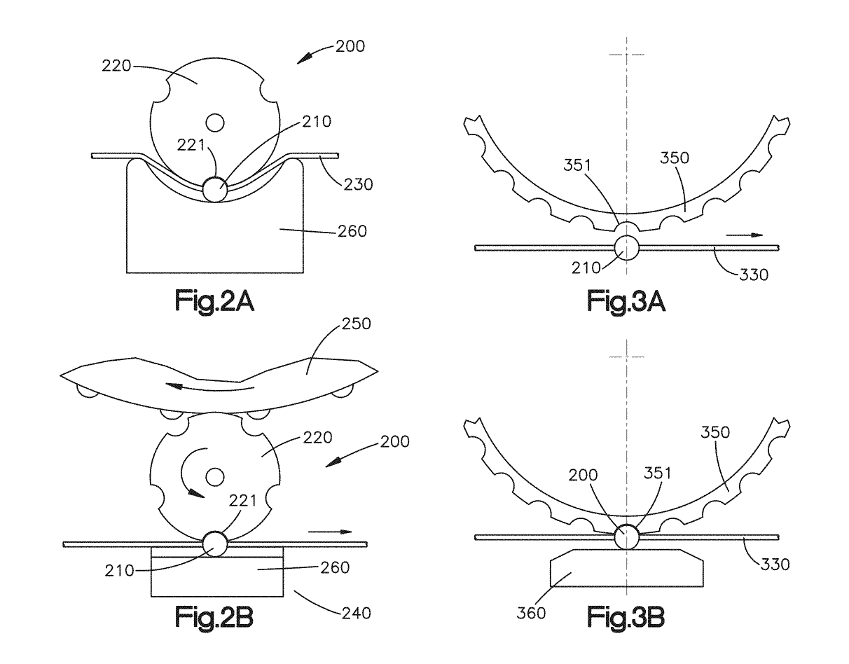

FIG. 1B schematically illustrates a plan view of certain components of a non-limiting embodiment of row rotation mechanism 120. Row rotation mechanism 120 includes elongated structural member 121 extending along and parallel to at least one row 110; one or more protrusions 122 coupled to elongated structural member 121; actuator 123; and drive mechanisms coupled to the photovoltaic modules of the at least one row (drive mechanisms not specifically illustrated in FIG. 1B, but optionally configured such as described with reference to FIG. 2A-2B, 3A-3B, 4, 5, 6A-6C, 7A-7B, 8A-8E, or 9A-9H). Optionally, row rotation mechanism 120 includes rotatable posts or pulleys 124 configured so as to guide elongated structural member in a continuous loop along and between multiple rows 110. In some embodiments, actuation of actuator 123 moves elongated structural member 121, the movement of elongated structural member 121 moves protrusion(s) 122, the movement of protrusion(s) 122 moves the drive mechanisms, and the movement of the drive mechanisms rotates the photovoltaic modules 111 of the one or more rows 110. For example, protrusion(s) 122 can convert motion of elongated structural member 121 into rotary motion of the photovoltaic modules 111 of row 100. Elongated structural member 121 optionally can include a cable or belt. Additionally, or alternatively, protrusion(s) 122 optionally can include balls, knots, or barrels that traverse the row responsive to actuation of the actuator. Additionally, or alternatively, the drive mechanisms (not specifically illustrated in FIG. 1B) optionally can include gearboxes, worm drives, belt drives, ratchets, or geneva mechanisms. Additionally, or alternatively, protrusion(s) 122 can engage spaces within the drive mechanisms in a manner such as described with reference to FIG. 2A-2B, 3A-3B, 4, 5, 6A-6C, 7A-7B, 8A-8E, or 9A-9H.

Illustratively, in the non-limiting example shown in FIG. 1B, actuator 123 turns and moves cable or belt 121 (elongated structural member) that traverses multiple rows 110 or a single row 110 of panels 111. The belt or cable 121 has a single or multiple balls or knots or barrels 122 (protrusions) attached to it that traverses the row(s) 110. As the ball or knot or barrel 122 passes by each panel 111, the angle of the panel is changed by a mechanism (drive mechanism). This mechanism can be a gearbox, worm drive, belt drive, ratchet, or geneva mechanism. The mechanism is not backdrivable (cannot be reversed by loads applied to the panel; this non-backdrivable nature can be due to the mechanism itself (such as a worm drive) or due to a mechanism that keeps the mechanism from being backdrivable (such as a ratchet or catch). The belt or cable 121 can be driven in one way to tilt in one direction, and in the other way to tilt in the other direction. Alternatively, the cable 121 may only travel in one direction and the panel will reverse tilt automatically at the end of travel.

FIG. 1C schematically illustrates a perspective view of exemplary system 100′ including a plurality of rows 110′ of photovoltaic modules 111′ and one or more row rotation mechanisms 120′ which can be coupled to any suitable number of rows 110′, e.g., to each of rows 110′, to only one of rows 110′, or to more than one of rows 110′, so as to rotate photovoltaic modules 111′ of that row. Optionally, system 100′ can further include a common structural element 125 attaching together at least some of the photovoltaic modules 111′ of each row 110′, such as a purlin. In an exemplary, non-limiting embodiment, row rotation mechanism 120′ includes elongated structural member 121′ extending along and parallel to at least one row 110′; one or more protrusions 122′ coupled to elongated structural member 121′; actuator 123′; and drive mechanisms 126 coupled to the photovoltaic modules of the at least one row. In some embodiments, actuation of actuator 123′ moves elongated structural member 121′, the movement of elongated structural member 121′ moves protrusion(s) 122′, the movement of protrusion(s) 122′ moves drive mechanisms 126, and the movement of drive mechanisms 126 rotates the photovoltaic modules 111′ of the one or more rows 110′. For example, protrusion(s) 122′ can convert motion of elongated structural member 121 into rotary motion of the photovoltaic modules 111 of row 100. Additionally, or alternatively, protrusion(s) 122′ can engage spaces within drive mechanisms 126 in a manner such as described with reference to FIG. 2A-2B, 3A-3B, 4, 5, 6A-6C, 7A-7B, 8A-8E, or 9A-9H.

In one optional configuration of modular installation including tables, such as illustrated in FIG. 1C, the overall installation optionally can include multiple independent groups of PV modules, or “tables” 112. Such tables 112 optionally can be arranged in multiple rows 110′ that can be parallel to one another in a manner such as illustrated in FIG. 1C. In one example, the modules 111′ of a given table 112 and/or the tables 112 of a given row 110′ share a common foundation (e.g., elongated concrete ballast 127), a common drive rail (e.g., elongated structural member 121′) (which can include multiple drive rail portions coupled together by couplings), and a common rotation mechanism (e.g., drive mechanism 126). In one example, one motor (e.g., actuator 123′) at the center of each row 110′ or other suitable location is responsible for rotating the modules 111′ (or tables 112 of such modules) in that row 110′. Exemplary components of one non-limiting example of a single-axis tracker are illustrated in FIG. 1C. It should be understood that any suitable combination of such components can be included. For example, one or more components can be modified. In another example, one or more components can be removed. In yet another example, one or more components can be added.

Power, actuation, and control system (PAC). In some embodiments, actuator 123′ optionally is configured as part of a PAC. In some embodiments, each PAC unit includes a gearbox and motor (e.g., actuator) assembly that turns the drive tubes (or other elongated structural members 121′) that can be connected from either side. In some embodiments, each PAC unit optionally can be mounted on a specialized or standard section of the track foundation 127. In some embodiments, between tables 112 the drive tubes (or other elongated structural members 121′) optionally are connected with flexible couplings, e.g., such as described with reference to FIGS. 11A-11B. In some embodiments, each table 112 can be fully or partially isolated from adjoining (neighboring) tables, e.g., using the flexible couplings and/or control joints (breaks) 128 in the track (foundation) 127. These optional control joints 128 can help to protect the single-axis tracker (system) from thermal, settlement, and/or seismic effects, for example, by providing controlled, acceptable places for the concrete foundation to crack. In some embodiments, the optional flexible coupling also or alternatively can accommodate such movement and/or can continue to transmit torque and/or motion to table 112. In some embodiments, the drive tube can be configured to slide within bearings on the uprights so as to provide still greater accommodation, or can be fixed (non-sliding), optionally with compensation for such movement in other components (such as the drive tube couplings).

It should be understood that such flexible couplings and control joints readily may be used with any other embodiments or configurations provided herein.

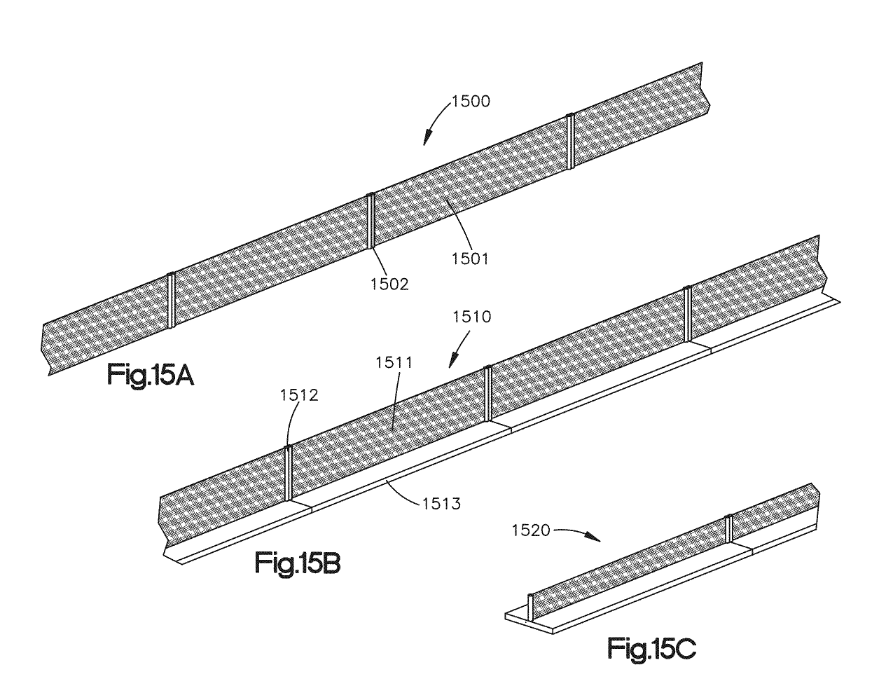

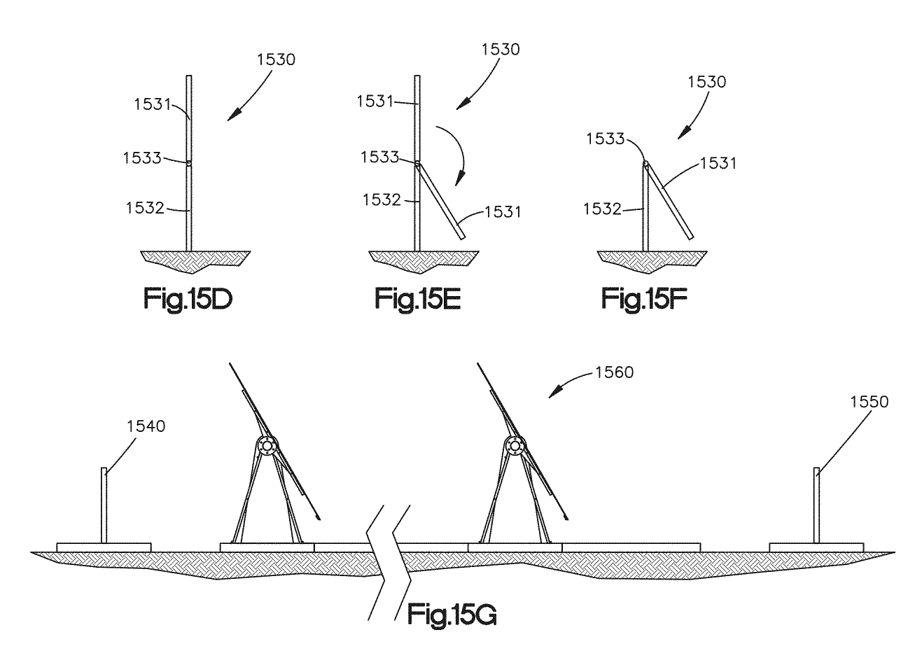

FIG. 1D schematically illustrates a plan view (non-limiting example of site layout) of exemplary system 100″ including a plurality of rows 110″ of photovoltaic modules 111″ and a plurality of row rotation mechanisms (not specifically labeled) that each is coupled to only one of rows 110″. In an exemplary, non-limiting embodiment, the row rotation mechanism includes an elongated structural member extending along and parallel to at least one row in a manner such as described with reference to FIG. 1A-1C, 1F-1H, 6A-6C, 8A-8J, or 11A-11B, and an actuator 123″. In some embodiments, actuation of actuator 123″ moves the elongated structural member, which rotates the photovoltaic modules 111″ of the corresponding row 110″. For example, the elongated structural member can include a belt or cable that moves the photovoltaic modules of row 110″ via a ball, knot, or barrel, or a drive tube that moves the photovoltaic modules of row 110″ via a drive mechanism, or a torque tube that is directly coupled to the row of photovoltaic modules. Optionally, system 100″ includes one or more wind fences 131 (e.g., an optional west windfence), 132 (e.g., an optional east windfence) disposed parallel to and adjacent to at least one of rows 110″ in a manner such as described with reference to FIGS. 15A-15G. Additionally, or alternatively, system 100″ includes one or more of the following features: optional water tank 133; optional autonomous cleaning vehicle home base 134; power, actuation, and control system 135; and optional row-to-row track or foundation 136 for optional autonomous cleaning vehicle (SPOT). FIG. 1D shows optional configurations including one or both of a windfence (131 and/or 132) and SPOT integrated O&M (operation and maintenance) vehicle, e.g., configured for cleaning and/or vegetation management, and/or remote inspection and/or life/performance enhancing material application.

FIG. 1E schematically illustrates a plan view of exemplary system 100′″ including a plurality of rows 110′″ of photovoltaic modules 111′″ and a plurality of row rotation mechanisms (not specifically labeled) that each is coupled to actuator 123′″. In an exemplary, non-limiting embodiment, the row rotation mechanism includes an elongated structural member extending along and parallel a plurality of rows in a manner such as described with reference to FIG. 1A-1C, 1F-1H, 6A-6C, 8A-8J, or 11A-11B, which member is coupled to a shared or ganged actuator 123″. In some embodiments, actuation of actuator 123′″ moves each of the elongated structural members, which rotates the photovoltaic modules 111′″ of the corresponding rows 110″. For example, the elongated structural member can include a belt or cable that moves the photovoltaic modules of each row 110′″ via a ball, knot, or barrel, or a drive tube that moves the photovoltaic modules of row 110′″ via a drive mechanism, or a torque tube that is directly coupled to the row of photovoltaic modules. Optionally, system 100′″ includes one or more wind fences 131′, 132′ disposed parallel to and adjacent to at least one of rows 110′″ in a manner such as described with reference to FIGS. 15A-15G.

Ganging options. In some embodiments, rather than having a PAC unit 135 (of which actuator 123′″ can be a part) on each row 110′″ such as illustrated in FIG. 1D, the present tracker (system) optionally can be configured so as to include a central actuator unit 123′″ that moves groups of rows 110′″. For example, a torque transmission mechanism can transmit the torque from the actuator 123′″ to the rows 110′″ of modules 111′″. For example, in some embodiments, the tracker (system) can include a rotating driveshaft that traverses multiple rows to provide motion and torque to slew drives for each individual row. Such a driveshaft optionally can be powered by a single motor (actuator) 123′″ and controller, and provide torque and motion to many rows 110′″ (for example, 2 or more rows, 5 or more rows, 10 or more rows, 20 or more rows, of 60 or more rows). Note that such ganging options are compatible with use of any suitable elongated structural member(s) for use in rotating the photovoltaic modules of the ganged rows, such as a cable or belt, drive tube, or torque tube.

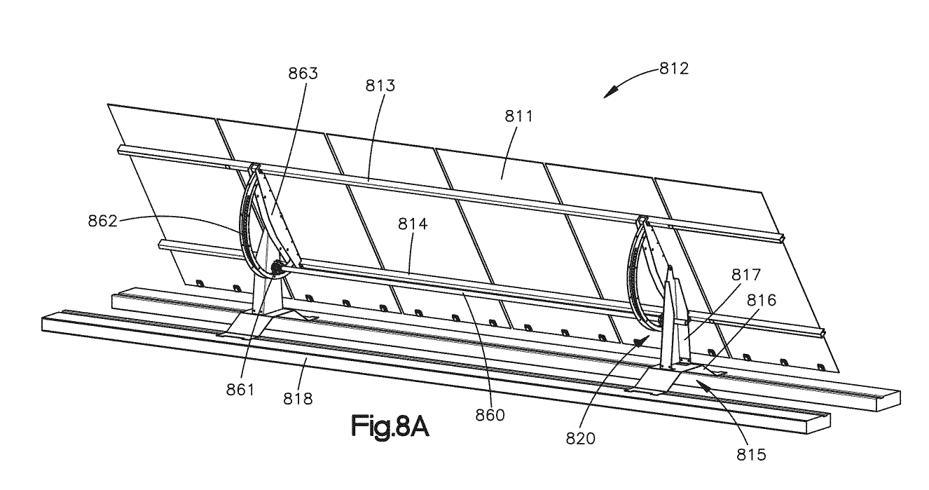

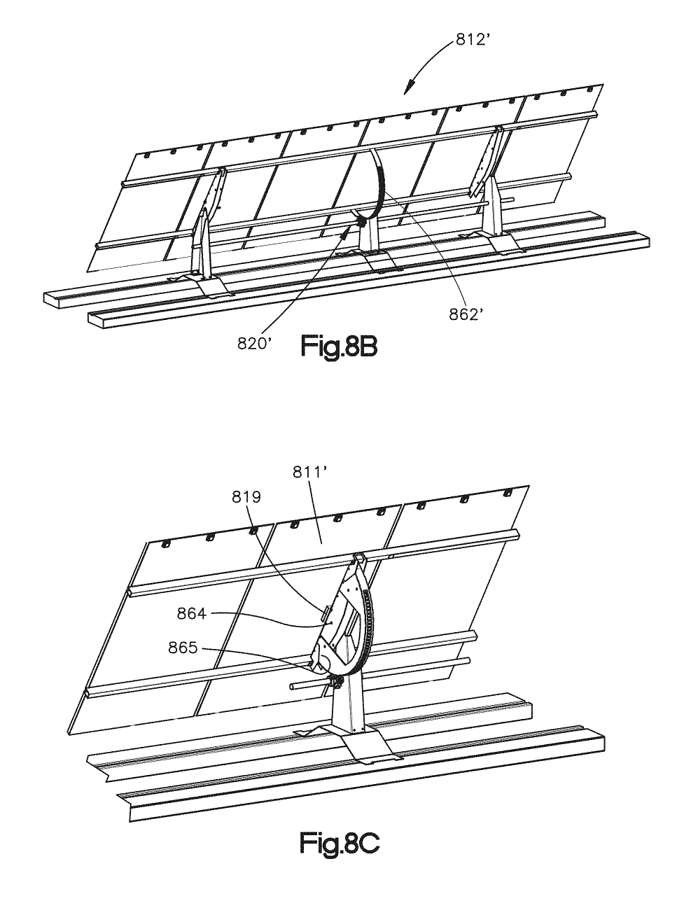

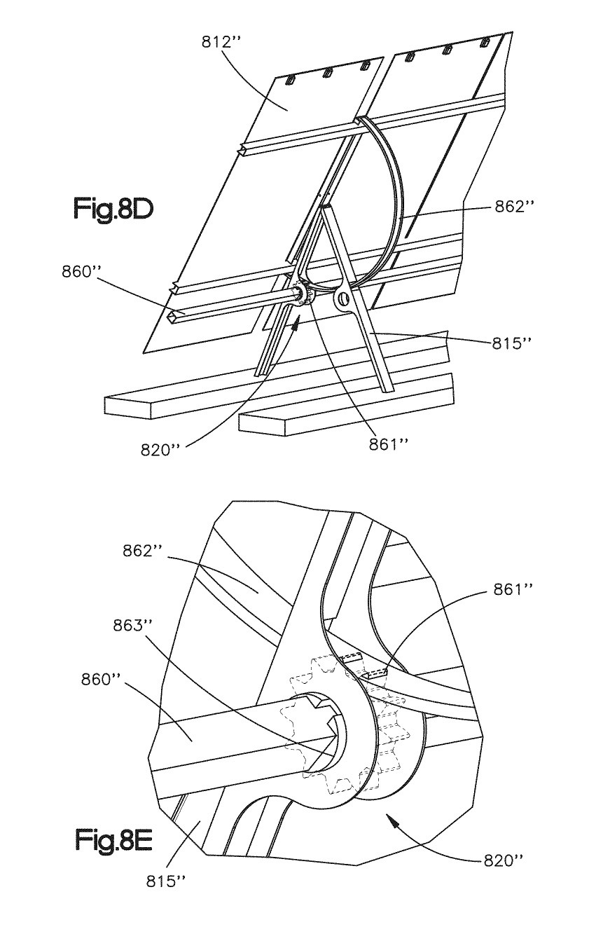

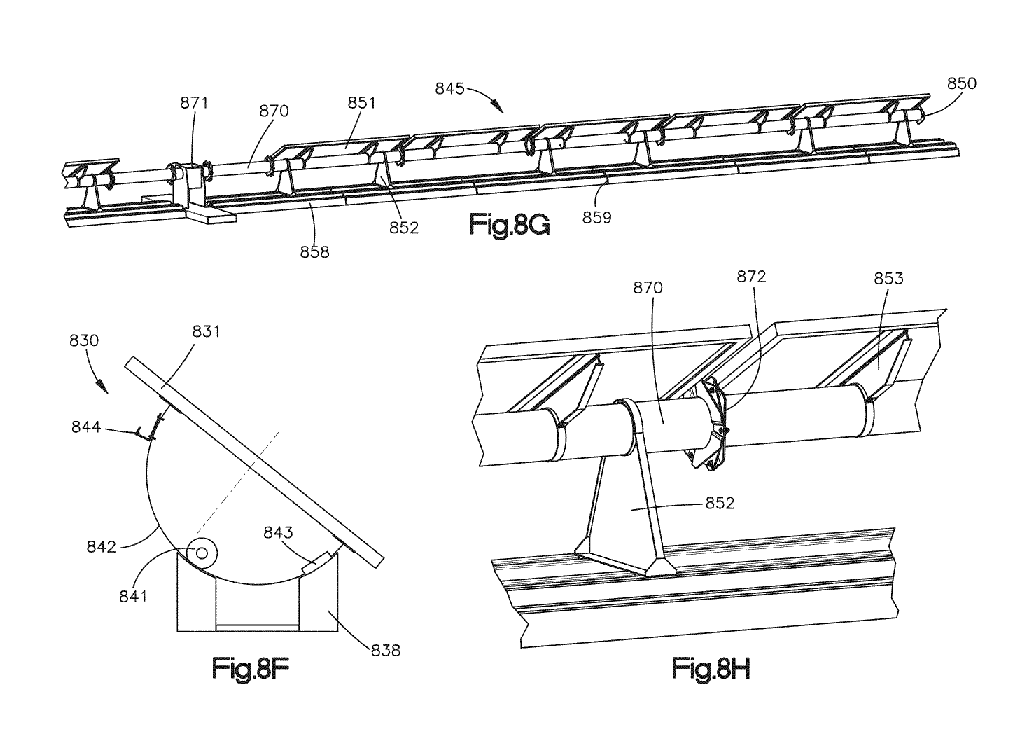

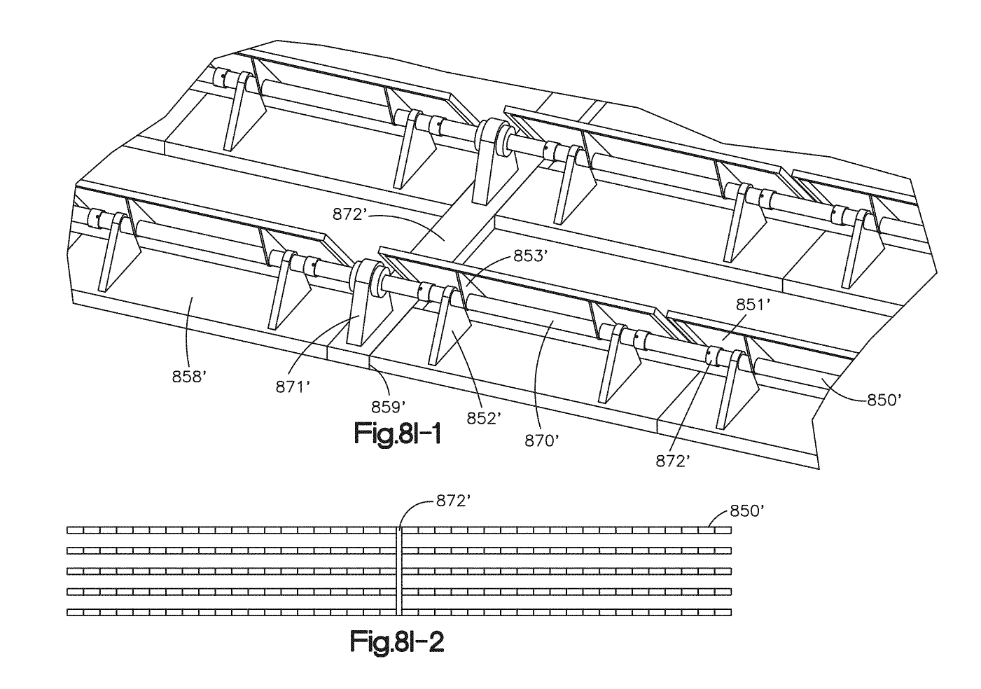

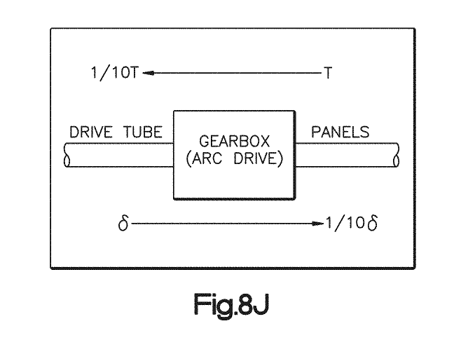

Additionally, or alternatively, In some embodiments, the present single-axis tracker (system) optionally can include one or more structural members that span between rows such as shown in FIG. 1F. Such supports (structural members) can help to provide a suitable foundation for PAC unit(s). FIG. 1F schematically illustrates a perspective view of a non-limiting embodiment in which the system is configured to rotate photovoltaic modules 151 arranged in multiple rows 150 (e.g., in first and second rows) that are parallel from one another and laterally offset from the row in a direction orthogonal to the row. The system can include, for each row 150, an elongated concrete ballast 177 extending along and parallel to the row and upon which the photovoltaic modules 151 of that row are disposed; and a linking member 144 extending perpendicular to and connecting together the concrete ballasts. For example, in some embodiments, the torque(s) applied to the panels 151 can be transferred from actuator 143 to a single torque tube 161 (such as in the non-limiting example shown in FIG. 1F) or to a drive tube via an arc drive (such as described with reference to FIGS. 8A-8F). The torque tube or drive tube then can transfer this torque to a slew drive or gearbox actuator, which can be connected foundation (e.g., elongated concrete ballast 177). The foundation has the option of handling this torque, for example, by including the foundation already present, by including an additional mount of ballasted foundation, by including a post-driven foundation, or by including an element (such as linking member 144) that connects the foundation of one row to the foundation of adjacent rows (thus spreading the torque over a wider base and making it easier to resist). Optionally, actuator 143 can be disposed on linking member 144, optionally in a region where linking member 144 optionally is disposed on elongated concrete ballast 177. Additionally, or alternatively, elongated concrete ballast 177 optionally can include a plurality of control joints 178, e.g., optional foundation control joints, e.g., concrete ballast control joints.

In some embodiments, optional flexible couplings and/or optional track (concrete ballast) control joints can facilitate the present single-axis tracker to tolerate thermal and seismic effects. In some embodiments, the optional flexible couplings can act as universal joints. For example, FIG. 1G schematically illustrates a side view of another exemplary configuration of a row 150′ of photovoltaic modules 151′ for use in the present systems and methods. Row 150′ includes elongated concrete ballast 177′ optionally including control joints 178′, torque tube 161′ coupled to photovoltaic modules 151′ and optionally including flexible couplings 179′, and actuator 143′. Optionally, unsupported sections 180 of torque tube 161′ can include suitable coupling(s) to accommodate larger misalignments. Optionally, each section of track (foundation or elongated concrete ballast) 177′ can be bonded to any suitable number of uprights 190, e.g., to one upright, or to more than one upright, wherein the uprights support at least photovoltaic modules 151′ and torque tube 161′.

FIG. 1H schematically illustrates a perspective view of yet another exemplary configuration of a row 150″ of photovoltaic modules (solar panels) 151′ for use in the present systems and methods. Row 150″ includes elongated concrete ballast 177″ optionally including control joints (not specifically illustrated), torque tube (torque transmitting tube) 161″ coupled to photovoltaic modules 151″ and optionally including flexible couplings (not specifically illustrated), and an actuator (not specifically illustrated). Optionally, elongated concrete ballast 177″ can be bonded to any suitable number of uprights (tube supports) 190″, e.g., to one upright, or to more than one upright, wherein the uprights support at least photovoltaic modules 151″ and torque tube 161″. Optionally, fold-out panel supports 162 support and couple photovoltaic modules 151″ to torque tube 161″. Optionally, row 150″ includes one or more of the following features: all plastic, frameless modules 151″ (no grounding necessary, except metal torque transmitting tube 161″); drive tube (torque transmitting tube 161″) is grounded (metal); works with SPOT cleaning robot (tracker rotates to a specific tilt).

It should be appreciated that the actuators for rotating one or more rows of photovoltaic modules suitably can be powered and controlled using a suitable power, actuation and control system (PAC). In some embodiments, the PAC systems can be powered by the grid and/or by battery storage. In embodiments in which battery storage is used, a PAC unit optionally can be fitted with a solar panel, for example, to charge the battery or to use inductive/parasitic power to charge the batter. FIG. 1I schematically illustrates an exemplary block layout for PAC 190 configured to rotate one or more rows 191 of panels. PAC 190 includes actuator 192 that includes a gearbox, motor, and connections for coupling to an elongated structural member for rotating row 191, such as torque tube connections. PAC 190 also includes controls 193 including a feedback monitor for sensing the tilt of the panels of row 191, motor controller, an inverter pad including master/monitoring controller configured to control the rotation of multiple rows and a supervisory control and data acquisition system (SCADA) that collects data on site, and a weather data acquisition subsystem (MET). PAC 190 also includes power source 194, such as a solar charged battery. The components of PAC 190 suitably can be coupled together with wires and/or wirelessly, e.g., such as shown in FIG. 1I.

In systems such as described herein with reference to FIGS. 1A-1I, any suitable drive mechanism can be used so as to couple an elongated structural member to photovoltaic modules of a row, so as to rotate those modules responsive to actuation of an actuator. For example, in some embodiments, the elongated structural member can include a cable or belt. Additionally, or alternatively, the drive mechanism can include protrusions that include balls, knots, or barrels that traverse the row responsive to actuation of the actuator. Additionally, or alternatively, the drive mechanism can include gearboxes, worm drives, belt drives, ratchets, or geneva mechanisms. Additionally, or alternatively, the protrusions can convert motion of the elongated structural member into rotary motion of the photovoltaic modules. For example, FIGS. 2A-2B schematically illustrate side views of a non-limiting embodiment of a mechanism 200 for converting cable 230 motion into rotary motion. Mechanism 200 can act directly on the solar module (not specifically illustrated) to tilt it, through a supporting device (e.g., panel supporting structure 250) or through a separate mechanism to tilt the solar panel. In mechanism 200 illustrated in FIGS. 2A-2B, ball 210 passes through cable guide or constrained space 260 and engages space 221 within wheel 220 that turns with ball passage or other device that causes it (the wheel) to turn a specified amount. In some embodiments, mechanism 200 can be driven in reverse by the cable 230, but wheel 220 cannot move backwards on its own. Mechanism 200 can be attached to concrete 240 or ballast or other mounting surface or to the solar panel or to the supporting structure 250. There can be one mechanism 200 per solar panel to provide tilting, or one mechanism for multiple solar panels, or multiple mechanisms per solar panel. In embodiments that include a single ball, mechanism 200 can be considered to include equal numbers of protrusions and drive mechanisms.

FIGS. 3A-3B schematically illustrate side views of a non-limiting embodiment of a mechanism 300 for converting cable 330 motion into rotational motion. In mechanism 300 illustrated in FIGS. 3A-3B, ball 310 passes through constrained/constraining space 360 and engages space 351 within panel supporting structure 350 to tilt the panel (not specifically illustrated) a specified amount. In some embodiments, mechanism 300 can be driven in reverse by the cable 330, but wheel (panel supporting structure 350) cannot move backwards on its own. Mechanism 300 can be attached to the concrete or ballast (not specifically illustrated) or to the solar panel or to the supporting structure 350. There can be one mechanism 300 per solar panel to provide tilting, or one mechanism for multiple solar panels, or multiple mechanisms per solar panel. In embodiments that include a single ball, mechanism 300 can be considered to include equal numbers of protrusions and drive mechanisms.

FIG. 4 schematically illustrates a perspective view of a non-limiting embodiment of a mechanism 400 for rotating at least one photovoltaic panel (module) 411. Mechanism 400 can include panel supporting structure 450, worm gear interface 460 to panel supporting structure 450, cable 430, ball(s) 410, space constrainer or cable guide 460, and wheel 420. Panel supporting structure 450 may include, or consist of, multiple parts that pivot relative to one another. Cable 430 with one or more balls 410 may drive wheel 420 or other device that turns a worm gear 460 or other device that causes the panel to tilt by a specified amount. The motion of ball(s) 410 through mechanism 400 may be constrained in place, e.g., by space constrainer or cable guide 460, as it (the ball) passes through mechanism 400. The worm drive 460 or other mechanism is not backdrivable, in certain embodiments.

FIG. 4 schematically illustrates a perspective view of a non-limiting embodiment of a mechanism 400 for rotating at least one photovoltaic panel (module) 411. Mechanism 400 can include panel supporting structure 450, worm gear interface 460 to panel supporting structure 450, cable 430, ball(s) 410, space constrainer or cable guide 460, and wheel 420. Panel supporting structure 450 may include, or consist of, multiple parts that pivot relative to one another. Cable 430 with one or more balls 410 may drive wheel 420 or other device that turns a worm gear 460 or other device that causes the panel to tilt by a specified amount. The motion of ball(s) 410 through mechanism 400 may be constrained in place, e.g., by space constrainer or cable guide 460, as it (the ball) passes through mechanism 400. The worm drive 460 or other mechanism is not backdrivable, in certain embodiments.

FIG. 5 schematically illustrates a perspective view of a non-limiting embodiment of a mechanism 500 for rotating at least one photovoltaic panel (module) 511. Mechanism 500 can include curved rack portion of solar panel supporting structure 550, vertically oriented wheel 520, cable 530, and ball 510. Panel supporting structure 550 may include, or consist of, multiple parts that pivot relative to one another. Cable 530 with one or more balls 510 may drive vertically oriented wheel 520 or other device that directly or indirectly engages the pivoting part of solar panel support structure 550. This engagement may be a curved rack or other mechanism. The motion of ball 530 through mechanism 500 may be constrained in place as it (the ball) passes through mechanism 500. Mechanism 500 may be inherently nonbackdrivable or may incorporate features such as a ratchet to make it non-backdrivable. Mechanism 500 may be operating in the forward or reverse direction by changing the direction of travel of cable 530.

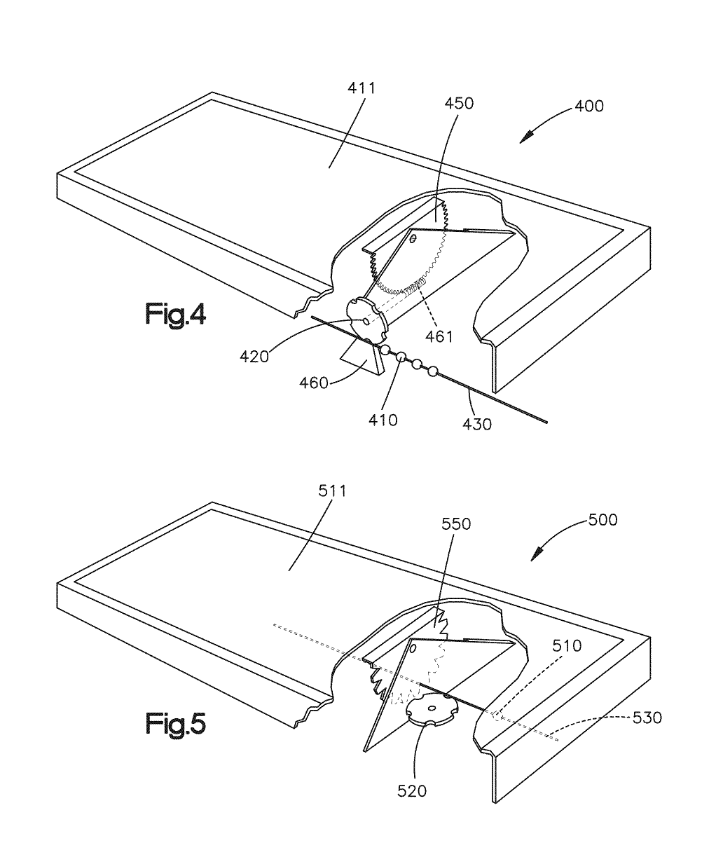

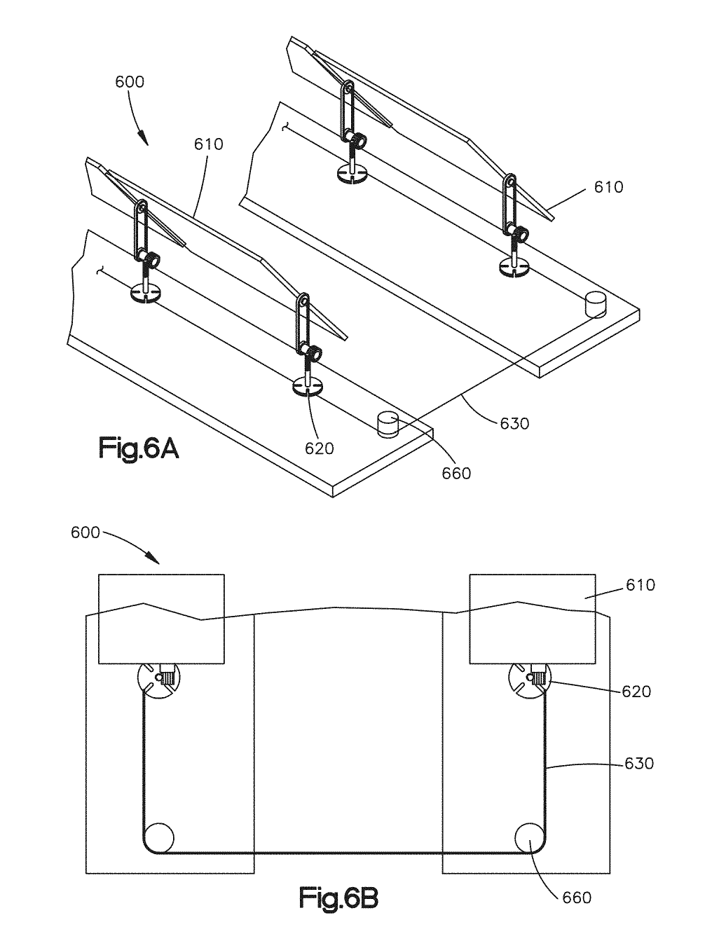

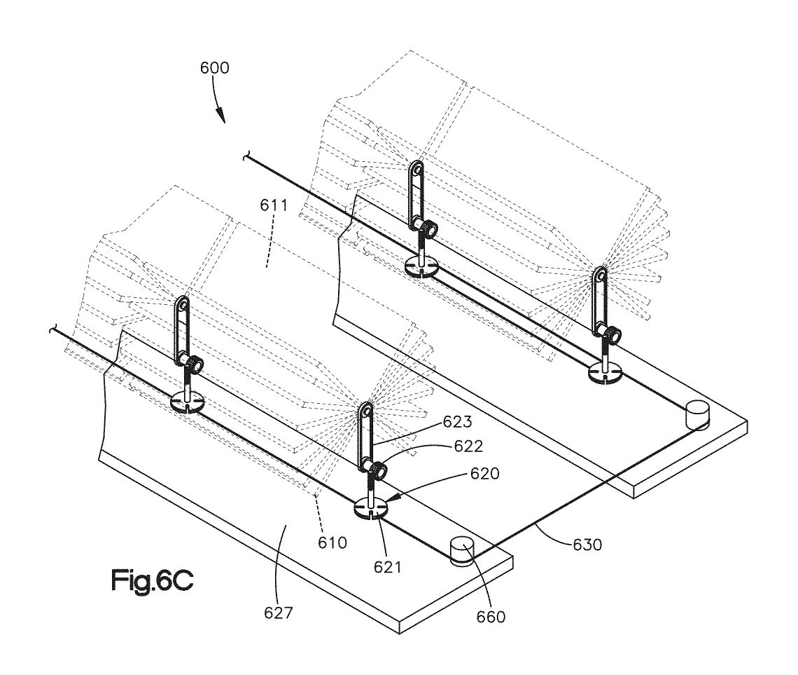

FIG. 6 schematically illustrates a perspective view of a non-limiting embodiment of a mechanism 600 for rotating a plurality of rows 610 of photovoltaic modules 611 that can be mounted on mounting surfaces 627 that can include concrete, asphalt, or other mounting surface and that may or may not be ballasted. Mechanism 600 includes cable(s) 630, pulleys 660, and panel rotational mechanisms 620. Panel rotational mechanisms 620 each are coupled to one or more photovoltaic modules 611 and can include vertically oriented wheel 621 that is moved by cable 630 or a ball on cable 630 that causes panel 611 to tilt; worm drive or other mechanism 622; and secondary belt system 623 that tilts panel (module) 611 indirectly, e.g., responsive to rotation of wheel 621 by motion of cable 630 or ball attached thereto, which causes rotation of worm drive or other mechanism 622, which causes motion of secondary belt system 623 so as to move photovoltaic modules 611 through multiple tilts such as shown in FIG. 6C. Cable(s) 630 move from one row of solar panels 611 to another using pulleys 660.

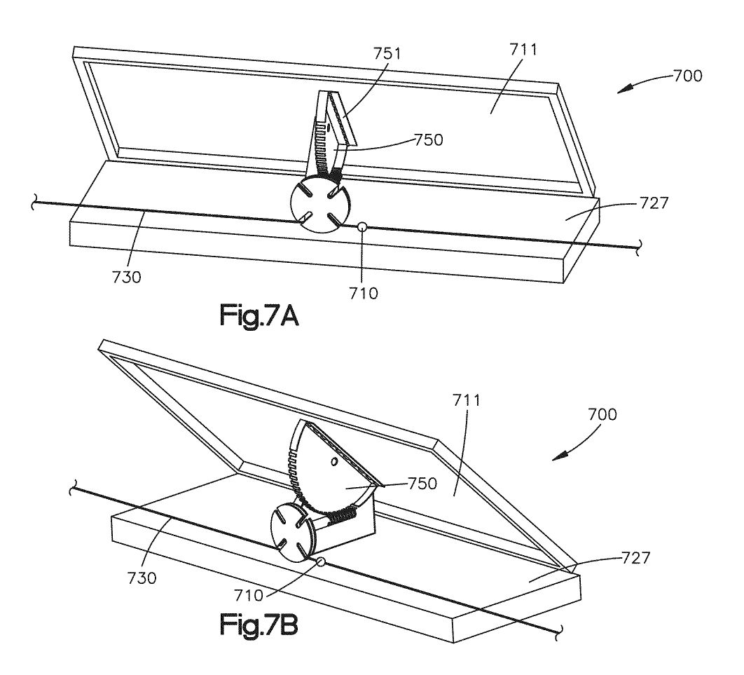

FIGS. 7A-7B schematically illustrate perspective views of a non-limiting embodiment of a mechanism 700 for rotating at least one photovoltaic module 711 that can be disposed on structure mounting surface 727, such as an elongated concrete ballast. Mechanism 700 can include solar panel support structure 750, e.g., a curved rack that can be coupled to module 711 via a folding hinge 751 into the back of the panel, cable 730, ball 710, and mechanism 720 that moves as ball 710 passes through. Panel supporting structure 750 may include, or consist of, multiple parts that pivot relative to one another. The tracking mechanism 700 and support structure 750 may fold relative to the back of panel 711 by hinged mechanism 751. The mechanism then may occupy the space created by the mounting structure or by additional components that create a space for folded support structure 751.

In still other embodiments, the drive mechanisms of a system such as illustrated in FIGS. 1A-1I can include curved racks each arranged perpendicularly to the photovoltaic modules. Optionally, the curved racks can include gear teeth and/or the photovoltaic modules rotate about a pivot point at a radial center of the curved racks. Additionally, or alternatively, the drive mechanisms can include distributed gearboxes. Illustratively, in some embodiments, the present single-axis tracker (system) utilizes a pinion (also known as a spur gear) and a curved rack gear mechanism (which together can be called the arc drive, or radial arc drive (RAD)) so as to rotate rows and/or tables of solar panels (e.g., groups of adjacent solar panels) so as to track the sun as it moves from east to west. These types of systems can be referred to as “trackers.”

In some embodiments, a solar block can include a collection of tracker rows. In some embodiments, each tracker row can include multiple tables. In some embodiments, these tables can include independent structures that can articulate to accommodate terrain variation at the installation site, such as slope and/or offset and/or angular variation that can be either in place during installation or that can occur due to phenomena such as settlement and/or erosion at the installation site over the lift of the product.

In some embodiments, the present single-axis tracker can be configured so as to turn such rows and/or tables to track the sun. In some embodiments, a drive tube, which in some embodiments can be controlled by a central slew actuator (or, as another example, a gearbox in a ganged configuration), optionally can be the only structural component that connects the tables, other than for a rail upon which the table(s) may sit. The drive tube optionally can include flexible couplings further enable the tables to articulate such as described herein. In some embodiments, the drive tube transmits torque and motion to a pinion gear, which in turn engages a curved rack gear to turn the table. In some embodiments, there may be one or many of these arc drives per each table.

Exemplary foundations for the present single-axis tracker can include ballasted, and traditional post-driven systems. The ballasted foundation (e.g., elongated concrete ballasts) can be monolithic or split into two parts, and can be referred to as tracks, rails, or pontoons. In some embodiments, the ballasted foundation can be formed by slipforming or precasting. Additionally, or alternatively, the ballasted foundation can be cast-in-place, e.g., using re-usable forms.

For example, FIGS. 8A-8D schematically illustrate perspective views of exemplary mechanisms for rotating photovoltaic modules using curved racks. Exemplary components of one non-limiting example of a table 812, including a foundation and a tracker including an arc-drive configuration, are illustrated in FIG. 8A. It should be understood that any suitable combination of such components can be included. For example, one or more components can be modified. In another example, one or more components can be removed. In yet another example, one or more components can be added. FIG. 8A illustrates an exemplary embodiment of a single table such as can be used in systems such as illustrated in FIGS. 1A-1I. A plurality of such tables can be provided in a given row and such tables can be independent of one another, e.g., can be joined together only by an elongated structural member (such as a drive tube) for rotating the tables and/or by an elongated concrete ballast upon which the table can be disposed. Illustratively, each table can be disposed on a discrete portion of an elongated concrete ballast, the discrete portions optionally being separated from one another by control joints. Optionally, the drive tube can include flexible couplings that allow articulation of the drive tube, such as described elsewhere herein. Each table can include one or more drive mechanisms coupled to such an elongated structural member.

Exemplary table 812 illustrated in FIG. 8A includes a plurality of photovoltaic modules 811 (e.g., two or more modules, three or more modules, four or more modules, five or more modules, six or more modules, seven or more modules, eight or more modules, nine or more modules, or ten or more modules); first and second optional common structural elements 813, 814 attaching together the photovoltaic modules, e.g., purlins; and uprights 815 coupled to elongated concrete ballast 818 extending along and parallel to the row and upon which the photovoltaic modules are disposed. Optionally, each photovoltaic module 811 can include multiple photovoltaic panels, e.g., two or more, three or more, or four or more photovoltaic panels that are joined together using stiffeners. Optionally, the modules 811 are frameless, and clips can be used so as to clamp the glass frames together. Alternatively, the modules 811 can be framed, and the frames optionally can be attached to purlins 813, 814. The modules 811 can have a portrait orientation such as illustrated in FIG. 8A, or can have a landscape orientation such as illustrated in FIGS. 1G and 1H.

In the non-limiting embodiment illustrated in FIG. 8A, elongated concrete ballast 818 is split into discrete tracks each parallel to table 812 and/or to the row of which table 812 can be a member. Alternatively, elongated concrete ballast 818 can be monolithic. Elongated concrete ballast 818 optionally can be formed by slip forming, precasting, or cast-in-place. Optionally, elongated concrete ballast 818 further includes one or more control joints such as described elsewhere herein. In the non-limiting embodiment illustrated in FIG. 8A, uprights 815 include bridge 816 and post 817. The bridge 816 can extend between first and second support surfaces such as provided by elongated concrete ballast 818, and the post 817 can extend vertically from bridge 816 and can support rotational mechanism 820. In the exemplary embodiment illustrated in FIG. 8A, rotational mechanism 820 includes elongated structural member 860, protrusions that are coupled to elongated structural members 860 and that engage with drive mechanisms 862 (e.g., teeth of spur gear 861), and drive mechanisms 862 (e.g., curved rack gear) coupled to photovoltaic modules 811. However, it should be understood that uprights 815 can have any suitable configuration. For example, in other embodiments such as described elsewhere herein, A-shaped uprights can be used so as to support elongated structural member 860, protrusions (e.g., teeth of spur gear 861), and drive mechanisms 862.

In some embodiments, actuation of an actuator (not specifically illustrated in FIG. 8A) moves elongated structural member 860, e.g., drive tube; the movement of elongated structural member 860 moves protrusions that engage with drive mechanism 862 (e.g., rotates spur gear 861 which causes the teeth of spur gear 861 to rotate); the movement of the protrusions moves drive mechanisms 862 (e.g., rotates a curved rack gear such as illustrated in FIG. 8A); and the movement of drive mechanisms 862 rotates photovoltaic modules 811 (e.g., rotates purlin arms 863 which are coupled to drive mechanisms 862 and to purlins 813, 814 which are coupled to photovoltaic modules 811).

Referring still to FIG. 8A, the actuator to which elongated structural member, e.g., drive tube, 860 is coupled optionally can include a slew drive actuator or a gearbox in a ganged configuration such as described elsewhere herein. Illustratively, the system further can be configured to rotate photovoltaic modules arranged in a second table or row, the second table or row being parallel to the row of which table 812 is a member and laterally offset from the row in a direction orthogonal to the row. The system can include a second elongated structural member extending along and parallel to the second row (e.g., a second drive tube configured similarly as drive tube 860 illustrated in FIG. 8A); protrusions coupled to the second elongated structural member (e.g., second spur gears configured similarly as spur gears 861 illustrated in FIG. 8A); and drive mechanisms coupled to the photovoltaic modules arranged in the second row (e.g., second drive mechanisms configured similarly as drive mechanisms 862 illustrated in FIG. 8A). Actuation of the actuator moves the second elongated structural member, the movement of the second elongated structural member moves the protrusions coupled to the second elongated structural member, the movement of the protrusions coupled to the second elongated structural member moves the drive mechanisms coupled to the photovoltaic modules arranged in the second row, and the movement of the drive mechanisms coupled to the photovoltaic modules arranged in the second row rotates the photovoltaic modules of the second row. The first and second elongated structural members optionally can be discrete from one another. The system optionally further can include a torque transmission mechanism, such as a rotating driveshaft, configured to transmit torque from the actuator to the second elongated structural member.

It should be understood that the present mechanisms can include any suitable number of drive mechanisms per table or row. For example, FIG. 8B schematically illustrates a non-limiting embodiment of a table 812′ that can be configured similarly as table 812 and that includes a single rotational mechanism 820′, e.g., a single drive mechanism 862′.

In some embodiments, embodiments of the present tracker, arc drive configuration (rotational mechanism), and/or table can provide one or more of the following features, e.g., any suitable combination of the following features:

High stiffness—for example, a table including any suitable number of photovoltaic (PV) modules, e.g., 6 PV modules, can be supported on any suitable number of purlins that are attached to any suitable number of purlin arms, e.g., can be supported on two purlins that are attached to two purlin arms; and/or

No damper required—high natural frequency, does not depend on row length; and/or

Reduced number of parts—for example, a table can be supported using any suitable number of purlins, such as two purlins configured or optimized for load bearing and torsion. The modules can be mounted directly to the purlins (e.g., with clamps). In some embodiments, no other support necessarily is required or included for the PV modules; and/or

More modules per motor/actuator can be provided than a design utilizing a torque tube. In one nonlimiting example, the drive shaft (drive tube) can have a smaller diameter than an equivalent stiffness torque tube, e.g., about 1/10 diameter of equivalent stiffness torque tube; and/or

Lower cost components—in some embodiments, drive shaft (drive tube) connections (couplings) can operate using lower load capacity and size than a torque tube design, e.g., in one example can require 1/10 load capacity and size than in torque tube design. Torque tube and couplings can be major cost components; and/or

Installed system can follow the terrain—for example, in some embodiments, modular tables can accommodate uneven ground at the installation site; and/or

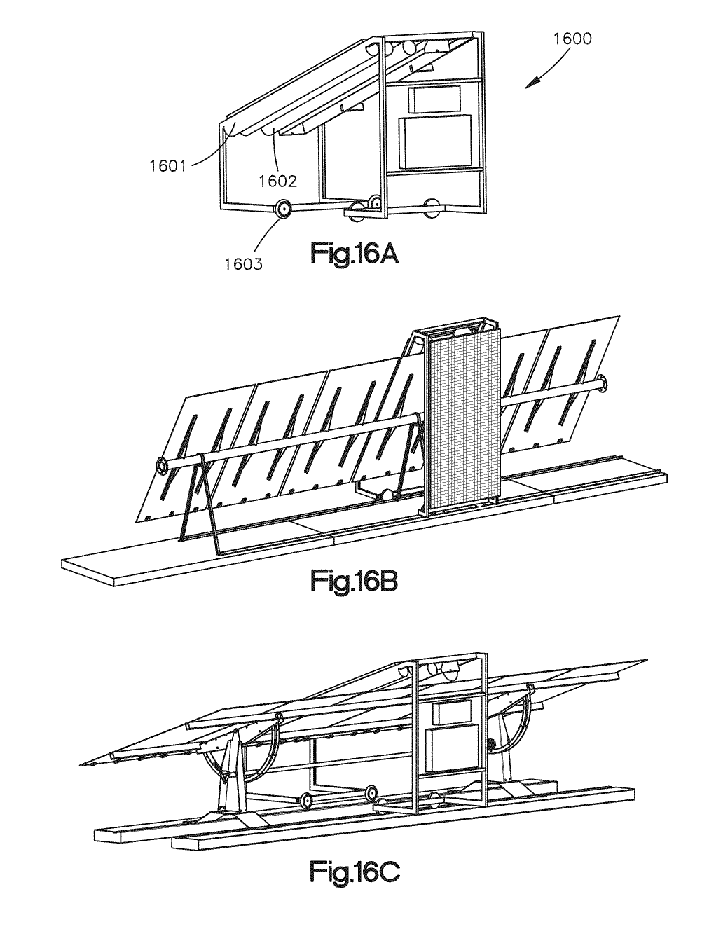

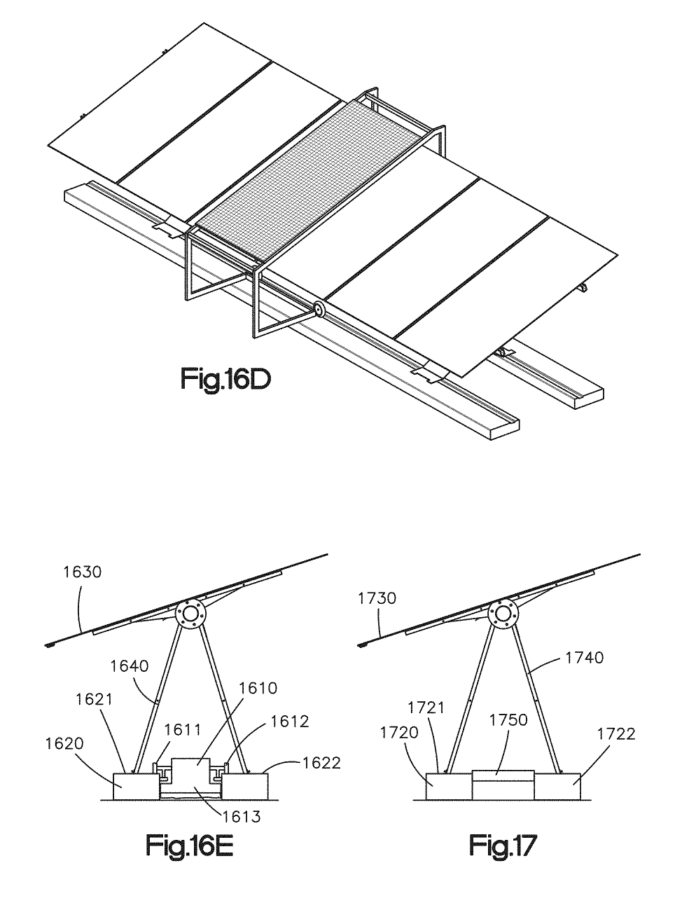

The present tracker, arc drive configuration, and/or table can be compatible with an autonomous cleaning/operation and maintenance (O&M) vehicle (SPOT) that travels along the track foundation(s). Exemplary embodiments of SPOT are described in U.S. Patent Publication No. 2015/0144156, the entire contents of which are incorporated by reference herein. Additional exemplary embodiments of SPOT are described further herein with reference to FIGS. 16A-16E.

Local and distributed options. In some embodiments, such as illustrated in FIGS. 8A and 8B, the present single-axis tracker includes a distributed foundation (e.g., one or more concrete tracks). In some embodiments, the mechanisms that support the table, rotate the table (e.g., arc drive), and support the modules can be distributed along the foundation. Additionally, or alternatively, each table is provided as an independent unit in which torque and motion are delivered by the drive tube. Additionally, or alternatively, in some embodiments, the strength of individual supports can be reduced as there can be any suitable number of supports to handle the load (the ability for structures to handle loads can change with their spatial distribution).

In some embodiments, the present single-axis tracker can include one or more tracks, e.g., concrete tracks, that can act as ballast. Such ballasting optionally can eliminate the need for a ground-penetrating foundation or can be used with a post-driven system or with a hybrid of the two approaches.

Split ballast/track options. In some embodiments, a table of modules optionally can be supported by a track, e.g., a split track that includes two sections such as in the non-limiting example shown in FIGS. 8A-8B, or by a track that includes one monolithic section. Such optional configurations can accommodate adhesive connection between the uprights and the concrete, or wet-set (e.g., embedment of a component or structural element into the body of the concrete before curing that is securely attached upon or after curing of the concrete. Exemplary methods for wet-setting uprights into an elongated concrete ballast are described elsewhere herein.

Number of arc drives per table options. The non-limiting exemplary table shown in FIG. 8A can include an arc drive (drive mechanism 862) at each upright. Alternative configurations optionally can include an arc drive at only some of the uprights, e.g., at only one of two uprights, or at another location of the table, e.g., at the center of the table, rather than at the uprights (one non-limiting example of such an embodiment being shown in FIG. 8B). In one example, the curved rack and pinion/spur gears at one of the uprights shown in FIG. 8A can be removed.

Bumper under pivot options. In some embodiments, padding optionally can be placed between the module and pivot point so as to protect the module in case of deflection. For example, FIG. 8C illustrates a non-limiting embodiment in which optional padding 819 is placed between module 811′ and pivot point 864 so as to protect the module in case of deflection. For example, in some embodiments, padding 819 can include rubber or other relatively soft material configured so as to prevent or inhibit the module from directly contacting the support or drive mechanism, e.g., purlin arm or arc-drive. Alternatively, or additionally, a support with adhesive can be used to limit panel deflection and constrain movement. Alternatively, or additionally, the pivot 864 can be located between panels, or far enough below panels that the deflection of panel 811′ does not come into contact with the support or drive mechanism, e.g., pivot components.

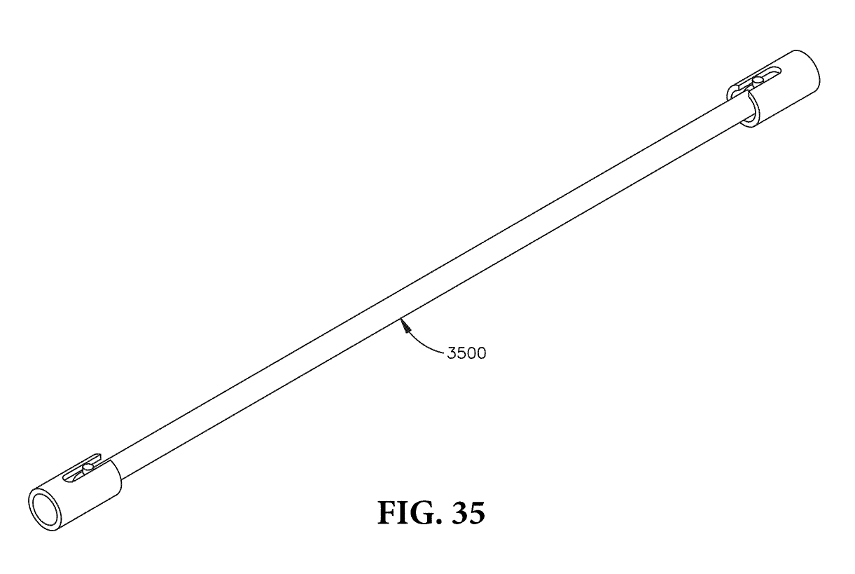

Square drive tube geometry options. It should be appreciated in that any suitable embodiment provided herein, the elongated structural member, e.g., drive tube, can have any suitable geometry, e.g., can have any suitable cross-sectional geometry. For example, the non-limiting configuration illustrated in FIGS. 8D-8E includes a tube with a square cross-section. FIGS. 8D-8E schematically illustrate perspective views of components of another exemplary table 812″ including exemplary rotational mechanism 820′. Mechanism 820′ can include bearing 863″, e.g., split plastic bearing, which is coupled to square drive tube 860″, spur gear 861″, and curved rack gear 862″. In the non-limiting configuration shown in FIGS. 8D-8E, the square drive tube 860″, bearing (e.g., split plastic bearing) 863″, and gear 861″ can be mechanically interlocked without the need for additional fasteners. Exemplary components of one non-limiting example of a drive tube, bearing, and gear, e.g., for use in an arc drive configuration, are illustrated in FIGS. 8D-8E. It should be understood that any suitable combination of such components can be included. For example, one or more components can be modified. In another example, one or more components can be removed. In yet another example, one or more components can be added. Another exemplary tube 3500 that can be used as a drive tube or a torque tube in a system or method provided herein is illustrated in FIG. 35.

Folding and/or A-shaped uprights options. Optionally, in some embodiments, one or more of the uprights that support the table can be A-shaped and/or can be hinged in a manner such as illustrated in FIGS. 8D-8E. For example, table 812″ illustrated in FIGS. 8D-8E can include uprights 815″ that are A-shaped and/or hinged. Such hinging can facilitate the uprights to fold during shipment and/or to accommodate different track (foundation/elongated concrete ballast) widths. Alternatively, or additionally, in some embodiments, the uprights can be shipped independent of one another and/or can be nested together, and then assembled (with or without an optional arm that pivots and attaches to the purlins), e.g., by inserting a pin. Alternatively, or additionally, the uprights can be A-shaped and can support the elongated structural member (e.g., drive tube), the protrusions (e.g., teeth of a spur gear), and drive mechanisms (e.g., curved racks). FIG. 31 schematically illustrates alternative table 3100 including alternative A-shaped uprights 3110.

FIG. 8F schematically illustrates a side view of another exemplary embodiment of a mechanism for arc drive integration with a track foundation. Mechanism 830 illustrated in FIG. 8F includes photovoltaic module 831, optionally which can be in portrait orientation; curb track 838; module-driven DC motor 841 every third or fourth module (having, for example, an estimated cost of $100 each); arc mechanism 842 that is movable responsive to actuation of motor 841 so as to tilt module 831; and spacer strut 844. Exemplary components of one non-limiting example of an arc-drive configuration are illustrated in FIG. 8F. It should be understood that any suitable combination of such components can be included. For example, one or more components can be modified. In another example, one or more components can be removed. In yet another example, one or more components can be added.

FIGS. 8G-8H schematically illustrate perspective views of a non-limiting embodiment of torque tube mechanism 845. In this example, mechanism 845 includes row 850 of PV modules 851 coupled to concrete track foundation 858 via uprights 852 coupled to panel supports 853; power, actuation, and control system (PAC) 871; torque tube 870; and optional flexible couplings 872 disposed along torque tube 870. Exemplary components of one non-limiting example of a single-axis tracker are illustrated in FIGS. 8G-8H. It should be understood that any suitable combination of such components can be included. For example, one or more components can be modified. In another example, one or more components can be removed. In yet another example, one or more components can be added. Optionally, foundation 858 includes one or more control joints 859 such as described elsewhere herein.

Illustratively, mechanism 845 can be included in a system for rotating photovoltaic modules 851 arranged in row 850. The system (e.g., mechanism 845) can include torque tube 870 extending along and parallel to row. Torque tube 870 can include a plurality of discrete sections coupled together with flexible couplings 872, the plurality of discrete sections being coupled to photovoltaic modules 851. The system or mechanism also can include an actuator, e.g., provided as part of PAC 871. Actuation of the actuator can rotate the discrete sections of torque tube 870 and flexible couplings 872. The rotation of the discrete sections of torque tube 870 and flexible couplings 872 can rotate photovoltaic modules 851. In a manner similar to that described elsewhere herein, photovoltaic modules 851 optionally can be arranged in a plurality of independent tables, each table being coupled to a discrete section of torque tube 870 and extending parallel to row 850. At least one of the flexible couplings 872 optionally can be disposed between each of the tables, e.g., at least at least two of the flexible couplings can be disposed between each of the tables. The flexible couplings 872 can allow articulation of the discrete sections of the torque tube between the tables. Additionally, or alternatively, he system/mechanism further can include elongated concrete ballast 858 extending along and parallel to row 850 and upon which the photovoltaic modules 851 are disposed. Optionally, elongated concrete ballast 858 follows an irregular geological topology, and torque tube 870 can follow the irregular geological topology via the articulation of the discrete sections of the torque tube. Illustratively, flexible couplings 872 can allow articulation of the discrete sections of torque tube 870 and/or can transmit longitudinal forces to compensate for thermal expansion or contraction or seismic effects.

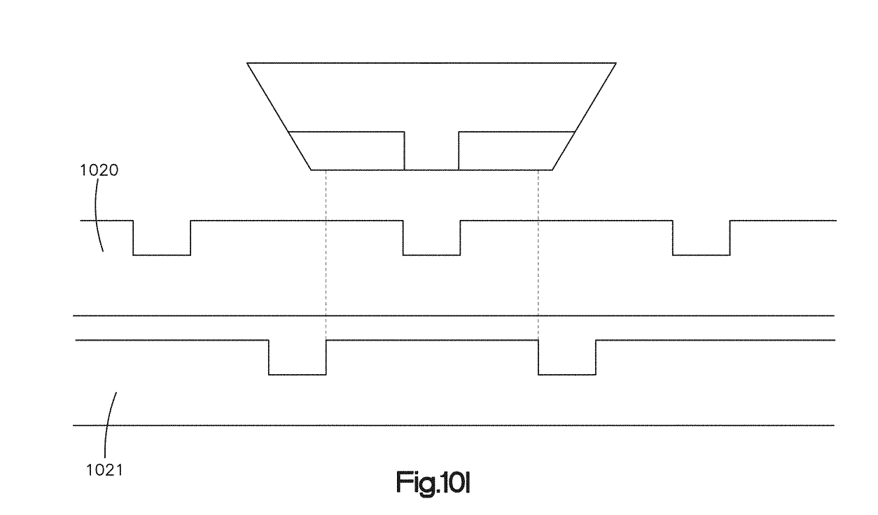

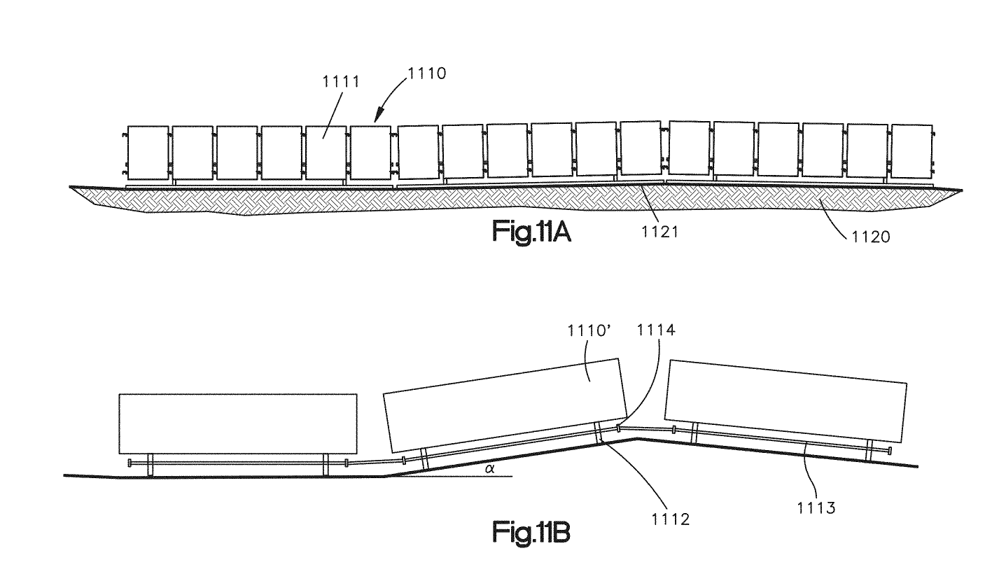

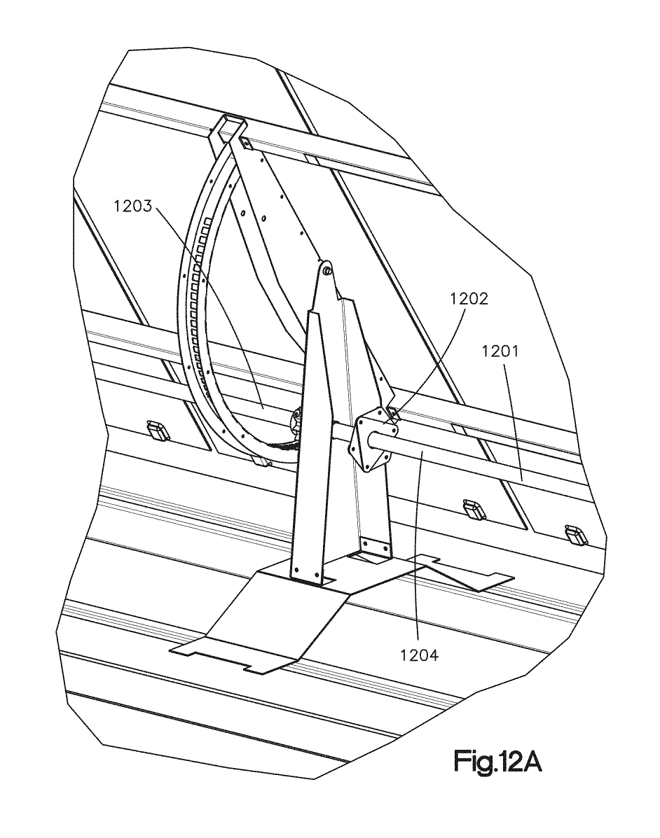

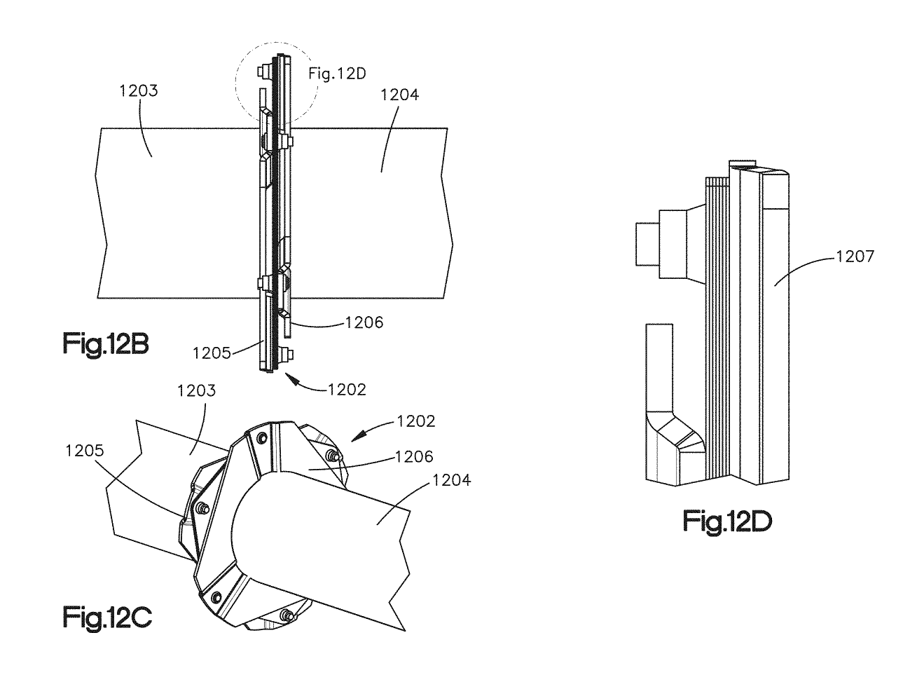

Exemplary embodiments of flexible couplings suitable for use in mechanism 845 are described herein, such as with reference to FIG. 12A-12F, 13A-13C, 14A-14Y, or 32. For example, each flexible coupling 872 optionally can include a first flange coupled to a first discrete section of torque tube 870; a second flange coupled to a second discrete section of torque tube 870; and one or more fasteners coupling the first flange to the second flange. As another example, each flexible coupling 872 can include a sleeve that can include a first end, a second end, and a lumen connecting the first and second ends, the lumen at the first end receiving a portion of a first discrete section of the drive tube, the lumen at the second end receiving a portion of a second discrete section of the drive tube.

FIG. 8I illustrates another exemplary embodiment of a single-axis tracker. More specifically, FIGS. 8I-1 and 8I-2 (collectively referred to herein as FIG. 8I) illustrate a plurality of rows 850′, each of which can include any suitable number of panels 851′ (PV modules) per row, e.g., 20, or 40, or 60 or more panels per row (1, 2, 3 strings of panels per row, or more), and any suitable number of rows 850′. Torque-transmitting tube 870′ (torque tube) transmits torque between actuator(s) 871′ and panels 851′. Concrete ballast 858′, which optionally includes one or more concrete control joints 859′, supports tube supports (uprights) 852′ and optionally also supports actuators 871′. Tube supports 852′ can connect torque tube 870′ to concrete ballast 858′, can allow rotation for pivoting to track the sun, and/or can allow sliding (e.g., of torque tube 870′) for thermal expansion/contraction. Panel supports 853′ can connect panel(s) 851′ to tube 870′ (e.g., rigidly attached). Torque tube 870′ optionally can include universal joints 872′ or other torque-transmitting, flexible joint(s) such as described elsewhere herein. Such joints 872′ can allow for differential concrete settlement and/or other ground support disruption. In one non-limiting example, tube supports 852′ and/or panel supports 853′ (which collectively can be referred to as support parts) can be made of, or include, plastic, and can have high lubricity and do not need to be grounded. Additionally, or alternatively, in one non-limiting example, torque tube 870′ can include metal tube parts, which can have a single grounding path and/or a high load carrying capacity (torque and shear).

Optionally, actuators 871′ can be connected across rows, e.g., using linking member 872′ which can be configured similarly as other linking members provided herein, so as to provide torsional resistance to loads. Optionally, the connection provided by linking member 872′ can happen on or be provided on the ground (like a speed bump) so that it can be driven over by typical construction equipment. Optionally, actuator 871′ control wiring and power plant power wiring can also be housed in this speed bump (linking member 872′). Optionally, actuator 871′ can include a worm drive or slew actuator, and optionally is non-backdrivable. Torque tube 870′ can come out of both sides of actuator 871′.

Options for torque tube configurations such as illustrated in FIGS. 8G-8I include one or more of the following:

The non-limiting, exemplary torque tube configuration such as shown in FIGS. 8G-8I optionally can include a single row of modules in landscape orientation. In some embodiments, the tracker can be configured to include two modules in landscape or a single row of modules in portrait; and/or

In some embodiments, an optional windfence can be installed around the perimeter of PV arrays. This eliminates the need to upsize components on array edges to resist higher wind loads; and/or

In some embodiments, the tracker optionally can include one or more masses that can act as a counterweight to the modules, for example, so as to reduce the torque demands on the motor and torque tube; and/or

The tracker optionally can be configured so as to include a restraint mechanism to inhibit contact between the modules and the uprights; and/or

This tracker optionally can include one or more flexible couplings, e.g., so as to accommodate undulations in terrain, as described elsewhere herein.

Exemplary configurations for counterweights, restraint mechanisms, and windfences are described elsewhere herein.

Gear ratio stiffness options. In various embodiments provided herein, e.g., arc-drive based embodiments, there is a gear ratio between the spur gear and the arc drive (for example, in one configuration the ratio is 1:10). In some embodiments, any torque applied to panels of a table can be resisted by the arc drive. In some embodiments, the arc drive connects the panels on the table to the drive tube using a gear reduction. Thus, in some embodiments, applying torque to a panel on the table can transmit an amount of torque reduced by the gear ratio to the drive tube. In some embodiments, the actuator holds the drive tube stationary in one location. Thus, in some embodiments, the drive tube can experience some amount of rotation along the length of the drive tube, also called a torsional deflection. In some embodiments, this torsional deflection can cause a movement of the table, and thus the panels, with this movement being the same as the drive tube rotation but reduced by the gear ratio. As a result, in some embodiments, the torsional stiffness of the panels on the table (which can be defined as the movement of the panels divided by the torque applied to the panels) can be the torsional stiffness of the drive tube multiplied by the gear ratio squared. (In the case of a 1:10 gearbox, the stiffness increases by 100×). Exemplary relationships between such components are schematically illustrated in FIG. 8J.

For example, a local gear ratio optionally can provide more stiffness with less structure, and/or optionally can provide by a distributed foundation via rotational stiffness, which optionally can be a constraint on tracker design and/or optionally can increase with the square of the gear ratio. In one non-limiting example of the present single-axis tracker, a gear ratio can be 1:10, the stiffness multiplier can be 100×, a tube diameter can be 2 inches, and the number of panels per row can be 120. Exemplary components and configurations are described. It should be understood that any suitable combination of such components can be included. For example, one or more components can be modified. In another example, one or more components can be removed. In yet another example, one or more components can be added.

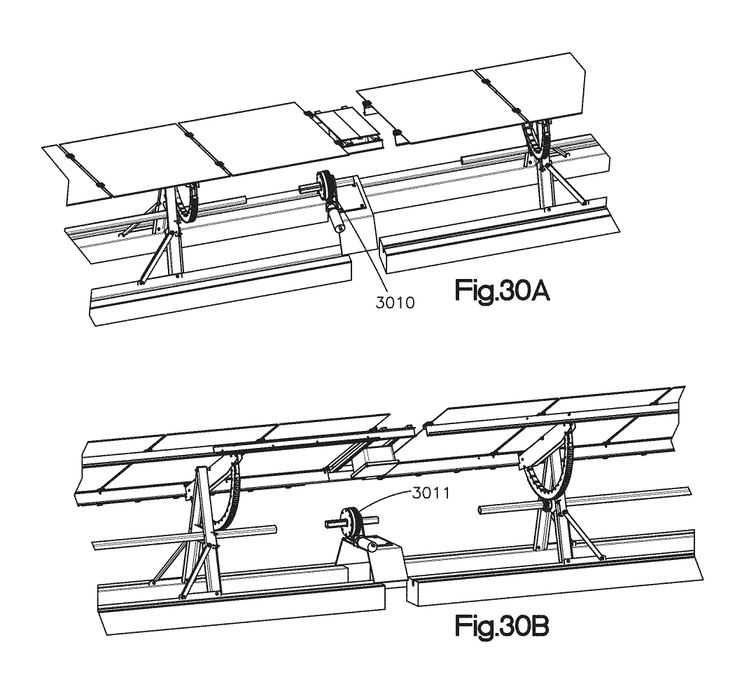

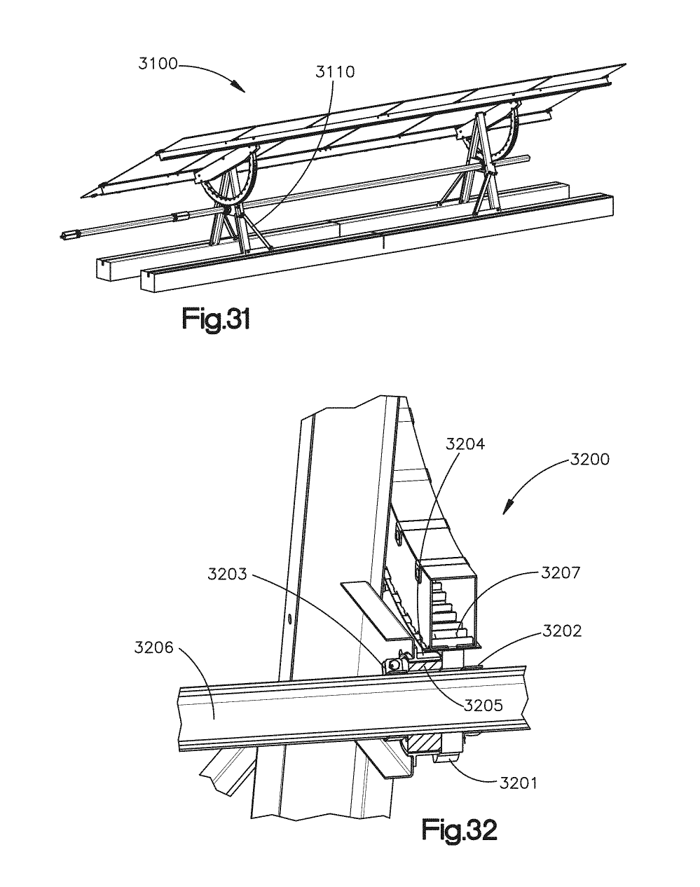

FIGS. 30A-30B respectively schematically illustrate exemplary actuators 3010, 3011 that can be used in the present systems and methods, e.g., so as to rotate a drive tube or a torque tube, optionally in a ganged configuration.

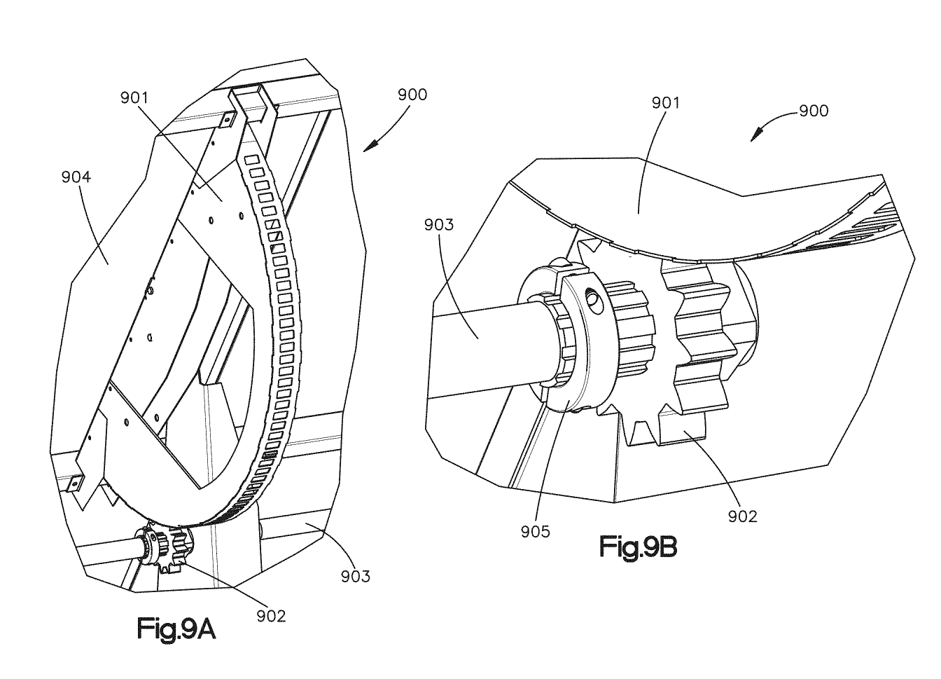

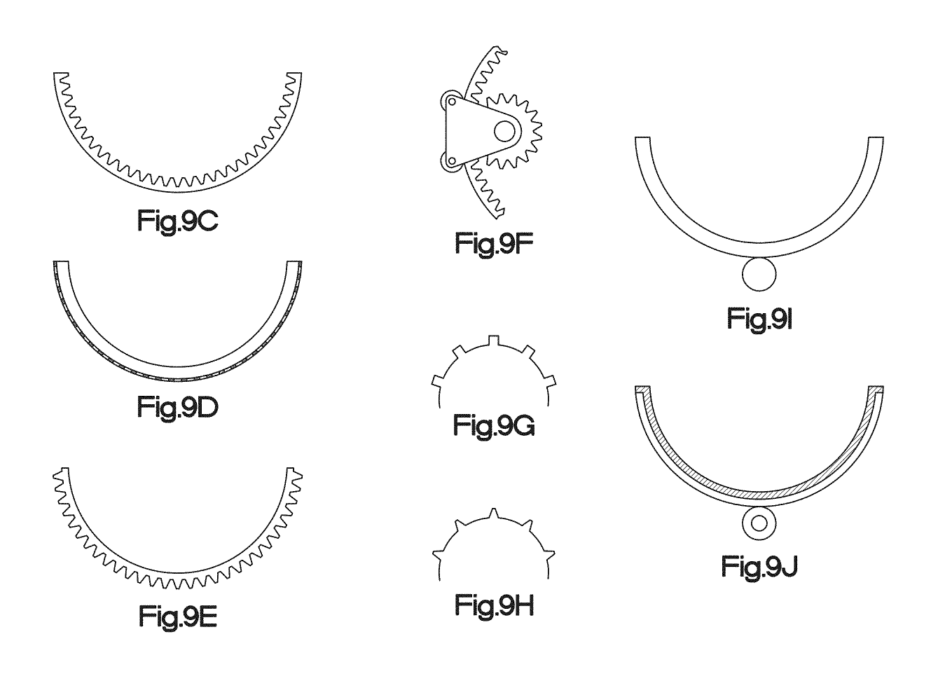

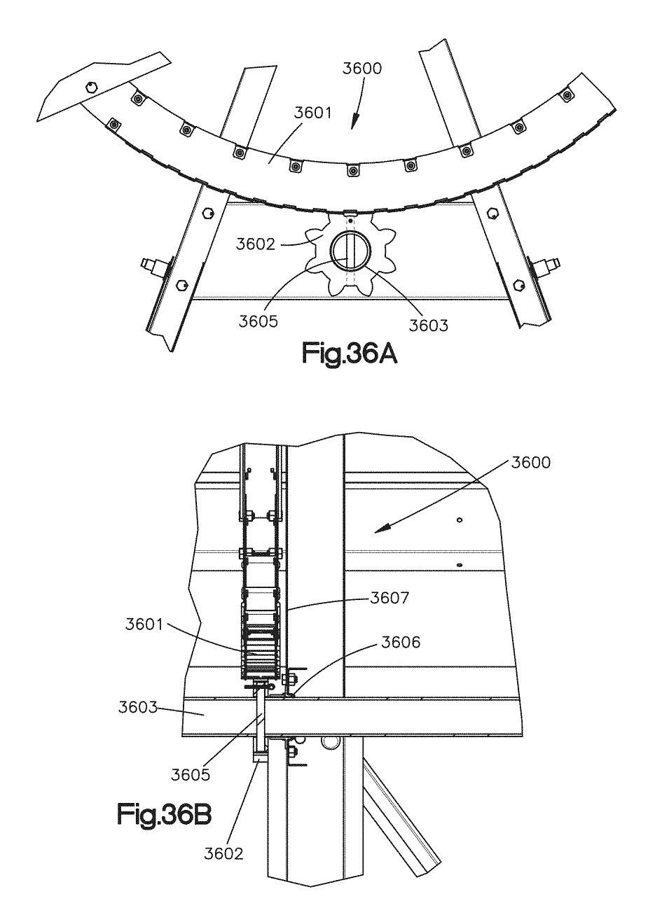

FIGS. 9A-9J schematically illustrate views of various exemplary components of an arc drive mechanism such as suitable for use in certain systems and methods provided herein. FIGS. 9A-9B schematically illustrate perspective views of one exemplary embodiment of rotational mechanism 900 including arc drive 901 and spur gear 902. Protrusions of spur gear 902 (e.g., teeth of spur gear) can engage with spaces within arc drive 901. For example, spur gear 902 and arc drive 901 can mesh together in such a manner that rotation of spur gear 902 caused by rotation of drive tube 903 coupled to drive tube 902 causes arc drive 901 to rotate so as to rotate PV module 904 coupled thereto. In some embodiments, arc drive 901 can include, or can be made of, a single piece or multiple pieces assembled together. Optionally, one or more components of arc drive 901 can include stainless steel, e.g., so as to reduce corrosion at locations where arc drive 901 and spur gear 902 meet. One or more other components of arc drive 901 optionally can include galvanized steel. Optionally, spur gear 902 can include stainless steel, aluminum, or a polymer. In some embodiments, spur gear 902 can be coupled to drive tube 903 via slide interface 905 which is configured so as to permit spur gear 902 to shift laterally along drive tube 903, e.g., responsive to thermal expansion or contraction of drive tube 903 over the course of the day, while maintaining rotational engagement of spur gear 902 with drive tube 903. Alternatively, spur gear 902 can be laterally fixed relative to drive tube 903. For example, drive tube 903 could include a hole, and spur gear 902 could be locked into place using a pin in a manner such as described herein with reference to FIGS. 36A-36B. Exemplary embodiments of one non-limiting example of an arc-drive configuration are illustrated in FIGS. 9A-9B. It should be understood that any suitable combination of such components can be included. For example, one or more components can be modified. In another example, one or more components can be removed. In yet another example, one or more components can be added. Illustratively, although drive tube 903 is illustrated in FIGS. 9A-9B as having a circular cross-section, the drive tube instead could have a square cross-section such as described elsewhere herein.

FIGS. 36A-36B schematically illustrate side and cross-sectional views of another exemplary embodiment of rotational mechanism 3600 including arc drive 3601 and spur gear 3602. Protrusions of spur gear 3602 (e.g., teeth of spur gear) can engage with spaces within arc drive 3601. For example, spur gear 3602 and arc drive 3601 can mesh together in such a manner that rotation of spur gear 3602 caused by rotation of drive tube 3603 coupled to drive tube 3602 causes arc drive 3601 to rotate so as to rotate a PV module coupled thereto (not specifically illustrated). In some embodiments, arc drive 3601 can include, or can be made of, a single piece or multiple pieces assembled together. Optionally, one or more components of arc drive 3601 can include stainless steel, e.g., so as to reduce corrosion at locations where arc drive 3601 and spur gear 3602 meet. One or more other components of arc drive 3601 optionally can include galvanized steel. Optionally, spur gear 3602 can include stainless steel, aluminum, or a polymer. In some embodiments, spur gear 3602 can be coupled to drive tube 3603 via an interlocking mechanism 3605, such as a pin which is configured so as to lock spur gear 3602 to drive tube 3603 in such a manner as to inhibit rotation of spur gear relative to drive tube 3603. Optionally, spur gear 3602 can be laterally fixed relative to drive tube 3603. Bushing 3606 can support drive tube 3603 relative to upright 3607. Exemplary embodiments of one non-limiting example of an arc-drive configuration are illustrated in FIGS. 36A-9B. It should be understood that any suitable combination of such components can be included. For example, one or more components can be modified. In another example, one or more components can be removed. In yet another example, one or more components can be added. Illustratively, although drive tube 3603 is illustrated in FIGS. 36A-9B as having a circular cross-section, the drive tube instead could have a square cross-section such as described elsewhere herein.

Arc drive options. The arc drive can have many other configurations, some exemplary options of which are schematically illustrated in FIGS. 9C-9F. In some embodiments, the gear profiles (and thus the optional spur/pinion gear) can be on the inside of the curved rack (e.g., such as shown in FIGS. 9C and 9F) or on the outside of the curved rack (e.g., such as shown in FIGS. 9A-9B, 9D, and 9E). Additionally, or alternatively, in some embodiments, the optionally curved rack gear teeth profiles optionally can be made by bending pieces of metal or other material in the shape of a gear (e.g., such as shown in FIG. 9E), and/or by cutting holes in the sheetmetal itself (e.g., such as shown in FIG. 9D) to allow for the spur gear teeth to engage, and/or by cutting gear teeth shapes into the sidewalls of the curved rack side flanges (e.g., C- or V-shaped cross section) or central flanges (e.g., T-shaped cross section). Additionally, or alternatively, the gear shaped teeth can be cut into flat pieces of steel or other material and used as a single layer of material or combined with other layers and materials into a multi-layered or composite assembly.

Gear options. The gears and arc drive mechanisms can have many different configurations, some options of which are schematically illustrated in FIGS. 9G-9J. For example, FIGS. 9G and 9H schematically illustrate exemplary gear tooth profiles suitable for use in a spur gear in one of the present systems and methods. As another example, FIGS. 91 and 9J schematically illustrate alternative embodiments of arc drive mechanisms that respectively include a friction wheel and a wire and capstan. Exemplary variations include different types of gear shapes, including roller gears, involute gears, friction drives, and/or wire and capstan drives (tensioned or untensioned).

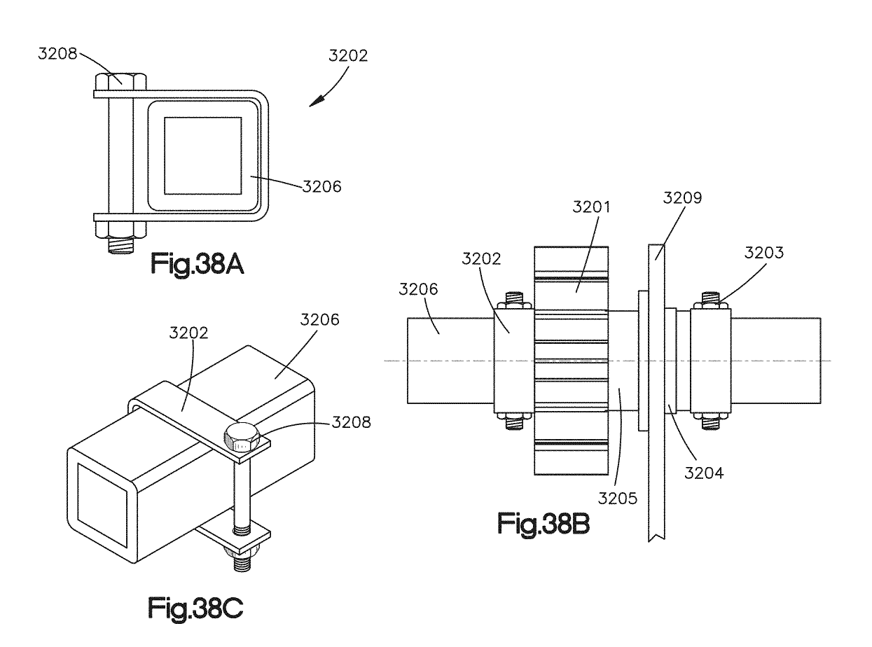

Another exemplary arc drive mechanism 3200 is illustrated in FIGS. 32 and 38A-38C. Mechanism 3200 includes pinion gear 3201 that engages with arc drive 3207 such that rotation of drive tube 3206 responsive to actuation of an actuator causes rotation of the arc drive. Pinion gear 3201 can be coupled to drive tube 3206, which can have a generally square cross-section, via clamps 3202, 3203, round/square adapter 3205, and bushing 3204. Optionally, the assembly can include a spacer to keep bushing 3204 from backing out. As shown in FIGS. 38A and 38C, exemplary clamp 3202 can be coupled to drive tube 3206 (clamp 3203 optionally can be configured similarly). In one example, clamp 3202 can include a structurally stiff material, such as sheet metal, that is shaped so as to receive drive tube 3206 and that can be securably engaged to drive tube 3206 via suitable fastener 3208, such as a bolt/bobtail. Optionally, pinion gear 3201 can include a square aperture that is sufficiently large as to permit lateral/longitudinal movement of pinion gear 3201 along drive tube 3206, and that is sufficiently small as to inhibit significant rotational movement of pinion gear 3201 relative to drive tube 3206. As shown in FIG. 38B, clamps 3202, 3203 respectively can inhibit lateral movement of pinion gear 3201 beyond selected lateral points of drive tube 3206. Bushing 3204 can support drive tube 3206 on a corresponding aperture (not specifically illustrated) through upright 3209 while permitting rotational movement of drive tube 3206 responsive to actuation of an actuator (not specifically illustrated). As such, arc drive mechanism 3200 can decouple lateral/longitudinal constraints of pinion gear 3201 from rotational constraints.

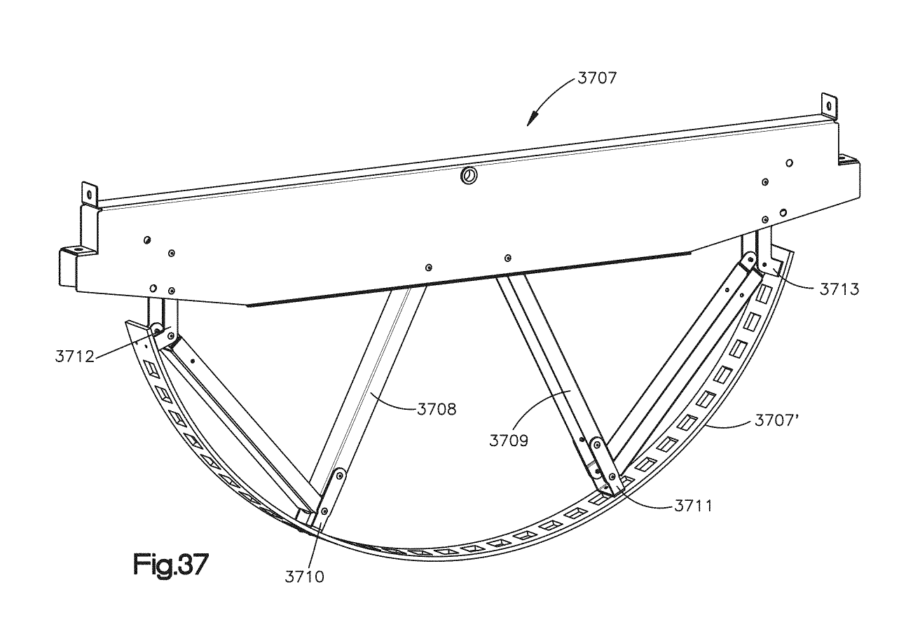

Yet another exemplary arc drive 3707 is illustrated in FIG. 37. Arc drive 3707 engages with a corresponding pinion gear (not specifically illustrated) such that rotation of a drive tube (not specifically illustrated) responsive to actuation of an actuator causes rotation of the pinion gear, which causes rotation of the arc drive. In the non-limiting example illustrated in FIG. 37, arc drive 3707 includes first and second trusses 3708, 3709, each of which can include one or more structural members providing a V-shaped support that contacts the curved portion 3707′ of arc drive 3707 at one or more points, e.g., at one or both of points 3710, 3712 for first truss 3708, and at one or both of points 3711, 3713 for second truss 3709. Optionally, the photovoltaic module to which arc drive 3707 is coupled can be stowed by rotating the drive tube so as to rotate arc drive 3707 (via the pinion gear) to a position at which the pinion gear is disposed adjacent to one of points 3710, 3711, 3712, or 3713 (e.g., adjacent to point 3710 or point 3711), at which point the corresponding one of trusses 3708, 3709 can provide additional support to arc drive 3707 and to the pinion gear engaged therewith.

Optionally, any of the embodiments provided herein can include one or more stop members configured to inhibit rotation of the photovoltaic modules beyond a preselected angle. As one example, the mechanism illustrated in FIG. 8C optionally can include pin 865 or other component interference to limit rotation and/or transmit wind loads (including but not limited to stow wind loads) directly into the structure instead of through the torque/motion transmitting elements (e.g., arc drive and drive tube).

Pivot stops and/or restraints options. In some embodiments, the table of modules reaches its limit of travel when the purlin contacts the uprights. In some embodiments, this provides a secure position for stowing the tables during high wind events. In some embodiments, the contact between the purlin and uprights sends the stow loads through the structure. Additionally, or alternatively, some embodiments include a pin that attaches to each arc drive (e.g., pin 865). In some such embodiments, the limit of travel is reached when the pin contacts the upright.

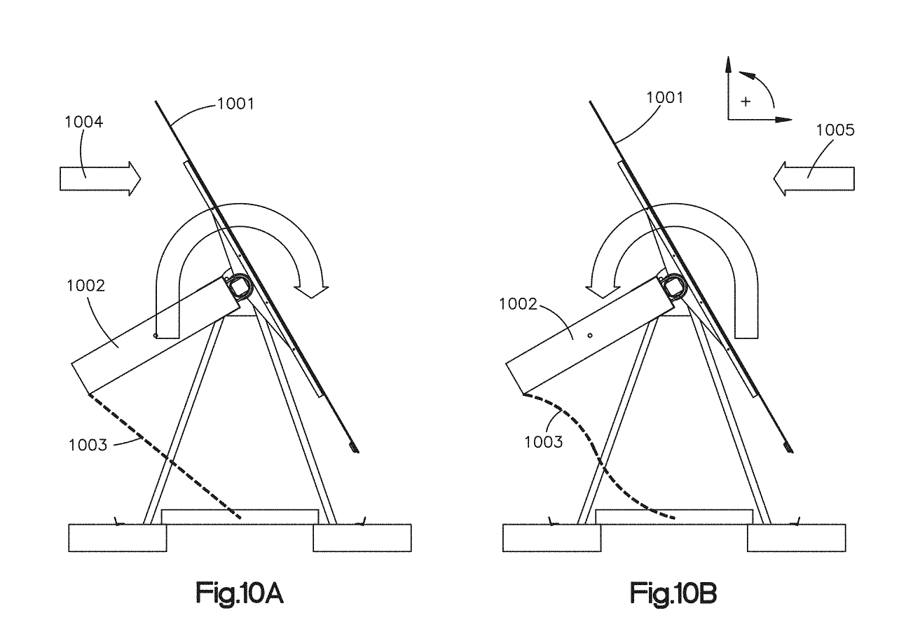

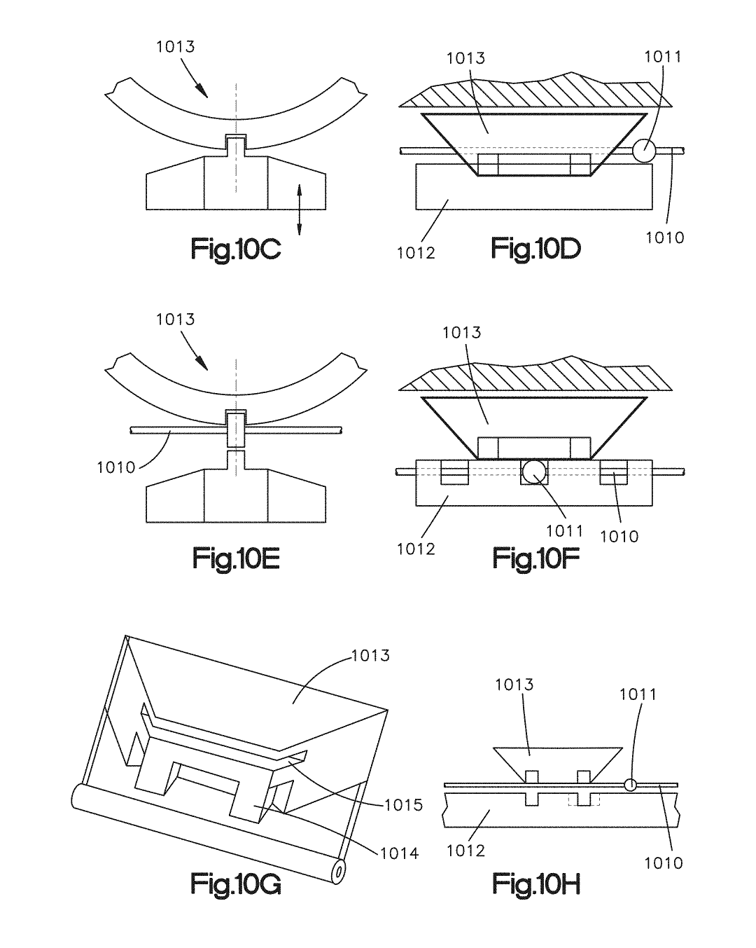

Alternatively, the stop members can include flexible members that are pulled taut when the photovoltaic modules reach the preselected angle, or include fixed members that the photovoltaic modules contact when reaching the preselected angle. For example, in the non-limiting, exemplary configuration shown in FIGS. 10A-10B, the limit of travel of table 1001 optionally can be controlled by an optional limit travel arm 1002 (e.g., counterweight and limit travel arm) and/or an optional restraint wire, cable, or chain 1003. In some embodiments, wind loads trying to rotate the module 1001 and structure can be predominantly in the clockwise rotation shown in FIG. 10A (wind load 1004, in which constraint of wire, cable, or chain 1003 limits rotation) and less in the counterclockwise direction shown in FIG. 10B (wind load 1005, in which constraint of wire, cable, or chain 1003 does not limit rotation). Note that embodiments such as illustrated in FIGS. 10A-10B can be used with drive tube based embodiments and/or with torque tube based embodiments.

Counterweight options. In some embodiments, such as illustrated in FIGS. 10A-10B, the present single-axis tracker optionally can include counterweights (e.g., included in optional limit travel arm 1002) so as to balance the mass of the tables around the pivot points. In some embodiments, such counterweights can reduce torque on system components. In some embodiments, optional counterweights (e.g., included in optional limit travel arm 1002) can include pipes filled with a suitable material, e.g., can include steel pipes filled with concrete.

FIGS. 10C-10H illustrate another embodiment of an exemplary rotation mechanism including a stop member (locking device). The rotation mechanism can be for converting cable 1010 motion into indexing motion (linear or rotational; direct or indirect action on panel). In one example, the passage of cable 1010 is allowed when no ball 1011 is present. The indexed device 1012 is not allowed to move since locking device 1013 does not allow that movement. When ball 1011 enters the mechanism, the locking device 1013 is pushed out of the locking position, and unlocks the indexed device 1012. Ball 1011 then moves the indexed device 1012 a specified amount, and is constrained by the locking device 1013. Ball 1011 then exits the mechanism and allows the locking device 1013 to re-engage, which stops further motion of the indexed device 1012. The operation of the locking device 1013 may include multiple levels, which may include a locking level (e.g., locking teeth 1014) and a wire groove level (e.g., wire groove 1015). In the embodiment illustrated in FIG. 10I, multiple levels may exist, including locking and moving levels, or bands. In one example, locking band 1020 and moving band 1021 can be the same part as one another. FIG. 10I illustrates transitions from a locked position to a moving position, and again to a locked position. The indentations in the locking band/moving band 1020, 1021 can be long enough for full entry and unlocking, and can include locking key slop.

Additionally, or alternatively, any suitable embodiments provided herein can be adapted so as to follow irregular terrain, e.g., uneven ground, at an installation site. The ground can be uneven to begin with, or can become uneven due to settling, erosion, or seismic activity, for example. In one example, a system for rotating photovoltaic modules arranged in a row can include a drive tube extending along and parallel to the row. The system can include the drive tube including a plurality of discrete sections coupled together with flexible couplings; an actuator; and drive mechanisms coupled to the photovoltaic modules. Actuation of the actuator can rotate the discrete sections of the drive tube and the flexible couplings, the rotation of the discrete sections of the drive tube and the flexible couplings can rotate the drive mechanisms, and the rotation of the drive mechanisms rotates the photovoltaic modules. Exemplary drive tubes, actuators, drive mechanisms, and flexible couplings are described elsewhere herein. In some embodiments, the photovoltaic modules are arranged in a plurality of independent tables, each table including one or more of the drive mechanisms and extending parallel to the row. In some embodiments, at least one of the flexible couplings is disposed between each of the tables. For example, at least two of the flexible couplings can be disposed between each of the tables. The flexible couplings can allow articulation of the discrete sections of the drive tube between the tables, can transmit torque from the actuator to the drive mechanisms, and/or can transmit longitudinal forces to compensate for thermal expansion or contraction or seismic effects. The system further can include an elongated concrete ballast extending along and parallel to the row and upon which the photovoltaic modules are disposed, wherein the elongated concrete ballast follows an irregular geological topology, and wherein the drive tube follows the irregular geological topology via the articulation of the discrete sections of the drive tube.

For example, FIGS. 11A and 11B schematically illustrate exemplary options for following irregular terrain in a system for rotating photovoltaic modules arranged in a row, according to some embodiments. Any suitable combination of options, such as described below or elsewhere herein, can be used.

Independent tables options. In some embodiments, the present single-axis tracker includes any suitable number of independent groups of PV modules, or “tables.” In the non-limiting example illustrated in FIG. 11A, each table 1110 includes 6 modules 1111, but the tables can have more or fewer modules per table (e.g., one, two, three, four, five, six, seven, eight, nine, ten, or more than ten modules 1111 per table 1110).

Control joints and/or ballast sections options. In some embodiments, optional control joints 1121 or cuts on the foundation tracks 1120 (elongated concrete ballast) can isolate each table 1110 from neighboring tables, or optionally can isolate uprights (not specifically illustrated) from each other. In one nonlimiting example, there can be two uprights per section of ballast (foundation) 1120 between control joints 1121, or one upright for every section of ballast 1120 between control joints 1121. Optionally, the section of track (foundation 1120) under a given table 1110 can contain a control joint 1121, e.g., if the concrete is not reinforced; in some embodiments of such an option, each section of track (foundation) 1120 supports one upright. Optionally, the section of track (foundation) 1120 under a given table may not necessarily need to include a control joint, e.g., if the concrete is reinforced such as with rebar, fibers, or another reinforcing material. Alternatively, or additionally, the foundation 1120 can be reinforced or otherwise configured such that the foundation can span multiple tables or entire rows without control joints.

Terrain following options. In some embodiments, optionally independent tables combined with optional flexible couplings in the drive tube (such as described elsewhere herein) can facilitate the single-axis tracker to follow terrain such as schematically shown in FIG. 11A Such a configuration also can make the tracker resistant to thermal and seismic effects.

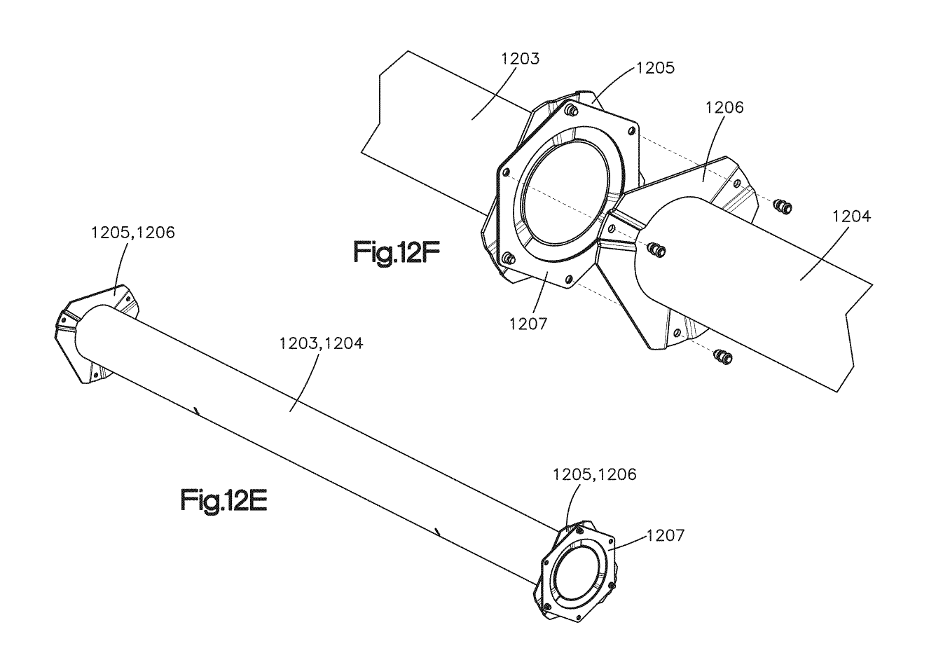

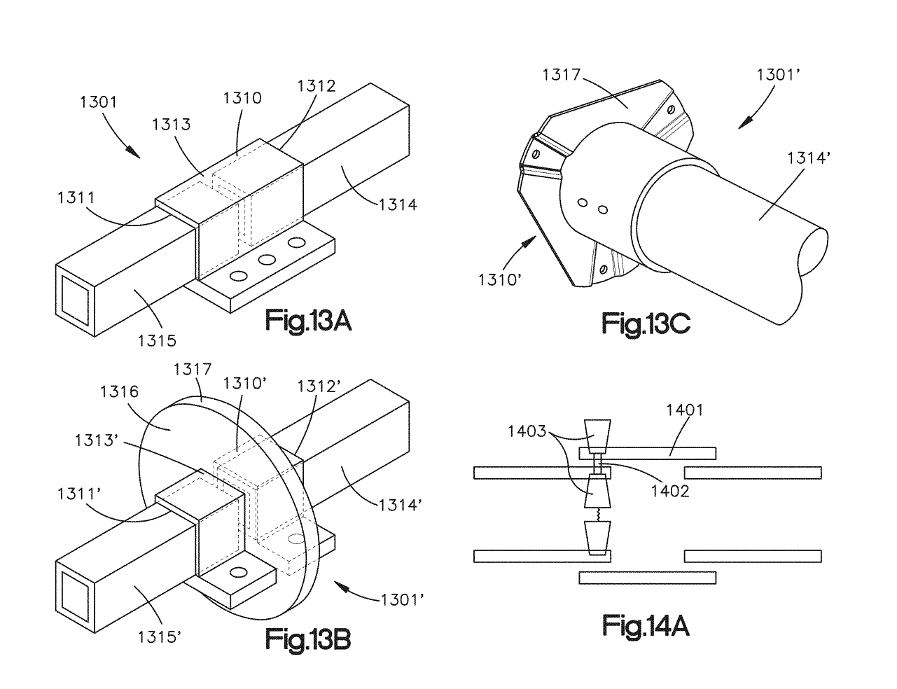

In some embodiments, the present single-axis tracker can accommodate uneven terrain such as schematically shown in FIG. 11B. For example, in one non-limiting embodiment, each table 1110′ is supported by any suitable number of uprights 1112 (e.g., two uprights) such that drive tube 1113 for that table can remain substantially straight between the uprights 1112 without bending. In some embodiments, sections of drive tube 1113 optionally can be connected with flexible couplings 1114 that can act to transmit torque (and potentially longitudinal forces to compensate for thermal expansion/contraction or seismic effects) but also can allow for angular misalignment, e.g., such as can arise from irregular terrain at the installation site. Illustratively, placing one or more flexible couplings, e.g., two flexible couplings, between uprights 1112 can allow for one or both of angular misalignment and lateral and/or vertical offsets. In some embodiments, each flexible coupling includes a first flange coupled to a first discrete section of the drive tube; a second flange coupled to a second discrete section of the drive tube; and one or more fasteners coupling the first flange to the second flange, e.g., such as described herein with reference to FIGS. 12A-12F. In other embodiments, each flexible coupling can include a sleeve that includes a first end, a second end, and a lumen connecting the first and second ends, the lumen at the first end receiving a portion of a first discrete section of the drive tube, the lumen at the second end receiving a portion of a second discrete section of the drive tube, e.g., such as described herein with reference to FIGS. 13A-13B.

Continuous drive tube options. In some embodiments, the present drive tubes can transmit torque over a relatively long distance (the drive tube optionally can be the only component of the system that transmits torque over such a distance). In some embodiments, the torque on the drive tube can be reduced or minimized based on the gear ratio between the drive tube and the arc drives on the tables in a manner such as described elsewhere herein. Additionally, or alternatively, the effect of deflections can be reduced by the gear ratio.

FIGS. 12A-12E, 13A-13C, and 14A-14Y schematically illustrate exemplary flexible couplings that can be used in a system for rotating photovoltaic modules arranged in a row, according to some embodiments. Any suitable number of such flexible couplings can be included along one of the present elongated structural members, e.g., along a drive tube or torque tube. For example, FIG. 12A illustrates detail of one exemplary embodiment of components of a drive tube, e.g., in an embodiment of an arc drive-based rotational mechanism that includes drive tube 1201 including one or more flexible couplings 1202 coupling discrete segments 1203, 1204 of the drive tube to one another. Exemplary components of one non-limiting example of a drive tube and flexible coupling, e.g., for use in an arc-drive configuration, are illustrated in FIG. 12A. It should be understood that any suitable combination of such components can be included. For example, one or more components can be modified. In another example, one or more components can be removed. In yet another example, one or more components can be added.

FIGS. 12B-12F illustrate an optional configuration of flexible coupling 1202 illustrated in FIG. 12A. Flexible coupling 1202 can include optional flanges optionally welded to drive shaft (drive tube) 1201, e.g., flange 1205 coupled (for example, welded) to segment 1203 of drive shaft 1201, and flange 1206 coupled (for example, welded) to segment 1204 of drive shaft (drive tube) 1201. Flanges 1205, 1206 can be coupled to one another, for example, using 6× (or other suitable number) of bobtail fasteners or other suitable fasteners. FIG. 12D illustrates an optional stainless steel (SS) disc pack 1207, e.g., that can be disposed between flanges 1205, 1206. Drive shaft segments 1203, 1204 each optionally have “half” of the coupling assembled to each end, e.g., in the factory or field, such as flange 1205 or 1206. The optional flange 1205, 1206 can be attached to optional disc pack 1207 with any suitable number of suitable fasteners, e.g., 3X bobtail fasteners. The couplings optionally are attached in the field or factory with any suitable number of fasteners, e.g., 3X bobtails or other fasteners. Exemplary components of one non-limiting example of a drive tube and coupling, e.g., for use in an arc-drive configuration, are illustrated in FIGS. 12B-12F. It should be understood that any suitable combination of such components can be included. For example, one or more components can be modified. In another example, one or more components can be removed. In yet another example, one or more components can be added.

Flex coupling configuration options. The optional flexible couplings optionally can be welded onto sections of drive tube. The couplings also, or alternatively, can be configured so that they attach with suitable fasteners, e.g., bolts or set screws, or adhesive, e.g., in a direct attach method (e.g., bolted/glued together) or by clamping (e.g., the bolt clamps the two pieces together, either directly or indirectly by themselves or by the introduction of a third component). Additionally, or alternatively, the pieces can be fit together while at elevated or depressed temperature, and then allowed to return to normal temperature to clamp them together. Additionally, or alternatively, the optional flexible couplings can be mounted on any suitable shape of drive tube, e.g., round, square, pentagon-shaped, hexagonal, octagonal, or other shape drive tube, using any suitable attachment, such as but not limited to bolting, clamping, adhesive, or thermal methods of attachment. Alternatively, or additionally, these couplings can be made rigid (e.g., do not allow for angular misalignment). Alternatively, or additionally, the drive tube itself can be flexible enough to account for angular misalignment.

Additional exemplary flexible couplings are illustrated in FIGS. 13A-13C. For example, FIG. 13A schematically illustrates a perspective view of flexible coupling 1301 including sleeve 1310 that can include first end 1311, second end 1312, and lumen 1313 connecting the first and second ends. Lumen 1313 at first end 1311 receives a portion of a first discrete section (segment) 1315 of the drive tube, and lumen 1313 at second end 1312 receives a portion of a second discrete section (segment) 1314 of the drive tube. In one non-limiting example, a coupling between sections of a square drive tube can have an appearance such as shown in FIG. 13A. In one non-limiting example, the coupling is secured with bolts or any other suitable fastener. Exemplary components of one non-limiting example of a drive tube and coupling, e.g., for use in an arc-drive configuration, are illustrated in FIG. 13A. It should be understood that any suitable combination of such components can be included. For example, one or more components can be modified. In another example, one or more components can be removed. In yet another example, one or more components can be added.

FIGS. 13B and 13C schematically illustrate a perspective view of flexible coupling 1301′ including sleeve 1310′ that can include first end 1311′, second end 1312′, and lumen 1313′ connecting the first and second ends. Lumen 1313′ at first end 1311′ receives a portion of a first discrete section (segment) 1315′ of the drive tube, and lumen 1313′ at second end 1312′ receives a portion of a second discrete section (segment) 1314′ of the drive tube. Flexible coupling 1301′ optionally can include first and second flanges 1316, 1317 that suitably can be secured to one another, e.g., using fasteners such as described herein with reference to FIGS. 12A-12F.

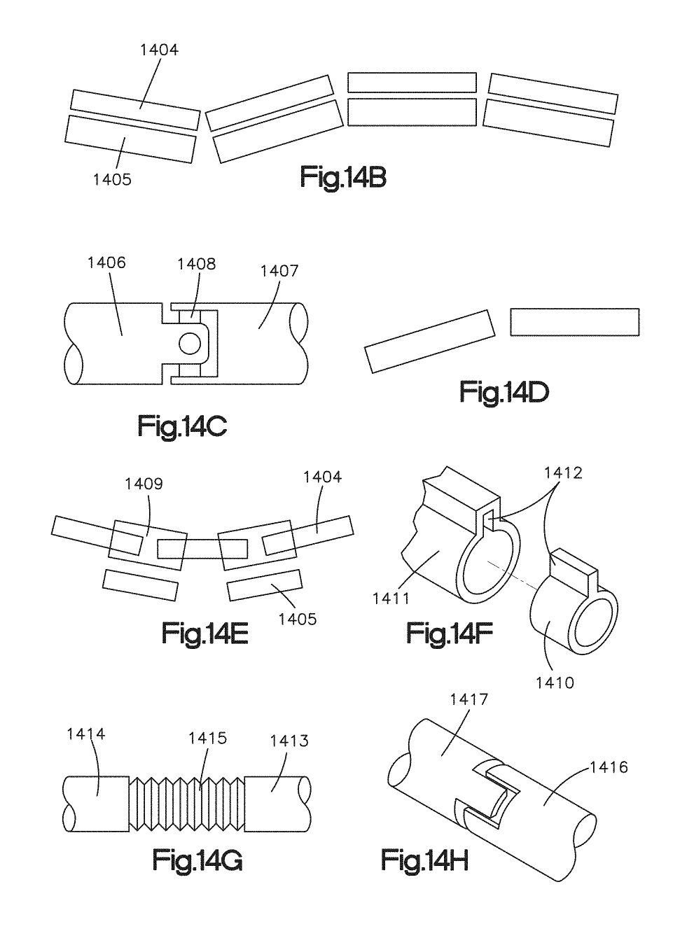

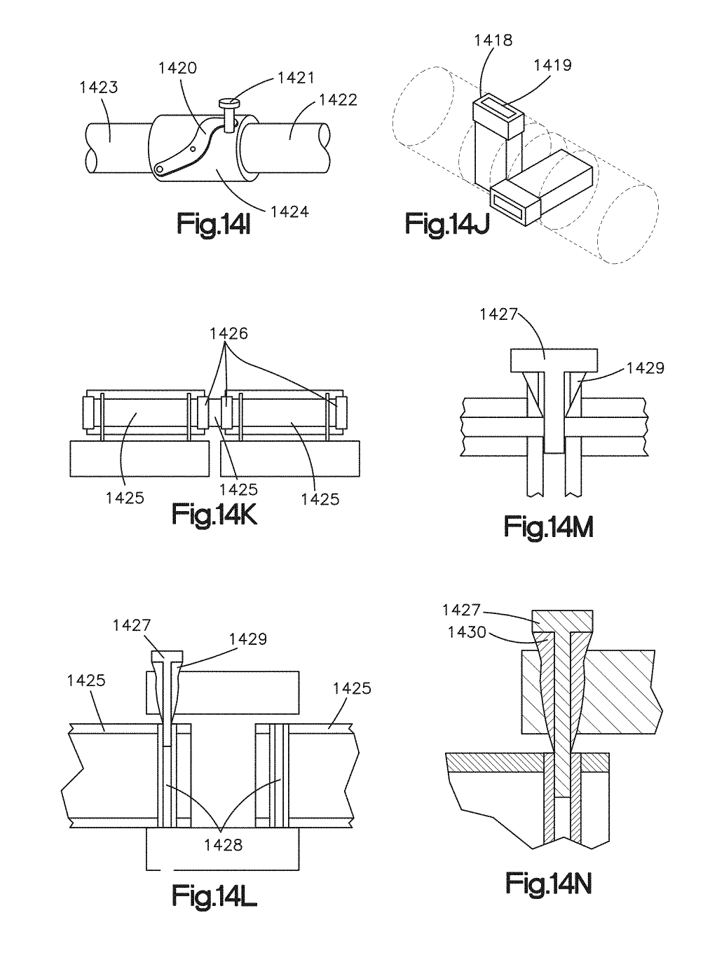

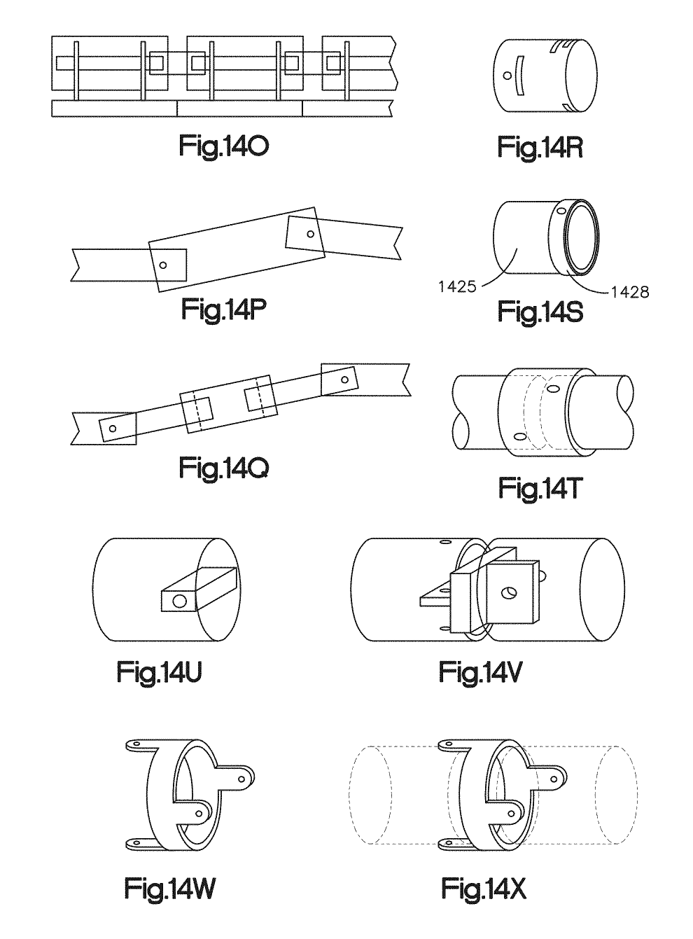

FIGS. 14A-14X schematically illustrate additional options for flexible couplings. For example, FIG. 14A schematically illustrates an embodiment with an expanding bushing 1401, in which tightening bolt 1402 draws conical shapes 1403 together, filling in and aligning holes in tubes (bushing 1401). One or both of conical shapes 1403 can be coupled to a spring. FIG. 14B schematically illustrates an embodiment in which segments 1404 of torque tube or drive tube generally follow segments 1405 of elongated concrete ballast, addressing the challenge of torque tube alignment. FIG. 14C schematically illustrates an exemplary universal (flexible coupling) between torque tube or drive tube segments 1406, 1407 using pin 1408. FIG. 14D schematically illustrates angular and linear offset that can occur between segments of a torque tube or drive tube or between segments of an elongated concrete ballast. FIG. 14E schematically illustrates an exemplary bridge type embodiment in which certain segments 1404 of torque tube or drive tube are used to bridge misalignments between other segments 1404 and/or between segments of concrete 1505. FIG. 14F schematically illustrates an exemplary embodiment of a flexible coupling in which a smaller section 1410 of a torque tube or drive tube is fitted into a larger section 1411 of a torque tube or drive tube; optionally, such an embodiment can include interlocking features 1412 that engage with one another so as to inhibit relative rotation of sections 1410, 1411. FIG. 14G schematically illustrates an exemplary bellows type embodiment in which segments 1413, 1414 of a torque tube or drive tube are flexibly coupled to one another using expandable and flexible (bellows-like) segment 1415. FIG. 14H schematically illustrates an exemplary interlocking embodiment in which the end of a first segment 1416 of a torque tube or drive tube is shaped so as to engage with and interlock with the end of a second segment 1417 of a torque tube or drive tube.

FIG. 14I schematically illustrates another exemplary flexible coupling (universal) that includes tube grounding through the universal, e.g., a sheetmetal piece to link tube-coupler-tube together. The coupling illustrated in FIG. 14I includes torque transmitting tubes 1422, 1423; sheetmetal 1420, which can be welded into place (e.g., spot welded) for easy assembly and connection to coupler 1424; bolts 1421, which respectively can ground sheetmetal 1420 to tubes 1422, 1423, e.g., since the tube(s) have welded threads; and coupler 1424.

FIG. 14J schematically illustrates another exemplary flexible coupling (universal) that can take up rotational tolerance, e.g., using an elastomer. The flexible coupling illustrated in FIG. 14J can include elastomer 1418 with steel center 1419. The steel center 1419 can provide strength, and elastomer 1418 can fill in the hole completely, with the elastic (elastomeric) component compensating for hole size variation.

FIGS. 14K-14N illustrate an exemplary embodiment of a flexible coupling (universal) with expanding or crush features, such as including thin walled nut tube crush features. The universal can include an expanding bushing to take up rotational tolerance and a welded in threaded part for reduced tolerance and easier assembly. For example, the coupling illustrated in FIGS. 14K-14N and 14S can include expanding sleeve 1429 that takes up rotational tolerances and expands or crushes to fill in excess space from tolerances; thick-walled coupler that can handle pin stresses, can be short, so as to save on material cost, and that can receive the ends of thin walled long tubes 1425; thin-walled long tubes 1425 that can save on material costs and can be good at transmitting torque; internally threaded welded shaft 1428 that can be welded in place to 1) reduce tolerance stack and 2) transmit torque to thin walled tubes 1425; and crush cone 1427, optionally which can include plastic. Alternatively, normal bolt 1430 illustrated in FIG. 14N can be used in place of crush cone 1427.

FIGS. 14O-14R and 14T-14X illustrate still further exemplary embodiments of flexible couplings or components thereof. In the example shown in FIG. 14O, segments of a torque tube or drive tube are articulably coupled together so as to follow angular variations in an elongated concrete ballast that includes control joints. In the example shown in FIG. 14P, segments of a torque tube or drive tube are articulably coupled together with a larger sleeve, e.g., using fasteners. In the example shown in FIG. 14Q, segments of a torque tube or drive tube are articulably coupled together with sleeves, e.g., using fasteners. FIG. 14R illustrates an exemplary coupling that can include cut slots to allow for a little flex. FIG. 14T illustrates segments of a torque tube or drive tube articulably coupled together with an exemplary sleeve that is stronger and without cuts. FIG. 14U schematically illustrates an additional structural member that can be added inside of a torque tube or drive tube so as to facilitate fastening a flexible coupling thereto. FIG. 14V schematically illustrates an example of a flexible coupling in which components of the coupling are disposed inside of the segments of the torque tube or drive tube that are being coupled together. FIG. 14W illustrates another coupling using a shaped thin pipe overlay that can be used to couple segments of a torque tube or drive tube to other another in a manner such as illustrated in FIG. 14X.

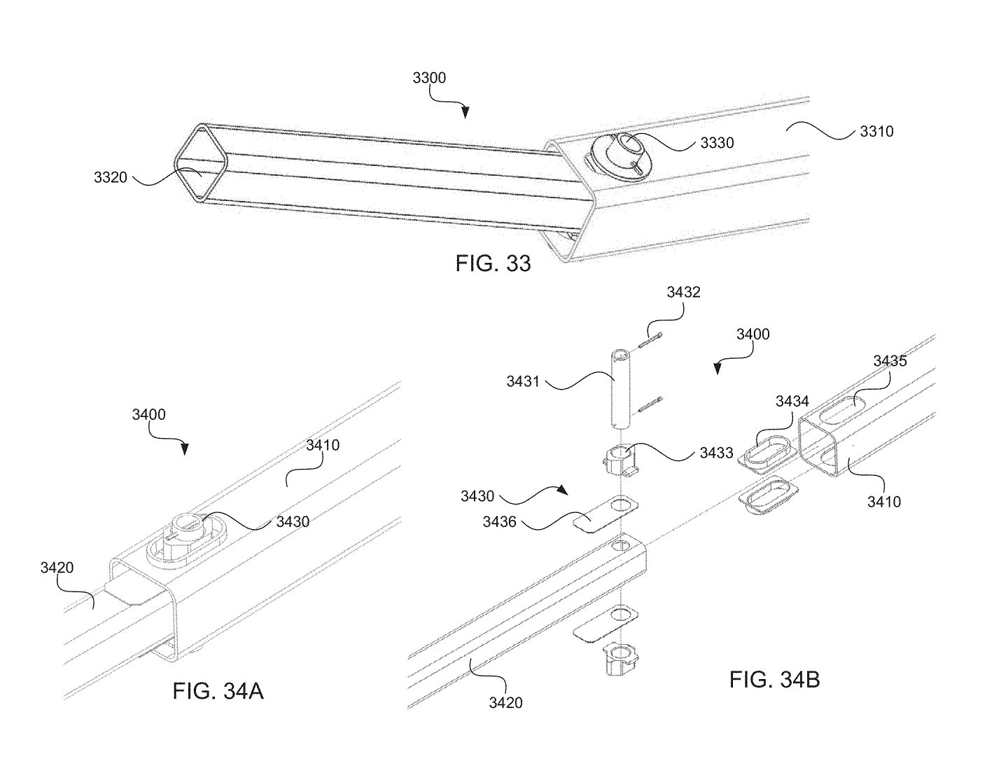

As another option, each flexible coupling comprises a fastener comprising a pin slidably disposed through an aperture of a first discrete section of the drive tube or torque tube and through a slotted aperture of a second discrete section of the drive tube or torque tube. For example, FIG. 33 schematically illustrates a perspective view of another exemplary flexible coupling 3300 that includes drive tube or torque tube 3310, coupling segment 3320 having reduced cross-sectional area relative to tube 3310 (e.g., that slidably fits within tube 3310), and fastener 3330, such as a shaft and cotter pin. As another example, FIGS. 34A-34B schematically illustrate assembled and exploded perspective views of another exemplary flexible coupling 3400 that is similar to coupling 3300 and that includes fastener 3430 coupling drive tube or torque tube segment 3410 to drive tube or torque tube segment 3420. Non-limiting embodiments such as illustrated in FIGS. 33 and 34A-34B provide for universal joints in which sections of the drive tube or torque tube need not necessarily be angularly aligned relative to one another, and that can compensate for thermal expansion/contraction. For example, as shown in FIG. 34B, fastener 3430 includes large diameter pin 3431 that can fit relatively snugly within aperture(s) of drive tube or torque tube segment 3420 and relatively loosely within slotted aperture(s) 3435 of drive tube or torque tube segment 3410; one or more (e.g., two) securement pins 3432; one or more (e.g., two) collar(s) 3433, optionally which can have a generally diamond shape; one or more (e.g., two) bearing insert(s) 3434 that can fit relatively snugly within apertures 3435 of drive tube or torque tube segment 3410; and optional spacer(s) 3436. In the example shown in FIG. 34B, pin 3431 fits relatively snugly within aperture(s) of collar(s) 3433, optional spacer(s) 3436, and drive tube or torque tube segment 3420. Collar(s) 3433 slidably fit within bearing insert(s) 3434 in such a manner that when fastener 3430 is assembled and secured using pins 3432, collar(s) 3433 move laterally and/or angularly in conjunction with lateral and/or angular movement of drive tube or torque tube segment 3420, and slidably move within bearing(s) 3434 so as to permit such lateral and/or angular movement of drive tube or torque tube segment 3420 relative to drive tube or torque tube segment 3410, e.g., responsive to thermal expansion/contraction, seismic activity, settling, or other causes of lateral and/or angular variations along the drive tube (such as irregular geological topology). Optionally, pin 3431 is hollow and/or is of such a diameter as to sufficiently distribute stresses of fastener 3430 among other components of the fastener. Collar(s) 3433 can include any suitable material(s), such as bronze. Bearings(s) 3434 can include any suitable material(s) that optionally do not corrode responsive to contact with collar(s) 3433, such as stainless steel or bronze. Optional spacers can include a material selected to inhibit corrosion that otherwise may arise responsive to contact between collar(s) 3433 with drive tube segment 3420, such as stainless steel. The optional generally diamond shape of collar(s) 3433 can increase contact area with bearing(s) 343 and thus reduce or distribute stress within fastener 3430.

Wind fence options. As noted further above, such as with reference to FIGS. 1D-1E, a wind fence optionally can be used, e.g., so as to reduce wind loads on photovoltaic modules. For example, in some embodiments, a wind fence at one or more respectively suitable location(s), e.g., at one or more of the edges of the present single-axis tracker (system), can reduce wind loads on the tracker. Such wind fence(s) can have any suitable configuration, e.g., can be ballasted or post-driven, and/or can be articulated or fixed, and/or can be solid or perforated. The optional wind fence(s) can be approximately the height of the pivot (or slightly lower), the height of a fully tilted panel, or some height between, or any other suitable height. This wind fence(s) can be on all sides of the tracker, only on the east-west sides, or some hybrid, including being on the east-west sides, and part of the north-south sides.

For example, a system for rotating photovoltaic modules arranged in a plurality of rows can include a plurality of drive tubes extending along and parallel to the rows; drive mechanisms coupled to the photovoltaic modules; an actuator configured to rotate the photovoltaic modules via the drive tubes and drive mechanisms; and a wind fence disposed parallel to and adjacent to at least one of the rows. Optionally, the wind fence includes a first portion, a second portion, and a joint disposed between the first and second portions, the first portion being substantially vertical, the second portion being articulable via rotation of the joint between a vertical position and a folded position. Optionally, articulation of the second portion to the folded position reduces shading of at least one of the rows. Additionally, or alternatively, the wind fence can include panels that include mesh, fabric, or solid material.

For example, FIGS. 15A-15G schematically illustrate exemplary wind fences that can be used in a system for rotating photovoltaic modules, according to some embodiments. FIG. 15A schematically illustrates a perspective view of exemplary wind fence 1500 including panels 1501 supported by vertical support members 1502, e.g., posts. Panels 1501 can include a solid material, or can be perforated, e.g., can include a mesh or fabric. FIG. 15B schematically illustrates a perspective view of exemplary wind fence 1510 that can be configured similarly as wind fence 1500, and in which vertical support members 1512 supporting panels 1511 can be coupled to ballast 1513, e.g., an elongated concrete ballast. FIG. 15C schematically illustrates a perspective view of exemplary wind fence 1520 that can be configured similarly as wind fence 1510, and that is approximately half the height of a photovoltaic module. FIGS. 15D-15F schematically illustrate an exemplary wind fence 1530 that includes substantially vertical first portion 1532, second portion 1531, and joint 1533 disposed therebetween. Second portion 1531 is articulable via rotation of joint 1533 between a vertical position (e.g., such as illustrated in FIG. 15D) and a folded position (e.g., such as illustrated in FIG. 15F). FIG. 15G schematically illustrates a side view of a non-limiting example of a wind fence configuration including one wind fence 1550 on the east side of a present system 1560, and one wind fence 1540 on the west side of system 1560. Fences 1540, 1550 independently can have any suitable configuration, e.g., each can be configured similarly as any of fences 1500, 1510, 1520, or 1530 provided herein.

Additionally, or alternatively, embodiments of the present single-axis trackers (systems) are compatible with the SPOT autonomous cleaning vehicle. For example, a system such as provided elsewhere herein further can include an elongated concrete ballast extending along and parallel to the row and upon which the photovoltaic modules are disposed, the elongated concrete ballast comprising first and second vehicle support surfaces; and a maintenance robot that can include first and second wheels respectively contacting the first and second vehicle support surfaces and configured to maintain the system. Illustratively, the elongated concrete ballast optionally can be split into first and second discrete tracks each parallel to the row, the first track including the first vehicle support surface, the second track including the second vehicle support surface. The maintenance robot optionally can include a body coupled to the first and second wheels and disposed between the first and second discrete tracks.

For example, FIGS. 16A-16E schematically illustrate exemplary vehicles that can be used with a system for rotating photovoltaic modules, according to some embodiments. For example, FIG. 16A schematically illustrates an embodiment of an exemplary SPOT vehicle 1600 for tracker and fixed tilt systems, that optionally includes water filtering. In some embodiments, the optional SPOT vehicle 1600 can include multiple tubes for liquids such as cleaning fluids (such as water) or other fluids (such as material application), including one or more tubes 1601 for cleaning fluid storage and one or tubes 1602 for treatment of such fluids (such as filtering, e.g., water filtration, or chemical additives). As shown in FIG. 16A, SPOT vehicle 1600 can include a plurality of wheels, each configured to engage a vehicle support surface, such as can be provided by an elongated concrete ballast upon which the photovoltaic modules of a row or table can be disposed. For example, FIGS. 16B-16D schematically illustrates SPOT vehicle being used together with different types of systems such as provided elsewhere herein.

SPOT between ballasts options. In some embodiments, an optional vehicle, e.g., an autonomous maintenance vehicle such as SPOT, can be configured to travel between the uprights of the present single-axis tracker. The maintenance vehicle can, for example, trim vegetation and/or perform other operation and maintenance (O&M) tasks. For example, FIG. 16E schematically illustrates an arrangement including elongated concrete ballast 1620 extending along and parallel to the row or table 1630 and upon which photovoltaic modules are disposed, such as using A-shaped upright 1640. Elongated concrete ballast 1620 can include first and second vehicle support surfaces 1621, 1622. Maintenance robot (e.g., SPOT) 1610 includes at least first and second wheels 1611, 1612 respectively contacting first and second vehicle support surfaces 1621, 1622 and configured to maintain the system. In the non-limiting embodiment illustrated in FIG. 16E, elongated concrete ballast 1620 optionally can be split into first and second discrete tracks each parallel to the row or table 1630, the first track including first vehicle support surface 1621, the second track including second vehicle support surface 1622. Maintenance robot 1610 optionally can include body 1613 coupled to first and second wheels 1611, 1612 and disposed between the first and second discrete tracks.

FIGS. 17, 18A-18F, 19A-19E, 20A-20C, 21A-21C, 22A-22J, 23, and 24A-24E schematically illustrate optional arrangements of components in a system for rotating photovoltaic modules in a row, according to some embodiments.

Sheet of material between uprights options. In some embodiments, material optionally can be included between the uprights, such as shown in the non-limiting example in FIG. 17, so as to inhibit or prevent vegetation growth. The material can, in some embodiments, include thin sheets of concrete or thin sheets of metal or other suitable material. For example, FIG. 17 schematically illustrates an arrangement including elongated concrete ballast 1720 extending along and parallel to the row or table 1730 and upon which photovoltaic modules are disposed, such as using A-shaped upright 1740. Elongated concrete ballast 1720 optionally can be split into first and second discrete tracks 1721, 1722 each parallel to the row or table 1730. Sheet of material 1750 can be disposed between, and optionally coupled to, tracks 1721, 1722 in such a manner as to inhibit growth of vegetation between tracks 1721, 1722.

FIGS. 18A-18C schematically illustrate an optional arrangement of components in a system 1800 for rotating photovoltaic modules 1810 in a row, according to one non-limiting embodiment. System 1800 includes elongated concrete ballast 1820, e.g., a tall concrete curb with a generally triangular profile; photovoltaic modules 1810 (solar panels), which can be in landscape or portrait orientation; control joints 1830 including a pivot hinge provided by arcuate members 1831 to which photovoltaic modules 1810 suitably are coupled, elongated structural member 1832 coupled to an actuator (not specifically illustrated) and to arcuate members, and base 1833. The actuator can rotate member 1832, which causes arcuate members to rotate, which causes photovoltaic modules 1810 to rotate. Optionally, the elongated concrete ballast 1820 (e.g., tall concrete curb) can act as a wind dam to lower the wind forces on panel/module 1810. The panel pivot point (provided by elongated structural member 1832) can integrate a hinge for the pivoting, including the pivot being a part of the concrete or the pivot being attached to the concrete.

FIGS. 18D-18F schematically illustrate additional optional arrangements of components in a system for rotating photovoltaic modules in a row, according to some non-limiting embodiments. In the optional arrangement illustrated in FIG. 18D, system 1801 includes concrete curb (rail or ballast) 1821 to which photovoltaic modules 1811 can be coupled via pivoting gearbox mechanism 1851 or other suitable mechanism such as provided elsewhere herein. Elongated structural member 1841, e.g., a cable, drive tube, or torque tube, is coupled to an actuator (not specifically illustrated) and rotates photovoltaic modules 1811 via pivoting gearbox mechanism 1851 or other suitable mechanism responsive to actuation of the actuator. In the optional arrangement illustrated in FIG. 18E, system 1802 includes concrete curb (rail or ballast) 1822 to which photovoltaic modules 1812 can be coupled via a pivoting gearbox mechanism or other suitable mechanism (not specifically illustrated). Elongated structural member 1842, e.g., a cable, drive tube, or torque tube, is coupled to an actuator (not specifically illustrated) and rotates photovoltaic modules 1812 via the mechanism responsive to actuation of the actuator. In the optional arrangement illustrated in FIG. 18F, system 1803 includes concrete curb (rail or ballast) 1823 to which photovoltaic modules 1813 can be coupled via pivoting gearbox mechanism 1853 or other suitable mechanism such as provided elsewhere herein. Elongated structural member 1843, e.g., a cable, drive tube, or torque tube, is coupled to an actuator (not specifically illustrated) and rotates photovoltaic modules 1813 via pivoting gearbox mechanism 1853 or other suitable mechanism responsive to actuation of the actuator. In embodiments such as illustrated in FIGS. 18D-18F, as well as other embodiments provided herein, the concrete curb, rail, or ballast can extend in the same direction of pivoting or in the orthogonal direction. In addition, the elongated structural member, e.g., cabling, drive tube, or torque tube, can run along the concrete rail or orthogonal to it. The solar panels (modules) can be attached together using a common structural element, such as joining structural element 1860 illustrated in FIG. 18E.

Other concrete shapes may exist, including one with driving surfaces for vehicles (such as an installation, cleaning, or maintenance vehicle, such as SPOT; such vehicle may be automated). Additionally, or alternatively, the cable or other elongated structural member may include, or be constructed of, two lines, and may have a link that connects the two lines and acts in the same way the ball acts. This link may operate the mechanism that tilts the solar panel.

For example, FIGS. 19A-19E schematically illustrate additional optional arrangements of components in a system for rotating photovoltaic modules in a row, according to various non-limiting embodiments. For example, FIG. 19A schematically illustrates two lines 1900 that make up an elongated structural member, e.g., cable, optionally including a link or actuating link 1901 coupling the two lines together. FIG. 19B schematically illustrates wheels 1902 of a vehicle, such as SPOT, disposed on vehicle support surfaces 1903 of an elongated concrete ballast 1904. FIG. 19C schematically illustrates smaller wheels 1905 of a vehicle, such as SPOT, disposed on vehicle support surfaces 1906 of an elongated concrete ballast 1907. FIGS. 19D-19E schematically illustrate use of elongated concrete ballast 1908 as a wind dam for photovoltaic module 1909 coupled thereto via hinge 1910 providing a line between the height of ballast 1908 and tilt. Optionally, the embodiment illustrated in FIGS. 19D-19E can be manually installed, e.g., without the use of a robot. One or more vehicle support surfaces can be included, e.g., for SPOT. Grass can be cut around ballast 1908.

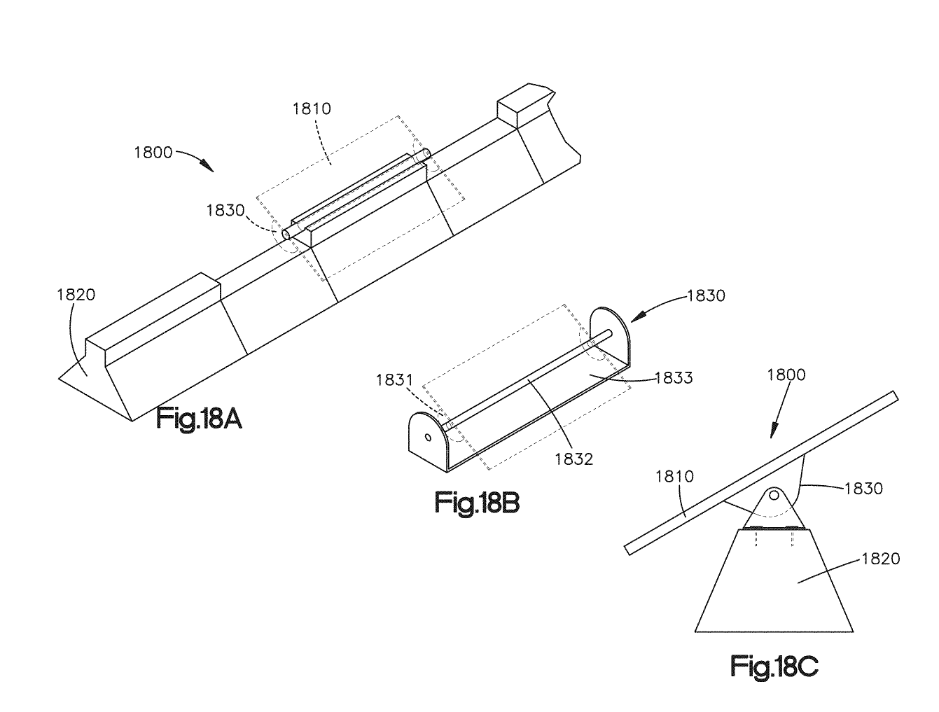

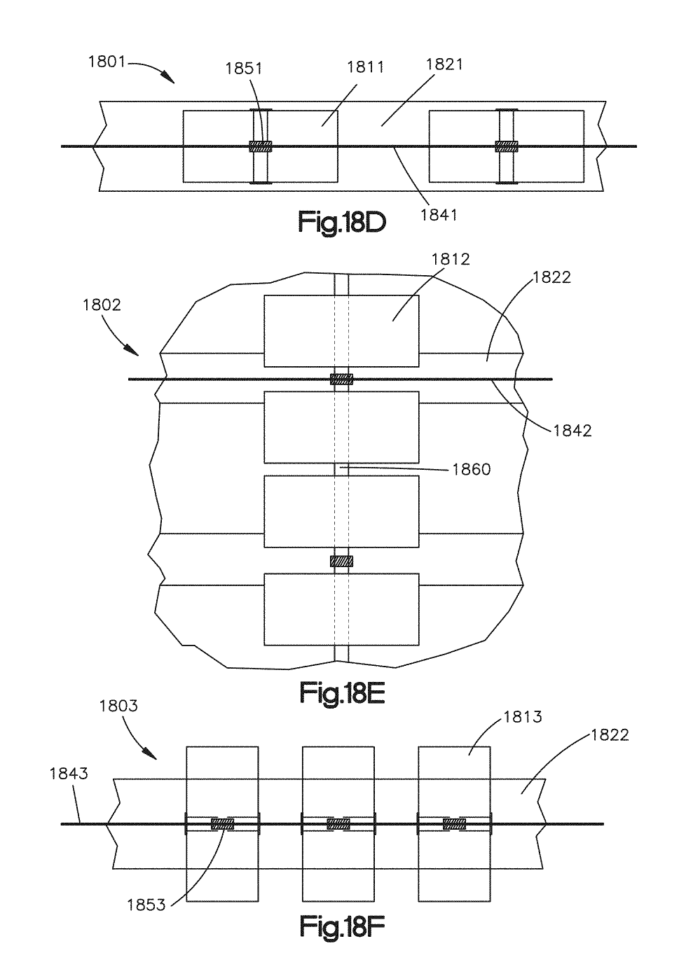

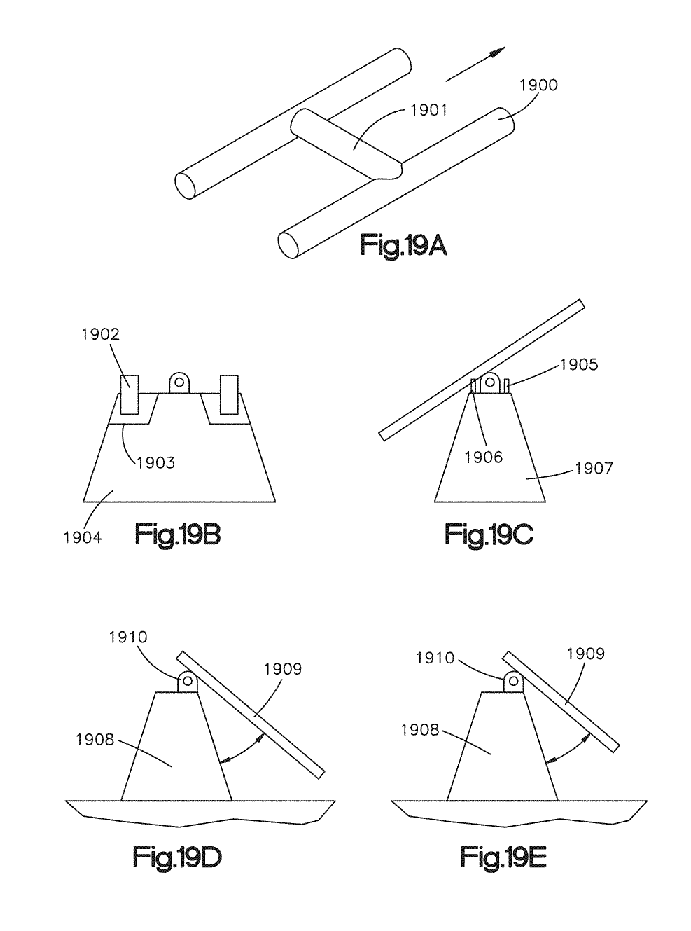

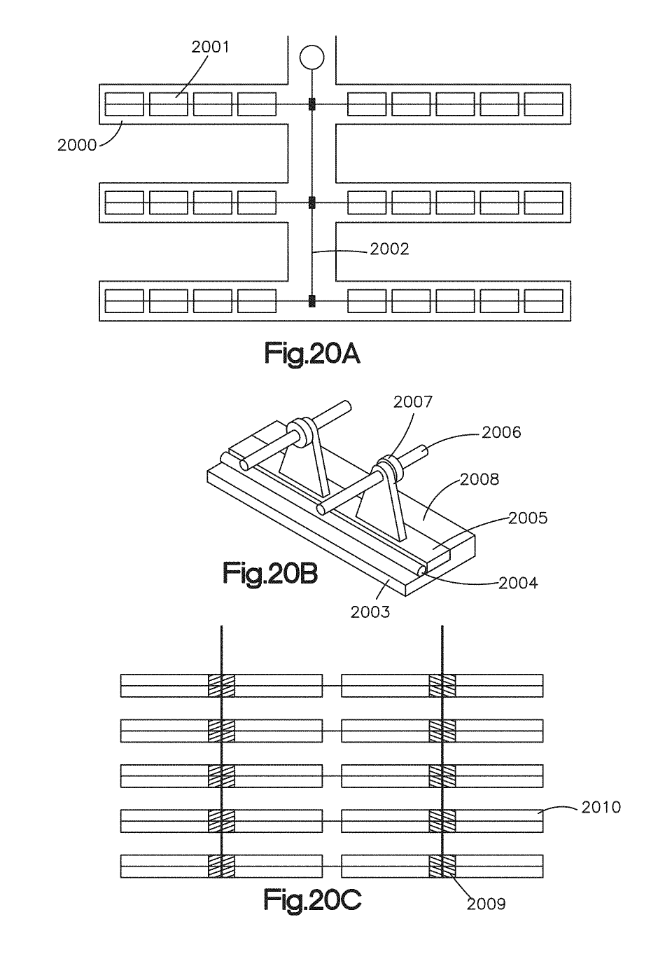

FIGS. 20A-20C schematically illustrate additional optional arrangements of components in a system for rotating photovoltaic modules in a row, according to some non-limiting embodiments. In the example illustrated in FIG. 20A, a damper can be added to rows 2000 of modules 2001 to deal with dynamics, e.g., wind dynamics. Additionally, or alternatively, wiring and/or structural connection 2002 can be provided between and connecting rows 2000. In the example illustrated in FIG. 20B, elongated concrete ballast 2003 can include a space between vehicle support surfaces 2008 for receiving wiring 2004, e.g., house power wiring, and/or elongated steel member 2005. Torque tube(s) 2006 can be supported by and rotated by actuator(s) 2007, e.g., worm drive(s). In the example illustrated in FIG. 20C, more than one actuator 2009 can be provided per row 2010 of photovoltaic modules.

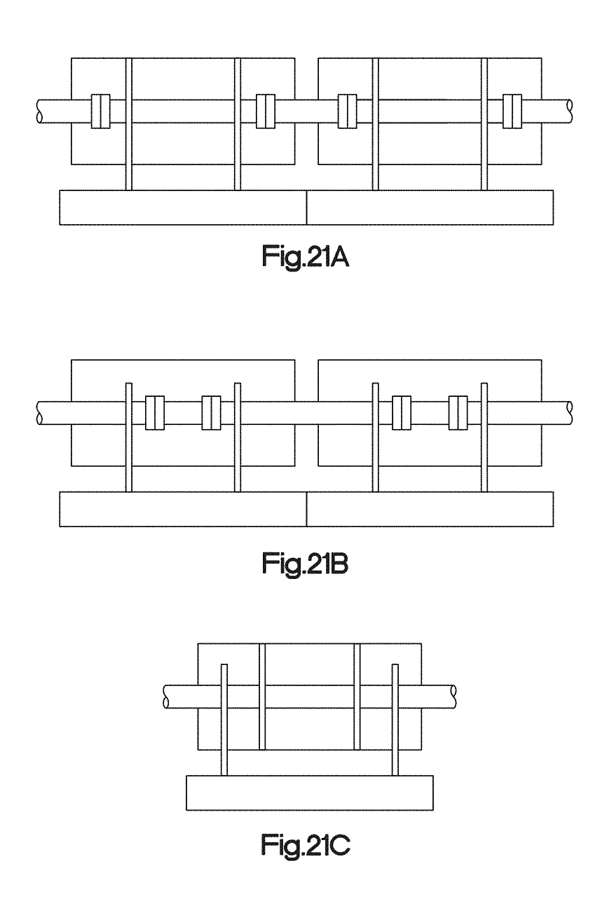

FIGS. 21A-21C schematically illustrate additional optional arrangements of components in a system for rotating photovoltaic modules in a row, according to some non-limiting embodiments. The exemplary arrangement in FIG. 21A includes groups of panels that are attached at two points, e.g., at two different panels of the group, to a pipe (e.g., torque tube or drive tube). Such an arrangement optionally provides straight pipes for panels and readily can be taken apart (e.g., two panels can be detached to disassemble one table or panel from the pipe). The exemplary arrangement in FIG. 21B includes groups of panels that are attached at two points, e.g., at two different points on a single panel of the group, to a pipe (e.g., torque tube or drive tube). The exemplary arrangement in FIG. 21C includes panels attached to a support in such a manner that the panels can be rotated and the arrangement can handle changes in temperature, e.g., can deal with thermal expansion/contraction.

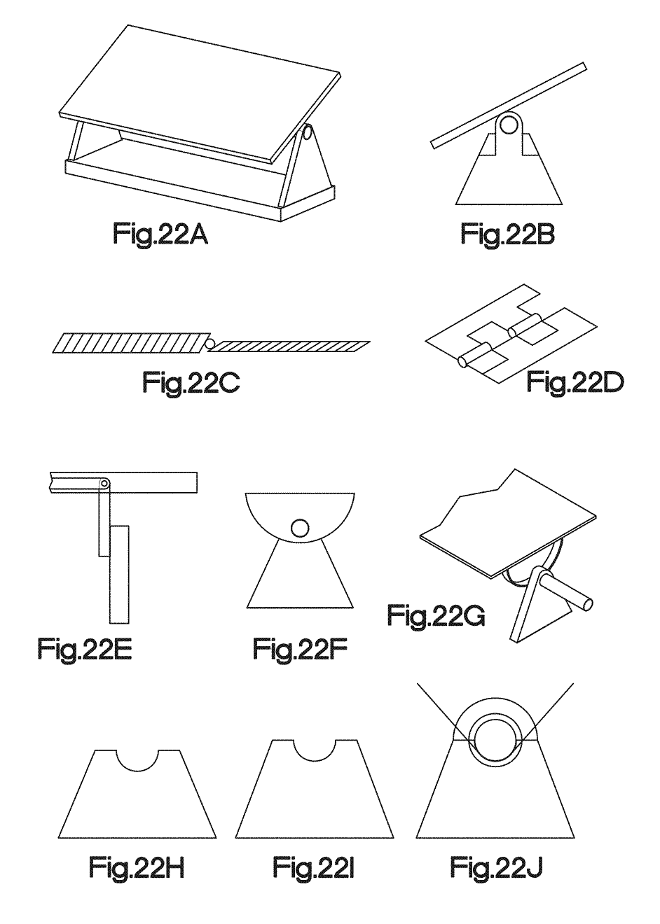

FIGS. 22A-22J schematically illustrate additional optional arrangements of components in a system for rotating photovoltaic modules in a row, according to some non-limiting embodiments. For example, the embodiment illustrated in FIG. 22C accommodates for torsion twist and dead weight.

In still other embodiments, the panel may tilt about a pivot, which may be offset. The tilting mechanism may include, or be made of, a ratcheting mechanism or other mechanism that pushes the panel or supporting structure upwards or downwards. Gravity may help push the panel up or pull the panel down. Some or all of the tilting mechanism and/or panel support structure may fold underneath the panel. When folded, some or all of the tilting and/or supporting mechanism may fit within the frame of a solar panel or within the space provided by packaging for the solar panel or a device attachment to the underside of the solar panel. For example, FIG. 23 schematically illustrates another optional arrangement of components in a system for rotating photovoltaic modules in a row, according to one non-limiting embodiment. In FIG. 23, device 2320 can be attached to the underside of solar panel (photovoltaic module) 2310, e.g., attached to or adjacent to hat channel 2360 and/or hinge 2361. Supporting structure 2330 may be fixed or moving, and optionally can include ratcheting mechanism 2340.

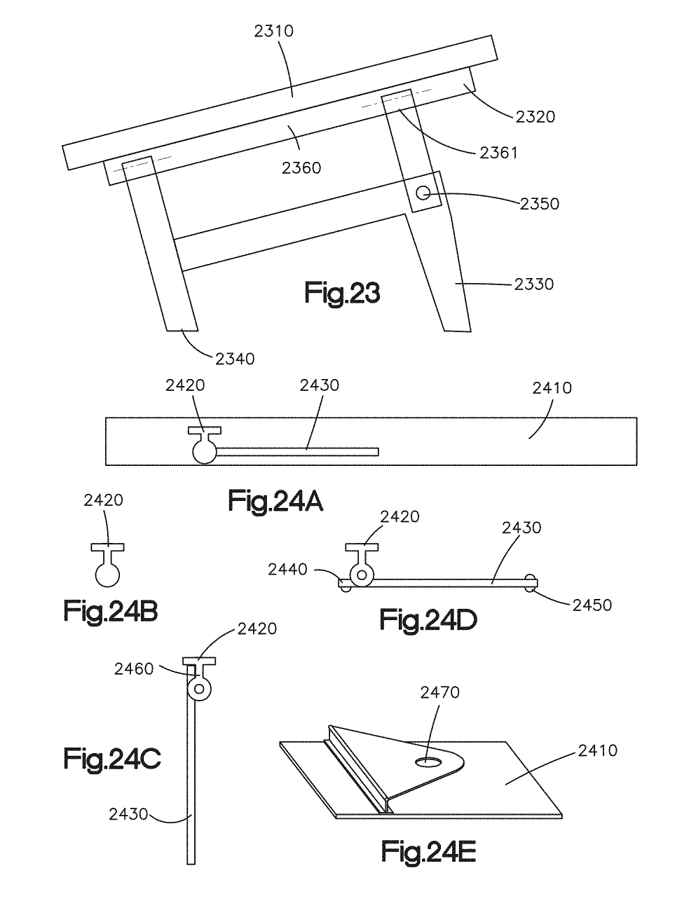

Exemplary embodiments of stiffener attachments (panel supports) are schematically illustrated in FIGS. 24A-24E. In these examples, a stiffener attachment (panel support) ships with panel 2410, folds out, and/or is all plastic. The stiffener attachment can include stiffener 2420 that attaches to panel 2410 and fold-out support 2430 that attaches to a tube via aperture 2470, such as a drive tube or torque tube such as described elsewhere herein, as well as to stiffener 2420. Optionally, stiffener 2420 is symmetric. In some embodiments, fold-out support 2430 is rotatably attached to stiffener 2420 via a hinge, and optionally could lock/snap at location 2460 (or is the hinge itself). In the example shown in FIG. 24E, extender 2440 can act as a stop, stack, and backsheet protection, and can be provided as a portion of fold-out support 2430. One or more bumper(s) or felt 2450 can be coupled to a distal end of fold-out support 2430.

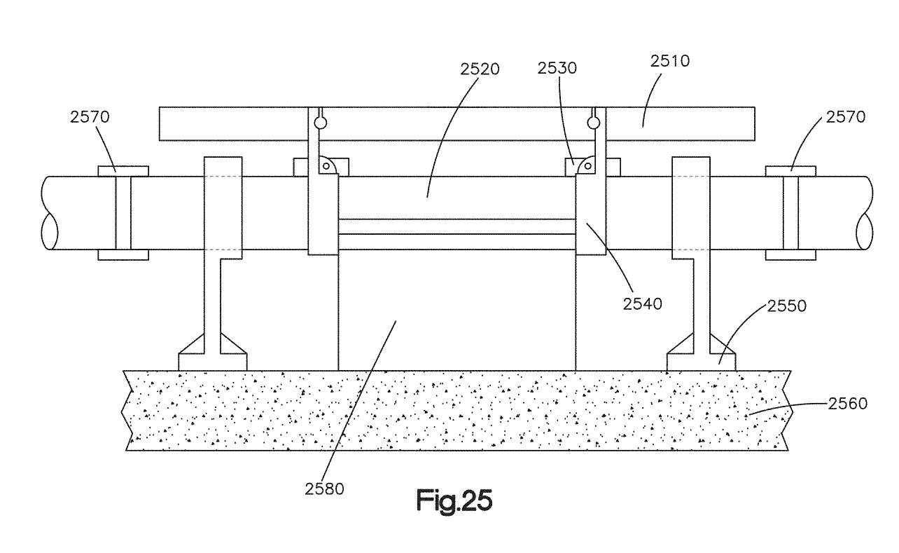

FIG. 25 schematically illustrates a side view of another exemplary arrangement that includes a stiffener attachment (panel support). In this example, the stiffener attachment attaches to a tube, such as a drive tube or torque tube such as described elsewhere herein, via a flag, and/or is all plastic. Illustratively, torque transmitting tube (torque tube) 2520, optionally which can be coupled to one or more additional segments of torque transmitting tube via couplers 2570 (such as flexible couplers described elsewhere herein) can be coupled to panel 2510 via flag 2530 (e.g., part of the torque transmitting tube) and via panel support 2540 (which attaches to the flag by a rivet, bolt, or other suitable fastener). Tube supports 2550 can be coupled to concrete 2560, e.g., to an elongated concrete ballast such as provided elsewhere herein.

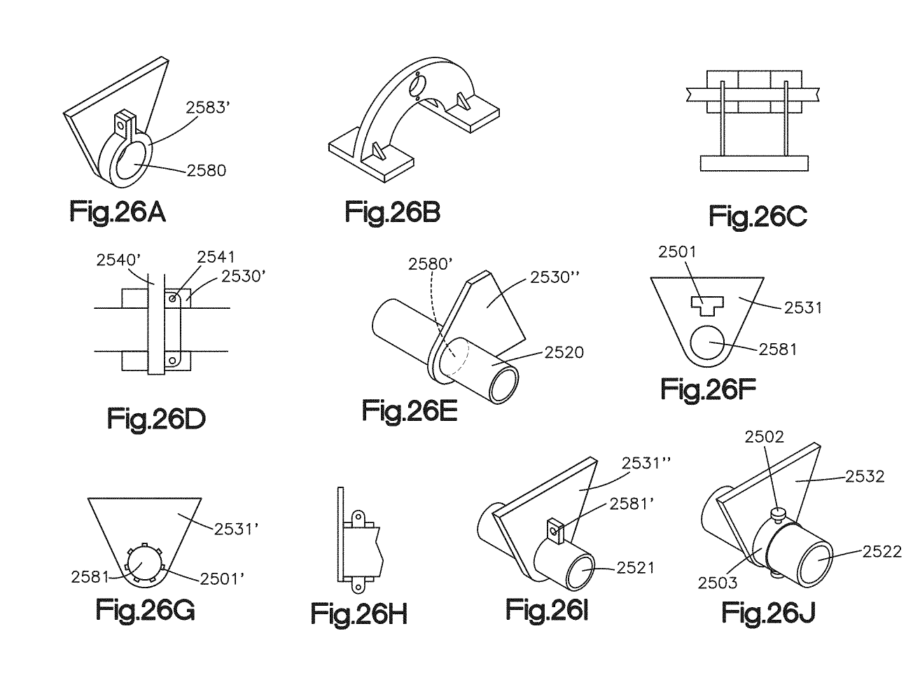

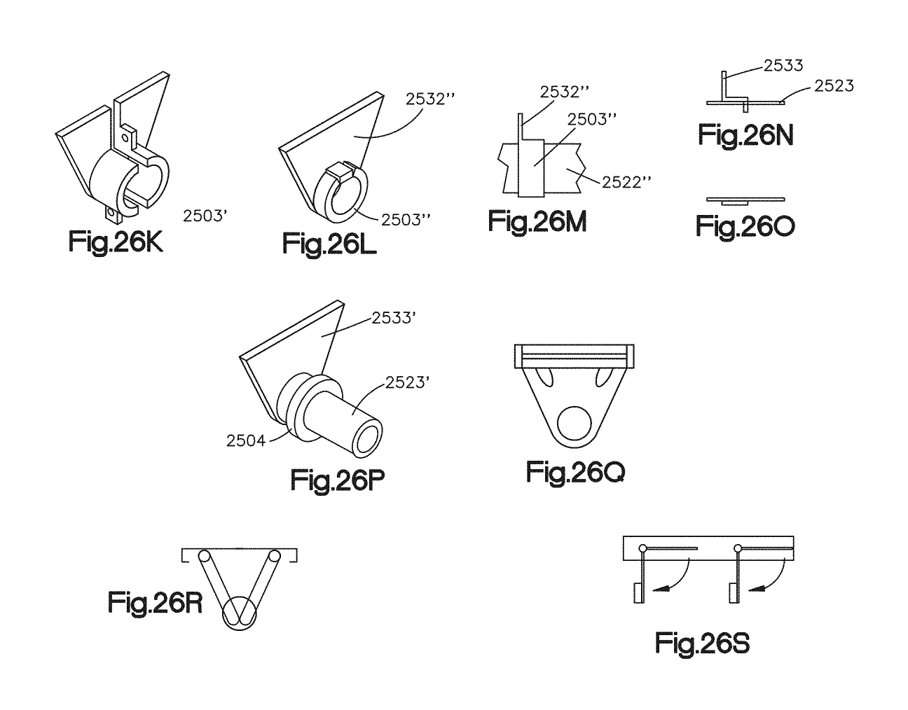

FIGS. 26A-26S schematically illustrate exemplary components and arrangements that optionally can be included in the arrangement of FIG. 25. For example, FIG. 26A schematically illustrates a perspective view of an exemplary flag that can be used in the arrangement of FIG. 25 and includes aperture 2580 for receiving a tube and flange 2583′ for securably engaging the tube. FIG. 26B illustrates front, side, and perspective views of an exemplary tube support that can be used in the arrangement of FIG. 25. FIG. 26C schematically illustrates a side view of an alternative arrangement of features that can be used instead of, or in combination with, the arrangement of FIG. 25. FIG. 26D schematically illustrates a side view of an exemplary coupling between a flag 2530′ and panel support 2540′ using rivet 2541 or other suitable fastener. FIG. 26E schematically illustrates a perspective view of an exemplary coupling between a flag 2530″ and tube 2520′ via aperture 2580′. FIG. 26F schematically illustrates a front view of an exemplary flag 2531 including key 2501 which is movable downwards aperture 2581, e.g., so as to securably engage a tube disposed therethrough. FIG. 26G schematically illustrates a front view of an exemplary flag 2531′ including spines 2501′ which are arranged about aperture 2581′, e.g., so as to securably engage a tube disposed therethrough. FIG. 26H schematically illustrates a side view another exemplary arrangement of features that can be used instead of, or in combination with, the arrangement of FIG. 25. FIG. 26I schematically illustrates a perspective view of an exemplary flag 2531″ that includes rivet 2581′ and optionally includes two opposite flags through which tube 2521 passes. FIG. 26J schematically illustrates a perspective view of an exemplary flag 2532 that includes flange (pinned sleeve) 2503 and first and second fasteners 2502 (such as self-driving screws) for securably engaging tube 2522 passing through flag 2532. FIG. 26K schematically illustrates a perspective view of an alternative flange 2503′ that can be coupled to a flag for securably engaging a tube passing therethrough. FIGS. 26L-26M schematically illustrate perspective and side views of an alternative flag 2532″ including alternative flange 2503″ for securably engaging tube 2522″ passing through the flag. FIG. 26N schematically illustrates a side view of another exemplary flag 2533 having tube 2523 passing therethrough. FIG. 26O schematically illustrates a side view of another alternative arrangement of features that can be used instead of, or in combination with, the arrangement of FIG. 25. FIG. 26P schematically illustrates a perspective view of use of a Band-It sleeve 2504 for securably engaging pipe 2523′ through flag 2533. FIGS. 26Q-26S illustrate still further exemplary embodiments of exemplary flags that can be used with the arrangement of FIG. 25.

Under yet another aspect, the systems and methods provided herein optionally can include wet-setting one or more components, such as one or more uprights to which the present rotation systems can be coupled, into concrete, such as into an elongated concrete ballast described elsewhere herein. For example, a method for mounting photovoltaic modules can include casting or slip-forming an elongated concrete ballast; wet-setting uprights into the elongated concrete ballast; curing the elongated concrete ballast with the uprights therein; and supporting, with the uprights, a drive tube extending along and parallel to the elongated concrete ballast, and drive mechanisms coupled to the photovoltaic modules, the photovoltaic modules being rotatable via the drive tubes and drive mechanisms. Optionally, the uprights can be A-shaped in a manner such as described elsewhere herein, or can include a bridge and a post, the bridge contacting first and second surfaces of the elongated concrete ballast, the post extending vertically from the bridge and supporting the drive tubes and drive mechanisms, in a manner such as described elsewhere herein. Optionally, the uprights each can include first and second feet that each are wet-set into the elongated concrete ballast. Wet-setting the uprights can include vibrating the uprights. Systems produced by such a method are provided.

For example, a wet set ballast can include a support that into concrete and/or can be all plastic. Optionally, a plastic tube support has a feature that engages with concrete (such as/perhaps by aggregate features, or chemistry that promotes adhesion with concrete, and/or is placed in uncured concrete (such as/perhaps by the use of a vibrating tool/wand); when the concrete cures, the tube support is structurally locked/mated to the concrete ballast.

Further wet-setting uprights options. In one non-limiting embodiment, the bases of the uprights or other system components (such as bolts or other components) optionally can be placed into the wet concrete of the foundation at the time of installation. For example, a bridge-based upright such as illustrated in FIGS. 8A-8C can be wet-set into an elongated concrete ballast. In another example, an A-frame shaped upright such as illustrated in FIGS. 8D-8E can be wet-set into an elongated concrete ballast.

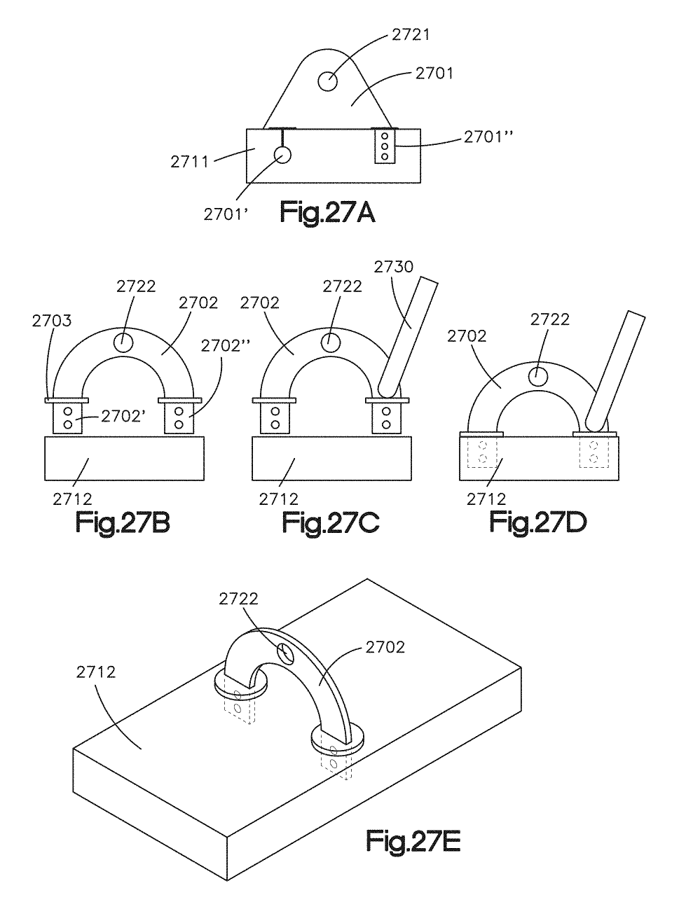

Illustratively, FIGS. 27A-27E schematically illustrate views of exemplary structures formed during steps of a method for wet-setting uprights in a system for rotating photovoltaic modules, in some embodiments. FIG. 27A schematically illustrates a front cross-sectional view of an exemplary upright 2701 that includes tube aperture 2721 (e.g., an aperture for receiving a torque tube or drive tube such as described elsewhere herein) and that is wet-set into concrete 2711 (e.g., an elongated concrete ballast such as described elsewhere herein). Upright 2701 can include first and second feet 2701′, 2701″. Optionally an aggregate can be simulated so as to strengthen attachment between one or both of feet 2701, 2701″, e.g., by a chemical bond (such as promotes adhesion between foot 2701″ and concrete 2711) or mechanical interlock. FIGS. 27B-27D schematically illustrate front cross-sectional views of steps in an exemplary method for wet-setting non-limiting upright 2702 into concrete (e.g., elongated concrete ballast) 2712. Concrete 2712 could also be asphalt. In the illustrated example, upright 2702 includes first and second features to engage with concrete, such as feet 2702′ that optionally include one or more apertures 2702″ therethrough; first and second features to define an amount of penetration, such as flats 2703; and tube aperture 2722. Concrete 2712 can be wet, and can be formed using slip-forming, cast-in-place, or pre-forming. The first and second features to engage with the concrete, such as feet 2702′, can be positioned over the concrete 2712 such as illustrated in FIG. 27B. A vibrating tool/wand 2730 can be brought into contact with one or both of features, e.g., feet 2702, such as illustrated in FIG. 27C. Pressure can be applied vertically to upright 2702 while actuating tool/wand 2730, such as by bringing a vise down, so as to set the features, e.g., feet 2702, into the concrete 2712 such as illustrated in FIG. 27D. The first and second features to define an amount of penetration, such as flats 2703 can define the amount of penetration of feet 2702 into the concrete and can assist in holding upright 2702 vertically while the concrete cures. FIG. 27E illustrates a perspective view of one exemplary structure resulting from such a method.

An exemplary assembly process for an assembly of components such as illustrated in FIG. 25 can include one or more of the following steps, and optionally can include each of the following steps, in any suitable sequence (e.g., in the numerically listed sequence): (1) drop onto spreader jig, e.g., temp spreader jig and support 2580; (2) thread tube 2520 and coupler (e.g., flag 2530) through tube supports 2540 and panel supports 2550; (3) attach tube 2550 and coupler (e.g., flag 2530) to previous coupler, e.g., one or both of flexible couplings 2570; (4) attach panel 2510 to tube 2520, e.g., via rivet, bolt, other suitable fastener; and/or (5) remove jig. Such a process optionally can be automated, can accommodate for thermal expansion/contraction, and/or can provide suitable torque characteristics, such as for use in a photovoltaic module rotation system or method provided herein.

Other attachment methods options. In some embodiments, the uprights optionally can be attached to the foundation (e.g., concrete tracks, or elongated concrete ballast) by one or more of the following: adhesive/epoxy, powder-actuated fasteners, concrete anchors, or bolts.

Corrosion protection options. In some embodiments, the surfaces of the upright that are in contact with the foundation (e.g., concrete tracks, or elongated concrete ballast) can experience corrosion depending on the chemistry of the concrete or component material or other environmental considerations. So as to prevent or inhibit such corrosion, the bases of the uprights can include a different material that is less susceptible to corrosion and/or can be covered with a protective coating.

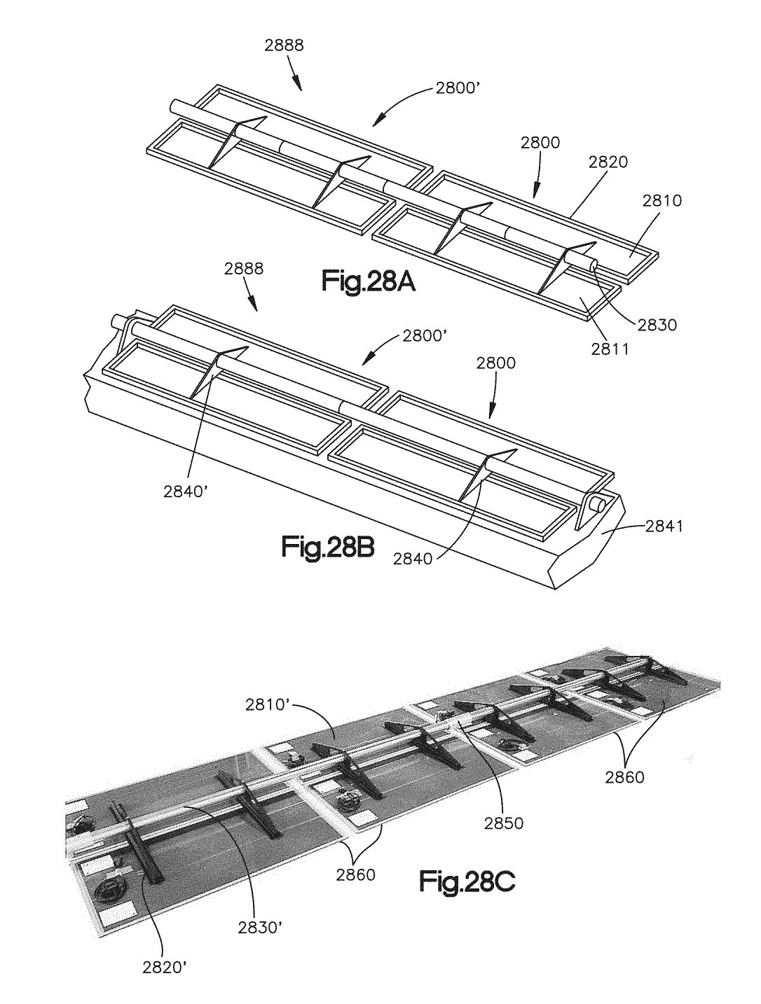

FIGS. 28A-28C illustrate still further optional arrangements of photovoltaic modules that can be used with the present systems and methods for rotating photovoltaic modules in a row, according to some embodiments. For example, FIG. 28A schematically illustrates an upside-down view of a 2-up configuration 2-wide configuration 2888 that includes assembly 2800 including first and second solar panels (photovoltaic modules) 2810, 2811 arranged in the same plane as one another on opposing sides of tube 2830, e.g., drive tube or torque tube such as described elsewhere herein; and stiffener 2820 coupled to each of panels 2810, 2811 and to tube 2830. Optionally, stiffener 2820 includes a fold-out support that bridges across two panels, e.g., each of panels 2810, 2811, and optionally uses adhesive or tape to attach thereto. Tube 2830 can include a drive tube or a torque-transmitting tube of sufficient length to be coupled to, and to rotate, any suitable number of assemblies 2800, such as to be coupled to assembly 2800 and assembly 2800′ which is configured similarly as assembly 2800, e.g., 1 tube 2830 for four solar panels. FIG. 28B illustrates right-side up view of the configuration of FIG. 28A on a concrete (or asphalt) ballast 2840, in which tube 2830 is coupled to the ballast using any suitable number of tube supports (uprights), e.g., first and second tube supports 2840, 2840′, such as two tube supports for every 4 panels. Optionally, ballast 2840 can include one or more control joints such as described elsewhere herein and/or can have the same width as the collective width of the panels coupled thereto, e.g., can be two panels wide in the example illustrated in FIG. 28B. FIG. 28C illustrates an embodiment in which first and second assemblies 2860, 2860′ each configured similarly as assembly 2888 (e.g., include solar panels 2810′, stiffeners 2820′, and one torque transmitting tube 2830′ for four panels) are coupled to one another via tube connection 2850, which optionally can include a flexible coupling such as described elsewhere herein.

An exemplary way to manage the need for torque transmitting tube to both (e.g., to multiple sections of a torque tube or drive tube such as described elsewhere herein, e.g., such as illustrated in FIGS. 28A-28C) can include one or more of the following features:
transmit torque;
flex along length to handle uneven terrain or differential settlement in terrain;
the tubes that the panels are attached to are constrained, since two supports attach to the ballast; settlement or uneven terrain can shift adjacent panel supporting tubes so that their axes are no longer aligned; to keep from overconstraining, two “universals” (components that transmit torque, but allow rotation in two directions) and a connecting tube can be used, and optionally, are required, between panel supporting tubes (similar to the drive shaft in a car/truck); and/or
does not have rotational slop, since the bolts clamp the tabs together.

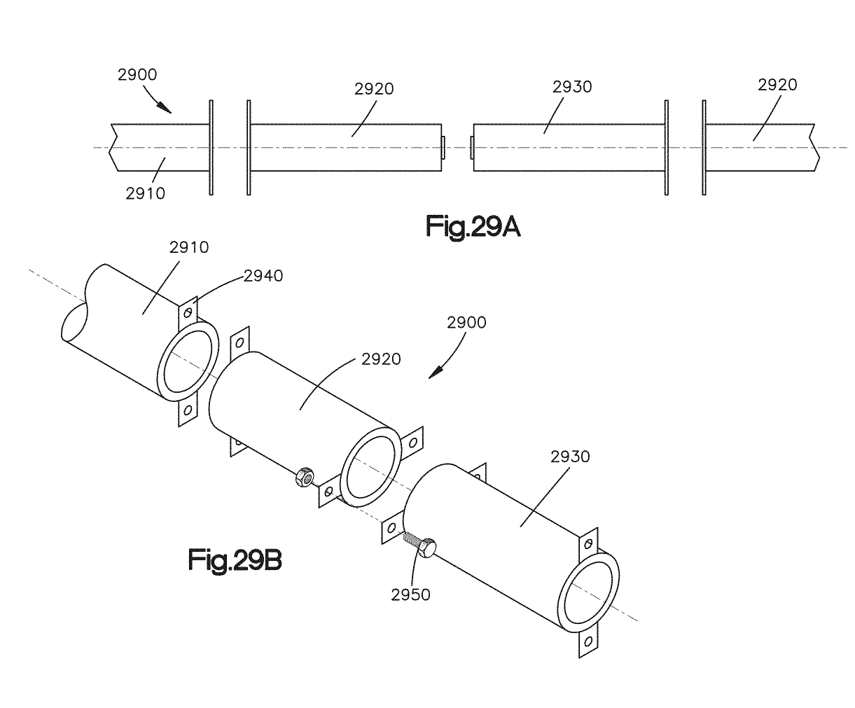

FIGS. 29A-29B schematically illustrate side and perspective views of an exemplary arrangement of elements that can be used in a torque tube or drive tube, according to some embodiments. FIG. 29A illustrates exemplary assembly 2900 including segments of tube (e.g., segments of torque tube or drive tube) 2910, universals 2920, and short tube 2930. Tube segments 2910 can correspond to the tube that panels attach to, and can be constrained. Short tube 2930 can correspond to a connecting tube. Universals 2920, e.g., first and second “universal” tubes, respectively can couple tube segments 2910 to short tube 2930 in such a manner as to transmit torque and/or to provide sufficient flex along the length of assembly 2900 as to accommodate uneven terrain and/or thermal expansion/contraction. FIG. 29B illustrates further detail of exemplary features of assembly 2900. In the illustrated example, tubes 2910, universals 2920, and short tubes 2930 each include bolt tabs 2940 via which the tubes 2910 or 2930 respectively may be coupled to universals 2920 using suitable fasteners 2950, such as nuts and bolts. Bolt tabs 2940 can be or include a flange that sticks off the end of the respective tube or universal. A bolt can go through to connect that is tightly clamped and does not allow rotational slop. The relatively thin thickness of the bolt tab allows twisting and/or bending in the other one/two directions, allowing it to act like one part of a “universal” joint, or the entire “universal” joint. Illustratively, bolt tabs 2940 can flex just enough to pivot slightly and to transmit torque and also has no slop. The bolt tabs 2940 at one end of a tube 2910 or universal 2930 optionally can be arranged in an opposite direction (e.g., orthogonally) to the bolt tabs at the other end of the tube or universal. As an optional alternative to the universal tube 2920, the bolt tab 2940 connection may flex in two directions, and the bolt tab tube connection can create a universal by itself (e.g., instead of two bolt tab connections and a universal tube).

Accordingly, in some embodiments provided herein, exemplary components of the present tracker (photovoltaic module rotation system) include one or more of the following features: ballasted: non-penetrating; tube-based transmission; non-backdrivable worm drive gearbox; easy to install: manually and/or automated install; ship as a unit, or assembly pieces on-site (manual/automated); and/or robotically cleanable. Exemplary embodiments include any suitable combination of the following features:

High level (general arrangement);
any suitable number of rows, any suitable number of panels per row, e.g., 20/40/60 panels per row, or more, e.g., 80 or more, 100 or more, or 120 or more;
connect actuators together across rows using speed bump; and/or
speed bump has wiring

Actuator;
worm drive; and/or
connects to tube drive that goes in both directions

Tube drive;
slides to accommodate thermal expansion/contraction;
universals to accommodate ballast settling;
grounding happens through the tube (only metal part); and/or
rotates relative to plastic ground support

Universal;
expanding bushing to take up rotational tolerance; and/or
welded in threaded part for reduced tolerance and easier assembly

Fold-out stiffener attachment;
ships with panel;
attaches to tube via flag; and/or
all plastic

Wet set ballast; and/or
vibrate support into concrete; and/or
all plastic

Other
all plastic, frameless modules (no grounding);
drive tube is grounded (metal); and/or
works with SPOT (goes to a specific tilt) (exemplary embodiments of SPOT cleaning robot described in U.S. Patent Publication No. 2015/0144156 to French, the entire contents of which are incorporated by reference herein). Other exemplary embodiments of SPOT are described elsewhere herein.

In one example, a system for rotating photovoltaic modules arranged in a row can include an elongated structural member extending along and parallel to the row; protrusions coupled to the elongated structural member; an actuator; and drive mechanisms coupled to the photovoltaic modules. Actuation of the actuator can move the elongated structural member, the movement of the elongated structural member can move the protrusions, the movement of the protrusions can move the drive mechanisms, and the movement of the drive mechanisms can rotate the photovoltaic modules. Exemplary embodiments of such a system are described herein, for example, with reference to FIGS. 1A-1I, 2A-2B, 3A-3B, 4, 5, 6A-6C, 7A-7B, 8A-8J, 9A-9J, 10A-10I, 11A-11B, 12A-12F, 13A-13C, 14A-14X, 16A-16E, 17, 18A-18F, 19A-19E, 20A-20C, 21A-21C, 22A-22J, 23, 24A-24E, 25, 26A-26S, 27A-27E, 28A-28C, 29A-29B, 30A-30B, 31, 32, 33, 34A-34B, 35, 36A-36B, 37, and 38A-38C.

In another example, a system is provided for rotating photovoltaic modules arranged in a row. The system can include a drive tube extending along and parallel to the row. The drive tube can include a plurality of discrete sections coupled together with flexible couplings. The system also can include an actuator; and drive mechanisms coupled to the photovoltaic modules. Actuation of the actuator can rotate the discrete sections of the drive tube and the flexible couplings, the rotation of the discrete sections of the drive tube and the flexible couplings can rotate the drive mechanisms, and the rotation of the drive mechanisms can rotate the photovoltaic modules. Exemplary embodiments of such a system are described herein, for example, with reference to FIGS. 11A-11B, 12A-12F, 13A-13C, 14A-14X, 29A-29B, 33, 34A-34B, and 35.

In another example, a system for rotating photovoltaic modules arranged in a row can include a torque tube extending along and parallel to the row. The torque tube can include a plurality of discrete sections coupled together with flexible couplings, the plurality of discrete sections being coupled to the photovoltaic modules. The system also can include an actuator. Actuation of the actuator can rotate the discrete sections of the torque tube and the flexible couplings, and the rotation of the discrete sections of the torque tube and the flexible couplings can rotate the photovoltaic modules. Exemplary embodiments of such a system are described herein, for example, with reference to FIGS. 11A-11B, 12A-12F, 13A-13C, 14A-14X, 29A-29B, 33, 34A-34B, and 35.

Under yet another aspect, a system is provided for rotating photovoltaic modules arranged in a plurality of rows. The system can include a plurality of drive tubes extending along and parallel to the rows; drive mechanisms coupled to the photovoltaic modules; an actuator configured to rotate the photovoltaic modules via the drive tubes and drive mechanisms; and a wind fence disposed parallel to and adjacent to at least one of the rows. Exemplary embodiments of such a system are described herein, for example, with reference to FIGS. 1D, 1E, and 15A-15G.

Under still another aspect, a method for mounting photovoltaic modules is provided. The method can include casting or slip-forming an elongated concrete ballast; wet-setting uprights into the elongated concrete ballast; curing the elongated concrete ballast with the uprights therein; and supporting, with the uprights, a drive tube extending along and parallel to the elongated concrete ballast, and drive mechanisms coupled to the photovoltaic modules. The photovoltaic modules can be rotatable via the drive tubes and drive mechanisms. Exemplary embodiments of such a system are described herein, for example, with reference to FIGS. 25 and 27A-27E.

While various illustrative embodiments of the invention are described herein, it will be apparent to one skilled in the art that various changes and modifications may be made therein without departing from the invention. For example, the present systems and methods are not limited to use with photovoltaic modules, and instead can be applied to rotating any type of solar module (e.g., a module such as used with a concentrated solar power system, such as a parabolic trough or heliostat), or to rotating any other type of surface. The appended claims are intended to cover all such changes and modifications that fall within the true spirit and scope of the invention.

What is claimed:

1. A system for rotating photovoltaic modules arranged in a row, the system comprising:
a tube extending along and parallel to the row;
an actuator; and
first and second arc gears coupled to the photovoltaic modules,
wherein:
actuation of the actuator rotates the tube,
the rotation of the tube rotates the first and second arc gears, and
the rotation of the first and second arc gears rotates the photovoltaic modules.

2. The system of claim 1, wherein the first and second arc gears are arranged perpendicularly to the photovoltaic modules.

3. The system of claim 1, further comprising:
a first spur gear coupled to the tube and that engages with the first arc gear; and
a second spur gear coupled to the tube and that engages with the second arc gear.

4. The system of claim 3, wherein:
the rotation of the tube rotates the first and second spur gears,
the rotation of the first spur gear rotates the first arc gear, and
the rotation of the second spur gear rotates the second arc gear.

5. The system of claim 1, wherein the first arc gear rotates about a first pivot point at a radial center of the first arc gear, and wherein the second arc gear rotates about a second pivot point at a radial center of the second arc gear.

6. The system of claim 1, further comprising:
first and second support members each extending along and parallel to the row and coupled to a plurality of the photovoltaic modules.

7. The system of claim 6, wherein each of the first and second arc gears is coupled to the first and second support members.

8. The system of claim 6, further comprising:
a first structural member coupled to and extending between the first and second support members, and
a second structural member coupled to and extending between the first and second support members.

9. The system of claim 8, wherein first and second ends of the first arc gear are coupled to the first structural member, and
wherein first and second ends of the second arc gear are coupled to the second structural member.

10. The system of claim 8, wherein the first and second structural members extend perpendicularly to the row.

11. The system of claim 8, further comprising:
a first post coupled to the first structural member; and
a second post coupled to the second structural member.

12. The system of claim 11, wherein the first post is coupled to a midpoint of the first structural member, and wherein the second post is coupled to a midpoint of the second structural member.

13. The system of claim 11, wherein the first and second posts are vertically oriented.

14. The system of claim 11, wherein the first arc gear passes through an opening through the first post, and wherein the second arc gear passes through an opening in the second post.

15. The system of claim 1, further comprising a locking mechanism configured to controllably lock the photovoltaic modules in place.

16. A system for rotating photovoltaic modules arranged in a row, the system comprising:
purlins extending along and parallel to the row and coupled to the photovoltaic modules;
first and second purlin arms positioned in a transverse direction to the purlins and coupled to each of the purlins;
first and second drive mechanisms, each of the first and second drive mechanisms coupled to each of the purlins and one of the first or second purlin arms;
a drive tube extending along and parallel to the row and coupled to gear teeth that engage with the drive mechanisms;
an actuator; and
wherein:
actuation of the actuator rotates the drive tube;
the rotation of the drive tube rotates the gear teeth;
the rotation of the gear teeth rotates the first and second drive mechanisms;
the rotation of the first and second drive mechanisms rotates the first and second purlin arms; and
the rotation of the first and second purlin arms rotates the photovoltaic modules.

17. The system of claim 16, wherein the first drive mechanism rotates about a first pivot point at a radial center of the first drive mechanism, and wherein the second drive mechanism rotates about a second pivot point at a radial center of the second drive mechanism.

18. The system of claim 16, wherein first and second ends of the first drive mechanism are coupled to the first purlin arm, and wherein first and second ends of the second drive mechanism are coupled to the second purlin arm.

19. The system of claim 16, further comprising:
a first post coupled to the first purlin arm; and
a second post coupled to the second purlin arm.

20. The system of claim 19, wherein the first post is coupled to a midpoint of the first purlin arm, and wherein the second post is coupled to a midpoint of the second purlin arm.

21. The system of claim 19, wherein the first and second posts are vertically oriented.

22. The system of claim 19, wherein the first drive mechanism passes through an opening through the first post, and wherein the second drive mechanism passes through an opening in the second post.

23. The system of claim 16, further comprising controllably locking the photovoltaic modules in place by a locking mechanism.
